(19) United States
(12) Patent Application Publication
(10) Pub. No.: US 2007/0299802 A1
(43) Pub. Date: Dec. 27, 2007

(54) Human Level Artificial Intelligence Software Application for Machine & Computer Based Program Function

(76) Inventor: Mitchell Kwok, Honolulu, HI (US)

Correspondence Address: Mitchell Kwok, 1675 Kamamalu ave., Honolulu, HI, 96813, US

(21) Appl. No.: 11/770,734

(22) Filed: Jun. 29, 2007

Related U.S. Application Data
(63) Continuation-in-part of application No. 11/744,767, filed on May 4, 2007.
(60) Provisional application No. 60/909,437, filed on Mar. 31, 2007.

(51) Int. Cl. G06N 7/02; G06F 17/00

(52) U.S. Cl. 706/52; 706/59

(57) ABSTRACT

A method of creating human level artificial intelligence in machines and computer software is presented here, as well as methods to simulate human reasoning, thought and behavior. The present invention serves as a universal artificial intelligence program that will store, retrieve, analyze, assimilate, predict the future and modify information in a manner and fashion which is similar to human beings and which will provide users with a software application that will serve as the main intelligence of one or a multitude of computer based programs, software applications, machines or compilation of machinery.

### CROSS REFERENCE TO RELATED APPLICATIONS

This is a Continuation-in-Part application of U.S. Ser. No. 11/744,767, filed on May 4, 2007, entitled: Human Level Artificial Intelligence Software Application for Machine & Computer Based Program Function, which claims the benefit of U.S. Provisional Application No. 60/909,437, filed on Mar. 31, 2007.

### STATEMENT REGARDING FEDERALLY SPONSORED RESEARCH OR DEVELOPMENT

(Not applicable)

### BACKGROUND OF THE INVENTION

1. Field of the Invention

This invention relates generally to the field of artificial intelligence. Moreover it pertains specifically to human level artificial intelligence for machines and computer based software.

2. Description of Related Art

For 60 years, ever since artificial intelligence has been around, scientists have long to build a machine that can think, reason, behave, and act like a human being. The problem with current AI software is that they cater to parts of human intelligence and not human intelligence as a whole. This is why there are so many subject matters related to artificial intelligence.

One aspect is the fact that no one has defined what the conscious is? The conscious is highly debated by both psychologists and AI researchers. In order to build a human brain the conscious must be defined. This would include: what the conscious is, how does the conscious work, and what are the computer codes to implement the software to a conscious?

Building a network that will store, retrieve, and modify information is another aspect that must be considered. The internal data in neurons and how the dendrites work has baffled many AI researchers. Neural networks try to resemble how neurons work but there are many unanswered questions with those AI programs and they don't work very well. The growing problem of how does the data get stored in memory and how does the data get retrieved by the host is still a mystery. What exactly are the data stored in the neurons is also something that has never been explained.

Another aspect is the field of reasoning and probability in machines. Currently, Bayesians probability theories, semantic networks, discrete mathematics, and language parsers are used in combination to produce a machine that can learn language/knowledge in a limited environment. The idea was to build something that can learn and understand language and to use the language to make the machines learn things from its environment. However, this is complicated by the fact that it is very difficult to build a machine that can learn language using the current AI methods. Even language that a 5 year old is capable of learning is very difficult to do in machines.

### SUMMARY OF THE INVENTION

To solve the mentioned problems above, the present invention proposes a totally different way of building a human robot. This would include defining/building a conscious, building a network to store/retrieve/modify large amounts of information, building a machine that can learn language and common sense knowledge, and building a machine that can learn probability and reasoning. In addition to this, the invention not only has the capability of human intelligence but the capability to acquire intelligence that “exceeds” human intelligence.

There are thousands of ways of building a human brain. This human level artificial intelligence program is a collection of 6 years of designing and implementing a software that I think will produce human intelligence. The HLAI program is a computer brain that can predict the future. The AI software can be applied to all machines and the machine will behave intelligently at or similar to human intelligence. If the human level AI is applied to a car then the car will drive by itself from one location to the next in the safest and quickest way possible. If the HLAI is applied to a plane then the plane will fly by itself from one place to the next in the safest and quickest way possible. If the HLAI is applied to a videogame then the AI can play any game for that videogame system. Just like humans, the AI program uses knowledge from the past to predict what will eventually happen in the future. By giving the AI the ability to see into the future it can anticipate what will eventually happen next and take the best course of action.

A camera is used to interface the HLAI program with all the different machines. The program will store all the frame-by-frame video in memory in an organized way. My program can store large amounts (almost infinite) hours of video in memory and the retrieval program will get the video clips in a quick way using multiple search points. This is revolutionary because it would mean that the computer will never run out of disk space (current neural networks can't do this). The program also self-organizes all the data in memory so that common video clips will be stored in the same area. The storage part of the program works by storing each frame of the movie in a 3-d environment. The result is the 3-d representation of all the movies. The 3-D environment is actually the average of all the movies stored in memory. Theoretically, this is how humans store information in memory

The idea behind the memory of the AI is to store the most important pathways (movie sequences) and to forget the least important pathways. The network uses strength of node/s to represent any repeated data. The more a pathway is trained the stronger the node/s become. The less training it goes through the less strength the node has. The length of the pathway also grows with more training and the length of the pathway shrinks with less training.

The present invention is novel because it solves 80 percent of all problems facing the field of artificial intelligence. Some of the features that are novel in the present invention are:
A. The AI can learn common sense knowledge and language without language parsers, discrete mathematics, semantic networks, probability theories, or any type of modern day AI technique/s.
B. The AI is capable of learning what is known as universal language. Instead of limiting the language to English the AI can learn Chinese, German, Arabic, Korean, Dutch, Spanish, French or any language, even alien language.
C. It can store large, “almost infinite”, amounts of video or pictures and the data can be retrieved quickly.
D. In prior art, storing all possible outcomes of a 2-player game in memory is impossible. The total possible outcome of a chess program is 10 to the 40^{th} power and the total combinations of the outcome are infinite. My program can store all the possible outcomes of a chess program (which amounts to infinite data). A more complex form of the chess program is movie sequences from real life or videogames. My program can store the total possible outcomes of movie sequences as well.
E. In prior art, the majority of 2-player AI games such as chess, and checkers use expert systems to calculate future steps during runtime. My program stores all the possibilities in memory and uses the stored data to predict the future (given that a 100 percent pathway match is found in memory). My program uses fuzzy logic to predict the future for similar or non-existing pathways in memory.
F. There is no need to insert rules into the network because the rules are learned through training. If you apply this program to a car, all the rules of driving are learned by observation. An expert trainer has to drive the car and the AI must observe, store and average all the training data in memory. When the data is averaged out the AI will understand the rules of driving.
G. The method the AI uses to retrieve information is faster than any search algorithm in computer science. The timing of the search is considerable lessened as more data gets inserted into the network.
H. No modern day AI technique is used to learn probability and reasoning. The AI learns probability and reasoning through patterns. I set up the different patterns in the system and the AI finds these patterns.
I. The HLAI program is versatile and can be applied to all machines including: cars, trucks, buses, planes, forklifts, computers, human robots, houses, lawnmowers, radios, phones, and even toaster ovens. “All” machines can be hooked up to the HLAI and that machine will act intelligently at or above human intelligence.
J. The HLAI has no boundaries as to its application. It not only is a revolutionary technology applied to computer science, but other disciplinary fields such as biotechnology, engineering, aero dynamics, chemistry, medicine, genetic engineering, and mathematics. The novel things that can be created from this invention are: a software that can predict an earthquake or hurricane one year in advance, a humanoid robot, a machine that can predict the future and the past with pinpoint accuracy, automated software to do all human jobs including: driving, surgery, retail, technical tasks, operating cameras for movies and tv, hair cuts, make-up, construction, building houses, fighting a war and so forth. Anything that a human or a group of humans can do this invention will also be able to do.

This patent is very long, 206 pages including drawings. I feel the need to disclose all information about this invention in a complete and concise manner so that the reader will have a better understanding of how “human intelligence” is reproduced in a computer. The outline of the patent is done in a computer science manner where the inventor discusses the basic functions of the AI program first and then dives deeper and deeper into the details. The inventor tries to introduce information in linear order. However, some information are repeated or revisited in certain parts of the patent.

### BRIEF DESCRIPTION OF THE DRAWINGS

For a more complete understanding of the present invention and for further advantages thereof, reference is now made to the following Description of the Preferred Embodiments taken in conjunction with the accompanying Drawings in which:

FIG. 1 is a software diagram illustrating a program for human level artificial intelligence according to an embodiment of the present invention.

FIG. 2 is the software diagram of the present human level artificial intelligence program presented in a different way.

FIG. 3 is a diagram depicting self-organization of data in memory.

FIG. 4 is a diagram depicting the current pathway during each iteration of the for-loop in FIG. 1.

FIG. 5 is a diagram demonstrating how conscious thoughts are used to interpret grammar.

FIG. 6 is a diagram depicting the data structure of memory.

FIG. 7 is a flow diagram depicting the searching of data from FIG. 6.

FIG. 8 illustrates the search process.

FIG. 9 is a diagram to illustrate the searching process using both commonality groups and learned groups.

FIGS. 10-11B are diagrams demonstrating sequential connections and encapsulated connections.

FIG. 12 is a diagram of 2-d data structured trees representing conventional networks, hashtables, vectors, or linklists.

FIG. 13 is a diagram of 3-d data structure for the present invention.

FIG. 14 are diagrams showing the weights of sequential connections and encapsulated connections.

FIGS. 15A-15C are diagrams depicting the rules program.

FIG. 16 is a diagram to demonstrate how the rules program assigns meaning to sentences.

FIGS. 17-18 are illustrations to demonstrate image layers.

FIGS. 19-20 are illustrations to demonstrate how the rules program assign meaning to nouns and verbs.

FIGS. 21A-21B are diagrams to illustrate how the mind produces conscious thoughts.

FIGS. 22-24 are illustrations to demonstrate the 4 deviation functions.

FIGS. 25-27C are diagrams illustrating examples of how the present invention can demonstrate human intelligence.

FIGS. 28A-28D are diagrams to illustrate how pathways in memory can form complex intelligence.

FIGS. 29-33 are diagrams to demonstrate how the AI program creates templates and how the templates are trained in memory.

FIG. 34 are diagrams to demonstrate how templates are used to lengthen pathways in memory.

FIGS. 35A-35D are diagrams illustrating the process in FIG. 34.

FIG. 36 is a flow diagram depicting the process of how objects are trained in memory.

FIG. 37 is a diagram depicting the structure of repeated objects in memory.

FIG. 38 are diagrams depicting the rules program.

FIGS. 39A-39B are diagrams illustrating the process of extracting element objects from a target object and activating said strongest element objects in linear order.

FIGS. 40A-40B are diagrams depicting human thoughts.

FIGS. 41A-41D are different examples of the ABC block problem.

FIG. 42 is a diagram illustrating grouping of encapsulated data between hidden objects.

FIG. 43 is a diagram showing the different times events occur.

FIG. 44 is a diagram showing decision making by the AI program.

FIGS. 45A-45D are illustrations showing how learned groups and commonality groups organizes face images.

FIGS. 46A-46F are illustrations demonstrating how moving objects self-organizes in memory.

FIGS. 47A-47B are flow diagrams depicting the process of how newly created objects are trained in memory.

FIGS. 48A-48B are diagrams demonstrating the 2 types of data in the current pathway: 5 sense data and activated element objects.

FIG. 49 is a flow diagram depicting a hidden object or meaning forget information.

FIG. 50 is a diagram depicting how the AI program matches pathways in memory.

FIG. 51 is a diagram depicting a target object and its activated meaning.

FIGS. 52-53 are diagrams depicting how the AI program matches pathways in memory.

FIGS. 54A-54B are illustrations demonstrating how the ABC block problem self-organizes in memory.

FIG. 55 is a diagram depicting the organization of data in memory based on learned language.

FIGS. 56A-56B are diagrams demonstrating the 3 types of data in the current pathway: 5 sense data, activated element objects and hidden data.

FIGS. 57A-57B are flow diagrams illustrating how commonality groups or 5 sense data forget information.

FIGS. 58A-58D are diagrams illustrating how learned groups or activated element objects forget information.

FIG. 59 is a flow diagram illustrating how hidden data forget information.

FIG. 60 is a flow diagram further illustrating how learned groups or activated element objects forget information.

FIGS. 61A-61B are diagrams illustrating how the AI program reads in the word bat.

FIG. 62 is a diagram depicting multiple learned groups assigned to a cat floater.

FIGS. 63A-63B are diagrams demonstrating the 4 types of data in the current pathway: 5 sense data, activated element objects, hidden data and patterns.

FIGS. 64A-64C are flow diagrams showing how the AI program finds patterns to similar pathways and output a universal pathway.

FIGS. 65A-65B are diagrams depicting how the AI program assigns hierarchical groups as variables in a universal pathway.

FIG. 66 is a diagram showing the different times events occur.

FIG. 67 is an illustration of visual text words in 3-d space.

FIG. 68 is an illustration of a mouse and the text word mouse.

FIG. 69 is a diagram of conscious thought when the AI program encounters the word mouse.

FIG. 70 is an illustration of how the AI program identifies the word mouse in the movie sequences.

FIGS. 71A-71B is an illustration of how the AI program assigns the word jump to a movie sequence.

FIG. 72 is a diagram of different sentences assigned to the same meaning.

FIGS. 73A-73E are diagrams depicting the process of assigning different sentences to the same meaning.

FIG. 74 is a diagram showing the steps of reading in and interpreting a sentence.

FIG. 75 is a diagram showing how the assignment statement is assigned to a sentence.

FIGS. 76A-76B are diagrams depicting how different sentences can be interpreted in a fuzzy logic manner.

FIGS. 77A-77B are flow diagrams showing the different patterns in a pathway to predict the future.

FIGS. 78A-79B are diagrams showing internal function: finding data from the 3-d environment.

FIGS. 80A-80B are diagrams showing internal function: rewinding and fast-forwarding in long term memory to get information.

FIGS. 81A-81B are diagrams showing two internal functions: finding data from the 3-d environment and rewinding and fast-forwarding in long term memory to get information.

FIGS. 82A-82B are diagrams showing a universal pathway of FIGS. 81A-81B.

FIG. 83 is a diagram depicting a universal pathway of FIG. 75.

FIGS. 84-85 are diagrams depicting target objects and activated element objects.

FIGS. 86A-86B are diagrams showing sequential sentence association.

FIGS. 87A-87D are diagrams showing an example of logic and reasoning.

FIGS. 88A-88B are diagrams showing an example of an addition problem.

FIGS. 89A-89B are diagrams showing an example of an addition problem similar to FIGS. 88A-88B.

FIG. 90 is a diagram showing the different times events occur.

FIG. 91 is a diagram showing hierarchical learned groups of numbers.

FIG. 92 is a diagram depicting the rules program assigning a word to a meaning.

FIG. 93 is a diagram depicting numbers being represented by learned groups.

FIG. 94 is an illustration showing visual images assigned to a word.

FIG. 95 is an illustration showing visual images assigned to a word similar to FIG. 94.

FIG. 96 is an illustration showing a diagram of a hierarchy tree of mammals.

FIG. 97 is a diagram showing a variance of FIG. 96.

FIG. 98 is an illustration showing a diagram of a hierarchy tree of a family.

FIGS. 99A-99B are diagrams showing how robots can learn knowledge by observing a situation.

FIG. 100 is a diagram showing three pathways with their powerpoints.

FIGS. 101-102 are diagrams of pathways at different states.

FIGS. 103A-103D are diagrams depicting logic and reasoning.

FIGS. 104-107 are diagrams showing the process of planning tasks and managing interrupted tasks via language.

FIG. 108 is a diagram showing how the robot reads and interpret words in a book.

### DESCRIPTION OF THE PREFERRED EMBODIMENTS

The Human Level Artificial Intelligence program acts like a human brain because it stores, retrieve, and modify information similar to human beings. The function of the HLAI is to predict the future using data from memory. For example, human beings can answer questions because they can predict the future. They can anticipate what will eventually happen during an event based on events they learned in the past.

There are multiple parts to the program:

A. storage of data

B. retrieval of data

C. the rules program (or self-organization of data)

D. future prediction

All these parts of the program work together to produce the intelligence of the machine. I will outline each of the parts individually and try to link them together. The next several paragraph explains how all the parts work together to form the intelligence of the machine.

The present invention provides a method of creating human level artificial intelligence in machines and computer based software applications, comprising: the AI program repeats itself in a single for-loop to receive information, calculate an optimal pathway from memory, and taking action.

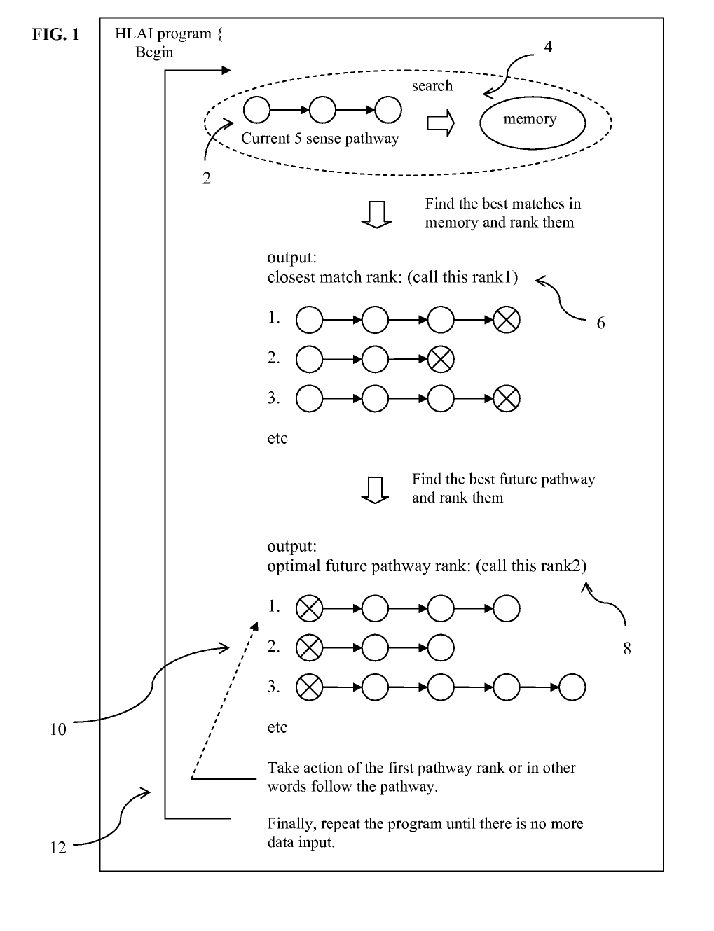

FIG. 1 is a software diagram illustrating a program for human level artificial intelligence according to an embodiment of the present invention. First, the AI will get input (current pathway) from the environment (Step 2). Next, the AI uses the search function to find the optimal pathway from memory (Step 4). The optimal pathway is based on two criteria: the best pathway matches 6 and best future predictions 8. The input data (current pathway) will be stored in the optimal pathway. The rules program, the self-organizing of data and the pattern finding are all done at the time the data is stored in memory. When all the data is stored, the AI will follow the future pathway of the optimal pathway (Step 10). Finally, the program repeats itself from the beginning (Step 12).

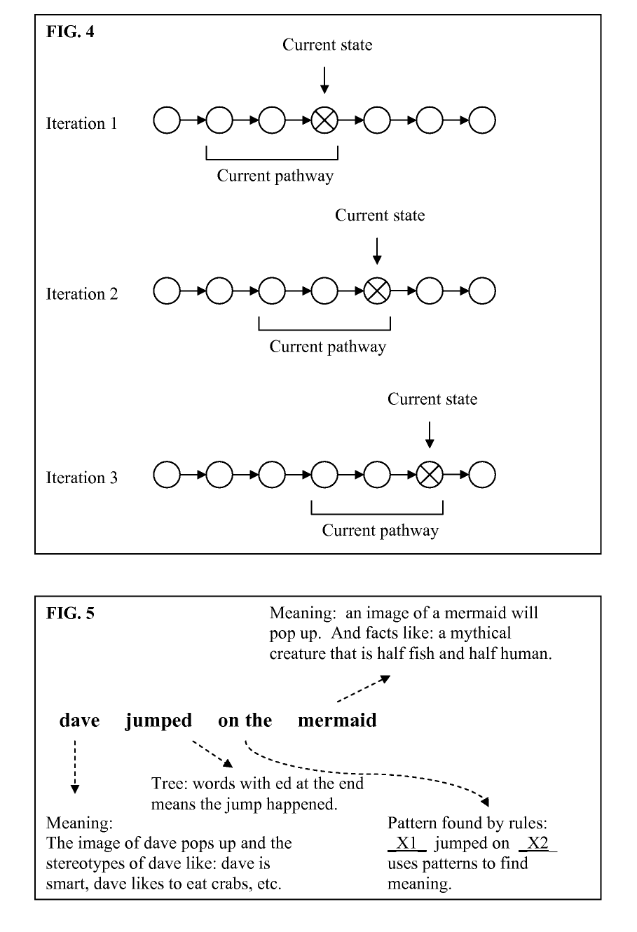

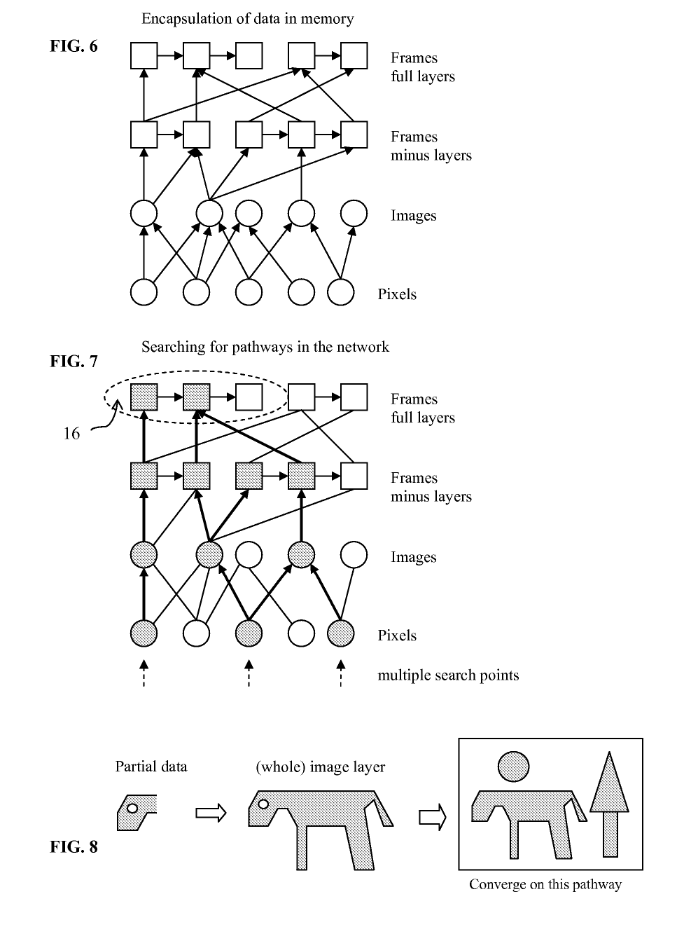

The length of the input will be defined by the programmer. In FIG. 4 the length of the input, or the current pathway, is 3 frames. During each iteration of the for-loop the AI receives one extra frame from a camera and this frame will be attached to the front of the current pathway; designated as the current state. The last frame of the current pathway will be deleted. The current pathway will be the fixed pathway searched in memory at each iteration of the for-loop.

Storage

Human beings store information in terms of a movie. If that person lives for 10 years then the brain has to store 10 years worth of video. If that person lives for 1 thousand years then the brain has to store 1 thousand years of video. The purpose of the storage is to collect large amounts of movies and store them in a way that will minimize repeated data and prevent memory overload. The current neural networks or compression programs can't do this. My HLAI can store large amounts of movies in a network where all the data are interconnected.

Data is stored in terms of a movie—frame by frame. The things that can be stored in the frames can range from images to sound to other senses such as taste, touch, and smell. I call these data, objects, because they can be “anything”. An object can be a dog barking or a blue pencil or a letter. Objects can also be encapsulated such as a hand is one object that is encapsulated in another object, the arm. Objects can also be combined. One example is the sound of a car zooming by and the images of the car moving. (When I mention words such as: pathways, data, information, and movie sequences I'm referring to objects)

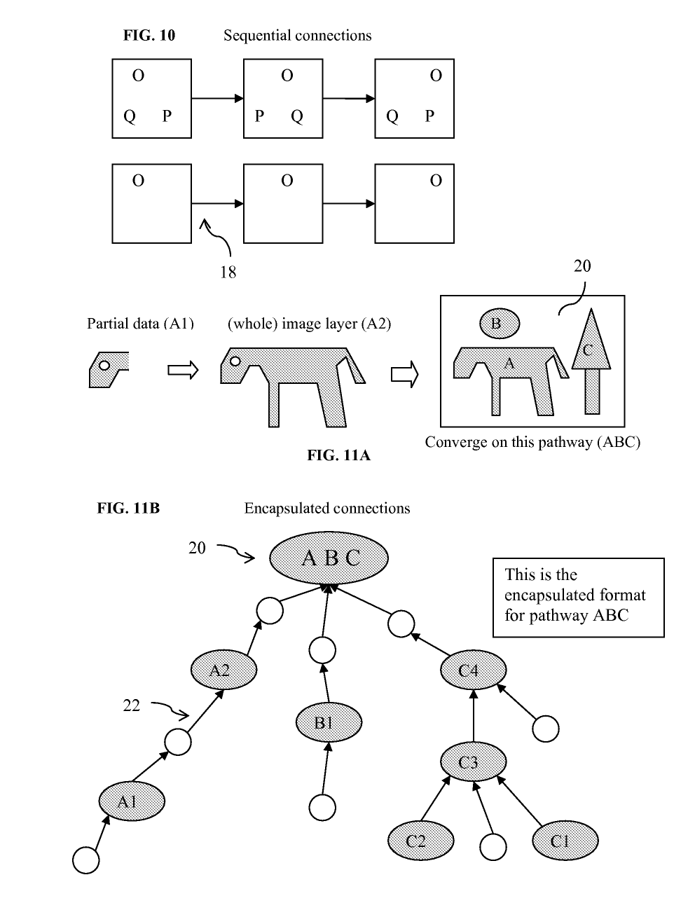

For each data in memory there are two types of connections: sequential connections and encapsulated connections. Both types of connections are independent of one another but are used to connect data in the same storage space. The sequential connections 18 are shown in (FIG. 10), where each arrow represents a sequential connection. Data are stored in the frames and the data can be anything. On the bottom (FIG. 11B) is a diagram of encapsulated connections 22. These are connection points that states that one object (data) is encapsulated in another object (data). The AI will be using the sequential connections to predict the future and the AI will be using the encapsulated connections for storing and retrieving information from the network (FIG. 14).

As the AI learns knowledge from the environment the weights of the connections (for both connection types) will get stronger and stronger. In some cases the connections get weaker and weaker based on external factors such as pain or pleasure. When data is repeated the data gets stronger. When data is unique and new it is created. As time passes the data that aren't trained often will be deleted from the network and data that are trained often is kept in the network. This is similar to how humans remember things. The most important information is kept in memory while the minor information is deleted.

Data in memory are also organized into two groups: commonality groups and learned groups. The commonality groups are the groups that have some form of common physical trait. A man and a women have common traits. Although they are different they both have 2 arms, two legs, and 1 head. The learned groups are groups that are learned to be the same. For example, a horse and a pig look absolutely different. However, they are both animals. The word animal is the learned group for both the horse and the pig.

Both the learned groups and the commonality groups must co-exist in the same storage space. All the data are also encapsulated within these two groups. In memory, anything that has similar traits to each other will be grouped and brought closer together. This is how the data in the network are interconnected and each data is connected to other data in the network globally. An example of this is from the diagram (FIG. 6). This diagram displays the level of encapsulation for visual images and movies. The lowest level will be the pixels. The pixels are encapsulated in the images. Next, the images are encapsulated in the frames. Finally, the frames are encapsulated in the movies.

In the current neural networks, when data is inserted into memory, every data in the network must be modified. This can waste a lot of disk space and computer processing time. The HLAI program on the other hand only changes specific data in memory but at the same time preserve the fact that the network is interconnected. The secret is that when the AI stores a pathway in memory it looks at its neighbors to find if there are any commonality and learned groups nearby. When and if the AI finds common groups it will bring those data with the same group closer together. Referring to FIG. 3, if two identical nodes are close enough (radius 14) they will merge into one and this will free up disk space. The new nodes will be created and connected to existing nodes in the network.

In terms of the topology of storage, data will be contained in a 3-dimensional grid where the movie pathways are stored as trees or branches of trees. In FIG. 12 the conventional way of building trees, networks, hash tables, vector arrays, or linklists will not work. Most of the data structures used today store information in one fixed tree with one fixed starting point. This would mean that in order to store information the tree has to be traversed from a fixed point and stored in its appropriate area. In FIG. 12 the relationship between elements A B C in the first tree will not have any relationship to A B C on the second tree and can not be brought closer together.

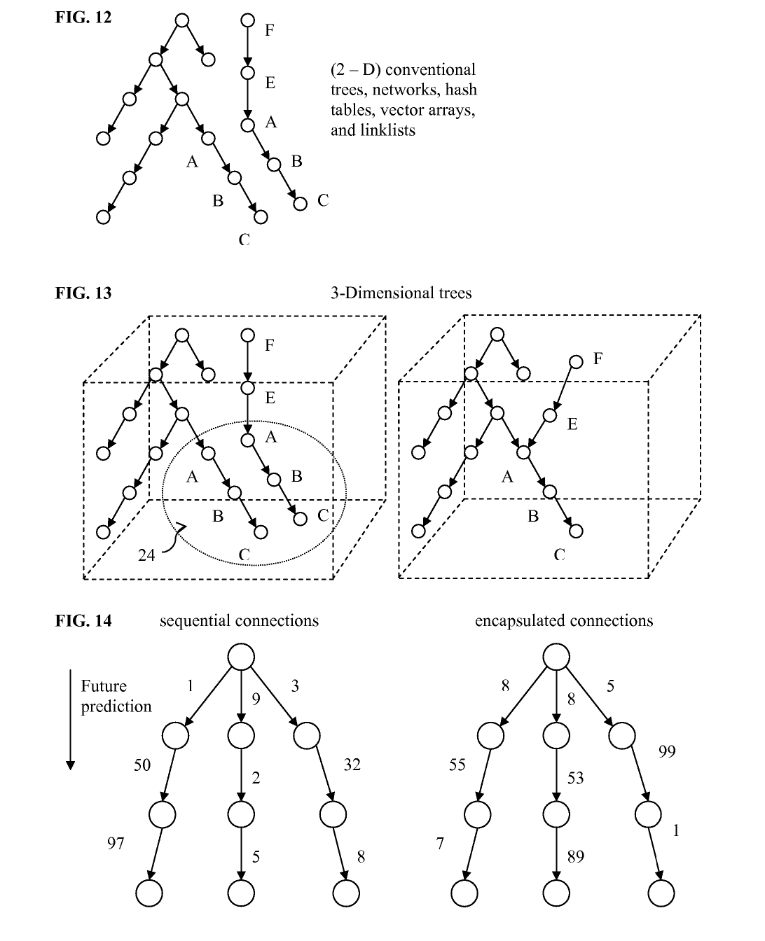

In a 3-dimensional grid the trees do not have a fixed point to start from nor does it require traversing the tree to store information (FIG. 13). The data is not stored in one tree but multiple trees that grow in size and length. Data in memory can shrink because data can be forgotten or it can grow if new data is inserted. Sections of long trees can be broken up into sub trees or it can migrate from one part of memory to another part of memory (this process is slow because the network needs time to adequately self-organize data and to preserve the global data connections).

One advantage of 3-d storage is that the AI can store pathways anywhere in the 3-d space without having to search and identify items from a fixed point. All the trees and all the branches of the trees can be easily retrieved by the search algorithm discussed below.

Another advantage of 3-d storage is that the AI can bring branches of trees together without traversing the branches of the trees. In FIG. 13 the AI will bring commonality traits of all the branches of the trees that fall within a given radius 24. A,B,C are the common traits. Any data that is contained in the radius will be subject to self-organization, while data outside of the radius will not be affected. This will bring relations between data closer together where the data can self-organize itself only in specific areas. This will also preserve the fact that all data in the network are interconnected in a global manner.

The movie pathways are stored and arranged in memory based on their sequences. This will create a 3-d environment using the 2-d movie frames. Although the movie will have many variations, many temporary objects, and many object layers, the function of self-organization will knit all the data in memory together. Anything that is stationary is more likely to have a permanent place in memory, while objects that move a lot is temporarily stored. After averaging out all the data, the 3-d environment will be established first because the majority of our environment stays the same. Things like pedestrians, moving cars, and non-stationary objects are forgotten. The 3-d environment is considered one big floater because it has a fuzzy range of itself—the environment can be day or night or rainy or damaged and so forth but because it falls within the floater's fuzzy range it will still be identified as the environment (floaters will be discussed shortly).

Retrieval of Data in the Network

The purpose of retrieving data from memory is to find one pathway, the optimal pathway, that best matches the current pathway.

For retrieving data from memory, the strength of each data's encapsulated connections in memory has already been established based on training (FIG. 14). Searching for data is accomplished by following the strongest encapsulated connections. This means that if the AI receives partial data of an image it will follow the strongest encapsulated connections to get the full data of an image.

Retrieving data from the network will require multiple search points. The AI will randomly pick out search points in the network. These search points will communicate with each other during the search process to find the data that it is looking for. This form of searching for information is faster than any search algorithm in computer science because it uses multiple search points along with a form of fuzzy logic to get information. This searching of data is kind of like throwing ants randomly in a room. At the center of the room is a piece of candy. As the ants searches for the candy they will communicate with each other to find the candy. When one ant finds the candy all the other ants know where the candy is located.

Each search point will communicate with other search points on search results such as successful searches, failed searches, best possible searches and unlikely possible searches. Each search point has a priority number, and determining the priority number depend on these criteria: the more search points that merge into one search point the higher the number, the more matches found by the search point the higher the number, and the more search points surrounding that search point the higher the number. The higher the priority number the more computer processing time is devoted in that search point and the lower the priority number the less computer processing time is devoted in that search point.

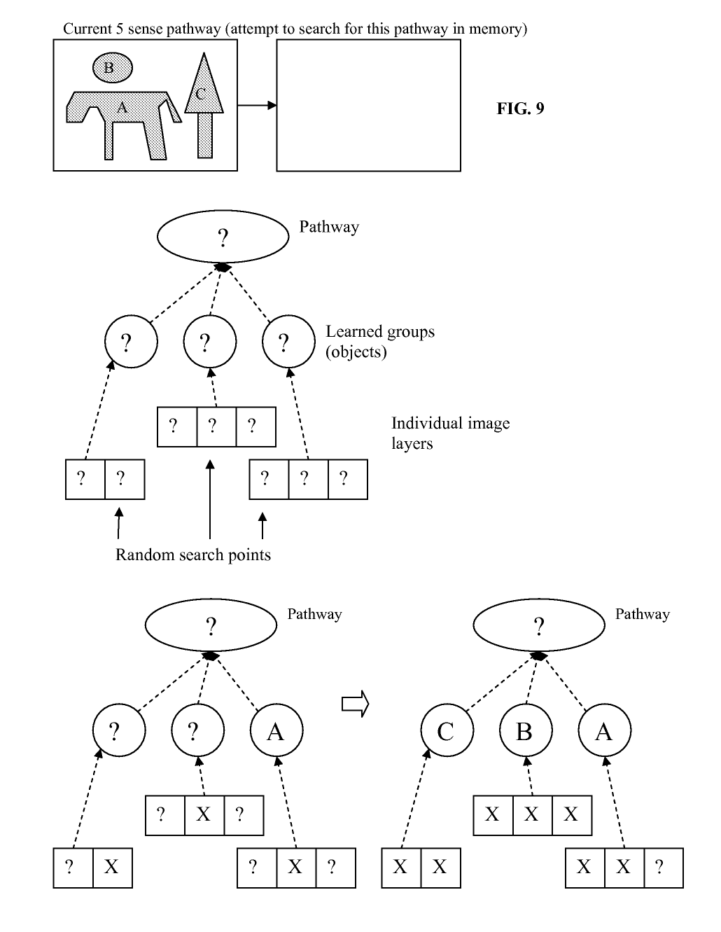

The retrieval of data uses both the commonality groups along with the learned groups to find information. The learned groups use the top-down search method and the commonality groups use the bottom-up search method. Both the bottom-up search method and the top-down search method will be used to search for information. In (FIG. 7) the search is done using commonality groups. In (FIG. 9) the search is done with both commonality and learned groups.

First, the AI breaks up the current pathway into sections. The current pathway is the pathway the AI is currently experiencing. The image processor will guide the process of breaking up the data into sections. Each section will be searched in memory based on randomly spaced out search points. All searches are done by traveling on the strongest encapsulated connections. Each search point will communicate with other search points on possible good searches or failed searches. The search points will merge together when they have the same search results and their priority number will be combined. The better the search result the more search points will be in that area. This will happen throughout all the search points until they converge on a (pathway 16) match for the current pathway (FIG. 7). If the current pathway isn't found in memory the AI will find the closest match.

The learned groups are used in the search process to find data even faster because they can tell the search points what are continuous frames and what aren't continuous frames. For example, if a search point finds one cat image in memory then the image sequence of the cat is also found in memory because visual images are stored in a 3D environment. In FIG. 9 the X marks the individual search points. These search points are known as partial data. The purpose of the search points is to find the whole data. Each search point will follow the strongest encapsulated connected nodes to find better matches. Once the whole data is found it will tap into the whole data's learned group. In this example “A” represent horse, “B” represent the sun, and “C” represent a tree. The whole data is the visual image of the horse. Partial data is the visual head of the horse. When the whole image of horse is found, that image has a learned group, the word “horse”. Once the learned group “horse” is identified then all the sequential images of horse from the current pathway will also be identified. This process will repeat itself for A, B and C. The search points will keep trying to find better and better matches until the entire network is searched.

When the AI locates the optimal pathway (or the best pathway match) in memory that is where the current pathway will be stored. But before that can happen a process of breaking down the current pathway into its encapsulated format must be done. This process consumes a lot of disk space but is necessary to preserve the global network. In (FIGS. 11A and 11B) the AI breaks down the current pathway into its encapsulated format based on the pathways the search function took to find the optimal pathway 20. This means that pathways that lead to the optimal pathway 20 are used to break down the input data into its encapsulated parts. Once the encapsulated format is created for the current pathway, new data will be created and stored in its respective area while data already in the network will be strengthened.

In (FIG. 11B) the current pathway is broken up into objects A, B, and C. Then it further breaks down the objects into its encapsulated objects. Things that make up that object, most notable the strongest objects, will be broken down. This process will go on and on until the individual pixels. If this takes up too much disk space and computer processing time the programmer can define how far the AI can break down the images. For example, break down images until the pixels are made up of groups of 6.

However, understand that the data in memory forgets. Several hours after the new data is inserted into memory, half of the data will be forgotten. If the data is trained many times it will stay in memory permanently, while data that happens coincidentally will stay in memory temporarily.

The Rules Program

Objects

Objects can be anything. It can be sound, it can be vision, it can be touch, and so forth. A visual word can be an object, a sound of a word can be an object, or the visual meaning of the word can be an object. For different senses the objects can be represented differently. There is also the consideration of combinations of objects together such as a visual object in conjunction with a sound object. A car zooming by is a combination of a visual object and the zoom sound is the sound object. Or dropping a pencil on the ground is a combination of visual and sound objects.

Another factor is that objects can be encapsulated. For example, a hand is an object that is encapsulated in another object, a human being. Another example is a foot is an object encapsulated in another object, a leg.

The way the program learns these objects is by repetition and patterns. Each object is represented by strength and if it ever repeats itself the strength gets stronger. If the object don't repeat itself then it will forget and memory won't have a trace. 1-d, 2-d, 3-d, 4-d, and N-d objects can be created by repetition and patterns.

Object Association is the Key to the Conscious

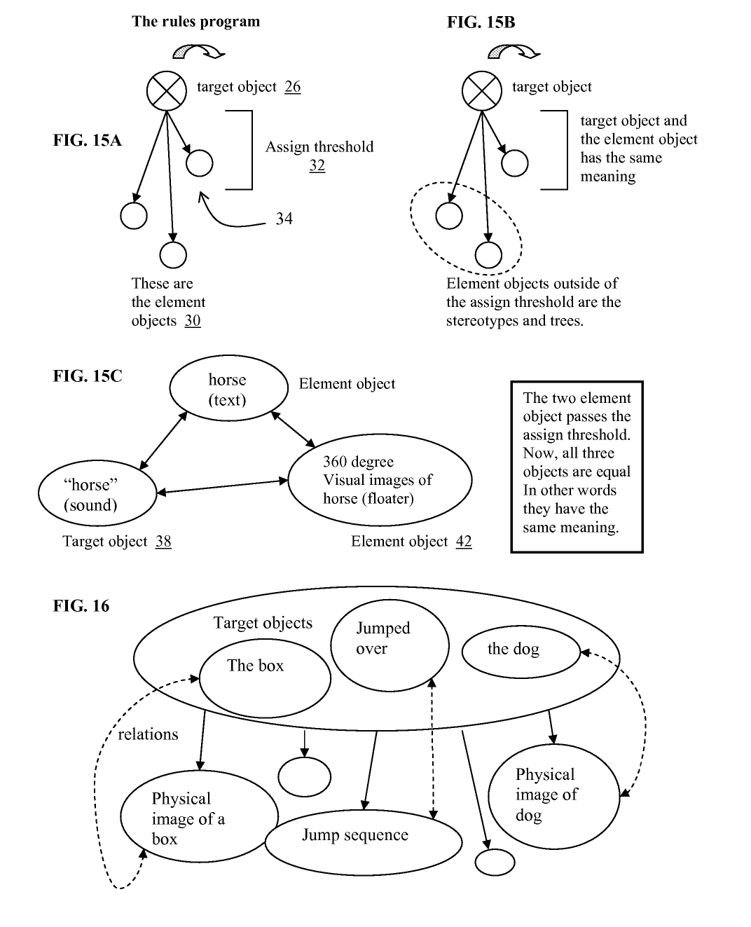

For each object the AI has to find other objects in memory that have association. “The more times two objects are trained together” and “the closer the timing of the two objects are” the more association the two objects have with one another. FIGS. 15A-15B are diagrams depicting the rules program. The object that will be used to find associations is called the target object 26 and the objects that have associations are called element objects 30.

When the AI recognizes the target object from the environment it will activate closest element objects that have association to the target object. There are three types of element objects:

A. equals (same meaning)

B. stereotypes

C. trees

Equals

Objects that are very close to each other are considered “equal”. Referring to FIG. 15A-15B, when any element object 34 passes the assign threshold 32 the element object 34 and the target object 26 are considered equal—they have the same meaning. (FIG. 15C) One example of this is the sound “horse”, if the sound “horse” is the target object 38 and the element object 42 that passes the assign threshold is a visual image of a horse then both the sound “horse” and the visual image of horse is considered the same.

Stereotypes

Stereotypes are facts about the target object. Objects that are associated with the target object but are not consistent are stereotypes. These objects are also farther away from the target object. We look at the fixed object as a part of the overall object. If the target object is “cat” and “cat” is a part of “cats don't like dogs”, then we can safely say that “cats don't like dogs” is a stereotype of “cat”.

Trees

Trees are objects that are usually farther away from the target object. Sometimes trees have relations to the target object. A tree is just instructions that people teach you at certain situations. Timing of the object is the key difference between stereotypes and trees. This is the most important trait in my program to convey intelligence. One example of trees is when you cross the street, the tree “look left, look right and check to make sure there are no cars before crossing the street” pops up in your mind.

To better understand about the rules program I will explain how the HLAI learns language.

How Human Robots Interpret Language

When dealing with language there are many AI software that tries to represent language. Among the most popular categories are: language parsers, discrete mathematics, and semantic models. None of these fields (or a combination of them) can produce a machine that can fully understand language similar to human beings. Designing a machine that can learn language requires a lot of imagination and creativity. My design of how to represent language comes from two sources: Animation and videogames. Mostly videogames because that is where my key ideas come from.

Common sense knowledge using language is very hard to represent on a computer because it's “all or nothing”. Either the computer can understand the language similar to human beings or they don't understand the language at all. People who clean rooms for a living not only need knowledge about cleaning rooms but also common knowledge that humans have. Basic things like: if you drop something it falls to the ground, if you break the law you will go to jail, if you throw an egg it will fall and break, if you don't eat you will get hungry. These are basic knowledge that every human should know. Machines on the other hand has to be fed the knowledge manually, unless someone builds a learning machine similar to a human brain. Even universal learning programs like the neural network require programmers to manually feed the rules and data in order for it to work. Like I said it's “all or nothing”.

If there exist a robot janitor and the function of the robot janitor is to clean the house, what happens when it's mowing the lawn and it begins to rain? Common sense tells a real human to take shelter. However, in the case of the robot janitor, it doesn't know that it's raining, unless you program it to take shelter when it rains. Another example is what if the janitor accidentally drops food on the ground; does it know that the food is contaminated? This is why it is very important to build a machine that is similar to a human brain in order for it to do anything human. The only way to build such a machine is by making software that can understand language.

Language is important because the robot needs to learn things from a society. The only way that humans can communicate with robots is if they both have some form of common language so that both parties understand each other. People who speak English can understand each other because the grammar and words used can be understood by everyone. Think of language as the communication interface between human robots and human beings.

There are basically 3 things that the AI software has to represent in the language: objects, hidden objects, and time. I don't use English grammar because English grammar is a learned thing. These 3 things I mentioned are a better way to represent language. If you think of objects as nouns and hidden objects as verbs, then that is what I'm trying to represent.

Objects

One day when I was playing a game for playstation 2, I couldn't notice that the game was repeating itself over and over again. When the characters jumped the same images appeared on the screen. When the enemies attacked the same images appeared on the screen. These repeated images was what gave me the idea that I can treat all the images on the screen like image layers in photoshop. I can use patterns to find what sequences of images belong to what objects. When the 360 degree images of one object is formed then I can use a fixed noun to represent that object (I call this 360 degree image sequence a floater). For example, if I have the 360 degree floater for a hat I can assign the letters “hat” to the floater. If I have the 360 degree floater for a dog I can assign the letters “dog” to the floater. The image processor will dissect the image layers out and the AI program will determine what the sequential image layers are. This is done by averaging the data in memory—taking similar training data and analyzing what the medium is. When the averaging is finished the floater has a range of how “fuzzy” the object can be.

Things like cat, dog, hat, dave, computer, pencil, tv, book are objects that have set and defined boundaries. Things like hand, mall, united states, universe don't have set boundaries. Either it doesn't have set boundaries or they are encapsulated objects. One example is the foot, when does a foot begin and when does a foot end? Since a foot is a part of a leg it is considered an encapsulated object. Another example is mall, when does the mall end and when does it begin? Since there are many stores and roads and trees that represent the mall we can't say where the mall ends and begins. The answer is the computer will figure all this out by averaging the data in memory. Another thing is that some objects are so complex that you have to use sentences to represent what it is. The Universe is one example, when does the universe begin and end? The answer is we use complex intelligence in order to represent the meaning to the word “universe”.

Unfortunately, black and white drawings are preferred in utility patents so I decided not to use colored pictures of videogames. (In U.S. Provisional Application No. 60/909,437, all examples are demonstrated by videogames) Instead I decided to use black and white images of animated movies and comic strips to illustrate my point about objects, hidden objects and time.

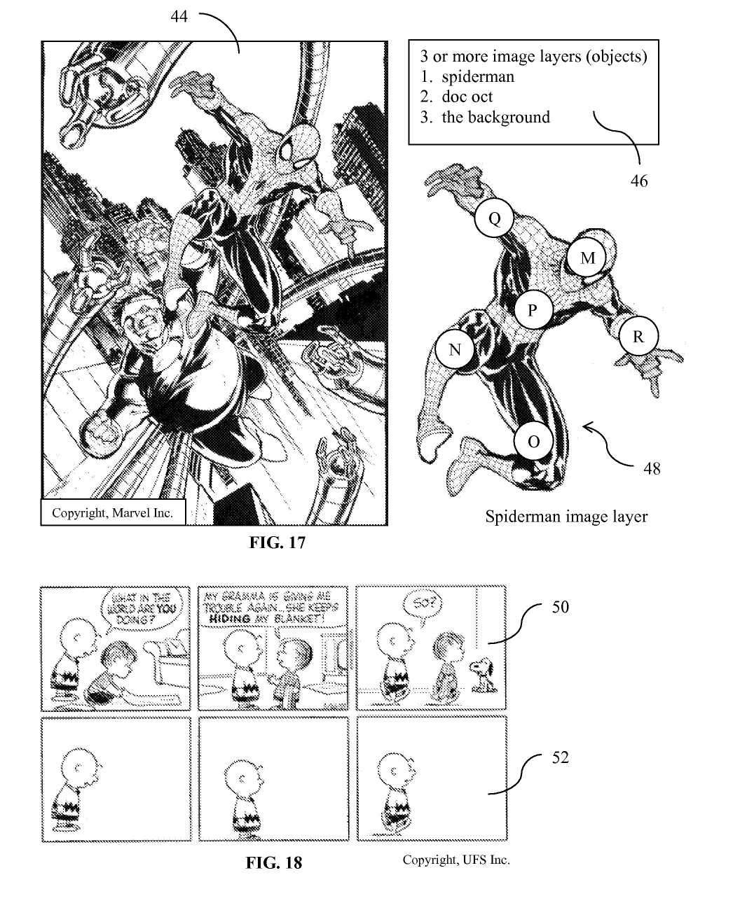

The first two pictures in (FIG. 17 and FIG. 18) best illustrate the point about image layers and floaters. The first picture 44 displays a series of lines and shapes that make up images. There are many things that are displayed in the picture 44. There are: the moon, the city, the tentacles, the walls, the characters, the breakable objects and so forth. The image processor will dissect the most important image layers from the picture (this process can be done in black and white but the image processor will have an easier time with colored pictures). It will then attempt to find a copy of this image layer in memory. Based on certain patterns within all the colored pixels and the relationship between each other the AI will understand what image layers belong “sequentially”—consistency and repetition is the key. The computer will normalize all the image layers (including encapsulated image layers) until it comes to an agreement of what is considered an object and what are encapsulated objects. Referring to FIG. 17, in list 46 is an example of 3 major image layers (objects) that the computer has found: Spiderman, Doc oct, and the background.

The purpose of the image processor is not to identify the image layers, but to delineate image layers that are moving from one frame to the next. The identification of the image layers comes by finding the image layers in memory. The image processor only makes the search process much easier to identify the image layers. One example is the Doc oct image layer. The image processor doesn't know that the tentacles belong to Doc oct. In fact, the image processor will think that the tentacles are separate image layers. Only when the AI identify Doc oct in memory does the AI know that the tentacles is a part of Doct oct.

Now that the image processor has found Spiderman 48 as one image layer, it will randomly break up Spiderman 48 further into partial data. This is represented by letters: M, N, O, P, Q, R. The partial data will each be searched randomly in the network.

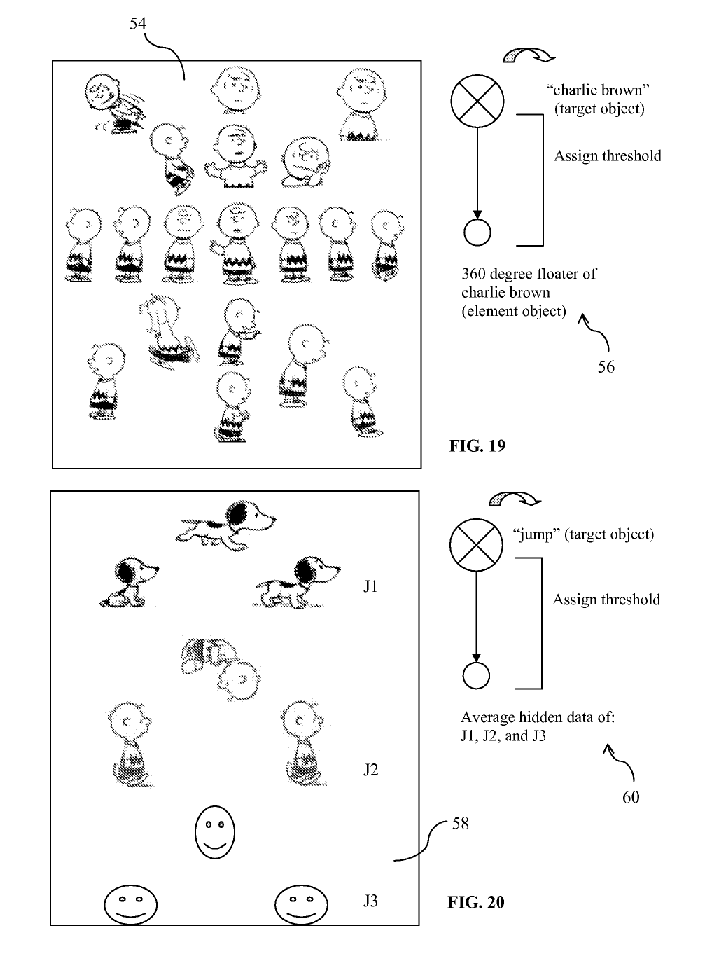

Although I couldn't find comic strips for Spiderman I found comic strips for Charlie Brown instead. In FIG. 18 the image layers of Charlie Brown are cut out from the movie animations 50 and 52. On the second picture (FIG. 19) is the 360 degree floater of Charlie Brown 54. All the possible moves of the character including scaling and rotation are stored as sequences in this floater. If the movie sequence is in 360 degree, like in a videogame, then the floater will have 360 degree image layer for each possible outcome. If the movie sequence is in 2-d then the floater will have only possible outcomes of the character. “The creation of the floater is kind of like reverse engineering a videogame programmers work or reverse engineering an animators work—what do videogame programmers consider an object or what are the animators' cell layers”.

The next step is to take the floater and treat it as an object. This is how I represent objects visually in my program—by using patterns to find the 360 degree images of an object and all its possible moves. The rules program 56 will bring the object “Charlie Brown” and the floater of Charlie Brown 54 together (FIG. 19). The target object is the word “Charlie Brown” and the floater is the element object. Once the floater passes the assign threshold that means the word “Charlie Brown” has the same meaning as the floater. At this point, any sequence wither its one frame or 300 frames of the floater is still considered the same object. You can stare at a table for hours but the table will still be a table. You can also walk around and stare at the table, the sequential images you see is still a table. The question people ask is: what happens if you break the table or what happens if there are other objects that make up a table. The answer is the AI will normalize the objects and output the most likely identification.

There are other topics that concern objects such as encapsulated objects (a human object can have thousands of encapsulated objects) and priority of objects and partially missing objects but I won't get into those topics.

Hidden Objects

Sometimes there are objects that don't have any physical characteristics. Action words are things that don't have physical characteristics. Things like walking, talking, jumping, running, throwing, go, towards, under, over, above, until, and so forth. These words are considered hidden objects because there is no image, sound, taste, or touch object that can represent them. The only way to represent these objects is through hidden data that is set up by the 5 senses. Let's call the 5 senses the current pathway—the pathway that the computer is experiencing. In order to illustrate this point I will only refer to the visual part of the current pathway.

Within the visual movie are hidden data that I have set up. This is done because I wanted the computer to find patterns within visual movies. Some of these hidden data are: the distance between pixel/s and the relationship between one image layer and another image layer. Let's illustrate this point by using a simple word: jump. The computer will take several training examples from the visual movie regarding jump sequences. As you already know, variation to a jump sequence can range exponentially. A person can jump from the front, back, side, at an angle, top, 10 feet away, or 100 yards away. The person doing the jumping can be other objects such as a dog, rat, horse, or even a box. There are literally infinite ways that the jump sequence can be represented in our environment. The computer will take all the similar training examples and average the hidden data out. Every time that a hidden data is repeated the computer makes that hidden data stronger (hidden data are considered objects). The hidden data are also encapsulated so that groups of common hidden data are combined into one object. As more and more training are done the computer will have the same hidden data for the same fixed word: jump. The rules program will bring the word “jump” and the hidden data closer to one another. When it passes the assign threshold the word “jump” will be assigned the meaning (hidden data).

In FIG. 20 the picture 58 is an example of how the word jump is assigned a meaning. First, the computer analyzes each jump sequence: J1, J2 and J3. It will analyze all the hidden data that all three jump sequences have and group those common traits into an object. Then the rules program 60 will take the word “jump” and assign it to the closest meaning.

The rules program is another thing I want to mention. When you train the robot, timing of the training is crucial. The reason why the word jump is associated with the jump sequence is because the jump sequence happens and either during the jump sequence or closely timed is the word “jump”. The close training of the word jump and the jump sequence is what brings the two together. If the word “jump” is experienced and the jump sequence happens 2 hours later, the computer will not know that there is a relationship between the word “jump” and the jump sequence. This is how the machine will learn language, by analyzing closely timed objects. This is also a way to rule out coincidences and things that happen only once or twice.

Time

Time is another subject matter that has to be represented in terms of language. In my program there is no such thing as 1 second, 1 minute, 5 years, or 2 centuries. The time that we know are learned time and isn't used in my program. What I have done is create an internal timer that will run infinitely at intervals of 1 millisecond. The AI will use this internal clock and try to find if there are objects (words) that have relationships to the internal clock. The timing in the AI clock can also be considered an object. For example, if someone says “1 second”. After many training examples the computer will find a pattern between “1 second” and 100 milliseconds in the AI's internal clock. This internal clock of 100 milliseconds will be an object that has the same meaning as “1 second”.

The above information concludes how my program represents things like nouns, verbs, time, and grammar. When we are dealing with entire sentences the computer has to do all the hard work by averaging all the training examples, looking for patterns, and assigning meaning to words in the sentence. The sentence itself is considered a fixed movie sequence while the meaning to the sentence changes as the robot learns more In FIG. 16 the diagram gives an example of how the rules program will assign meaning to the sentence “the box jumped over the dog”. Just like how the rules program learn nouns and verbs, it will learn the meaning of the sentence by finding the “complex patterns”. The target object is broken up into sub-groups and the element objects are broken up into sub-groups. The AI will then attempt to string the element objects and combine them into other element objects that best represent the entire sentence.

This type of machine to represent language is considered “universal” because the program can be applied to all languages including sign language. Different languages use different words to represent the same things. “cat” in English, “neko” in Japanese, and “mau” in Chinese are all talking about the same object. Different verbs in English, German, or Latin are all talking about the same verbs. Even something like sign language uses fixed sequential hand motion to represent words and phrases. The grammar too also relies on patterns and different ways of stringing words/verbs together to mean something. This is easily done with the AI program because finding patterns is what it was designed to do. As long as the grammar in that language repeats itself or have some kind of rule (regardless of how complex) then the pattern will be recognized by the AI.

Patterns and Language

Now that I have discussed all the basics of how most words are represented let's get into something more complex such as finding patterns. When a question like: where is the bathroom? is asked, patterns are used to answer the question. These patterns are found by averaging similar pathways in memory. Some of the functions used to find patterns include: using the 3-d environment (in storage), using visual functions such as pixel comparison and image layer comparison, using long-term memory, searching for specific data in memory, and so forth. Where is the book, where is the sofa, where is Mcdonalds, where is the University, where is dave? All these questions rely on their respective universal question-answer pathway. The AI will look into memory and find out that there is a relationship between a question and a specific type of pattern to get an answer. In terms of the bathroom question, the AI will find that it has to know where it is located presently (this is done by looking around and identifying its current location). Then the robot will look into memory for the bathroom that is located in the current location. If the bathroom location is found in memory it will output the answer: “the bathroom is located -----”. If it doesn't know (no bathroom memory in current location) it will either say it doesn't know or it will attempt to find more information to answer the question.

This pattern finding doesn't just apply to questions and answers but also statements and orders. If someone said: “remember to buy cheese at the supermarket”. This statement has a recurring pattern and it requires that there are many training examples so that the AI can find these patterns. The pattern is when the robot gets to the supermarket, sometime during the purchase of goods, the statement pops up in memory “remember to buy cheese”. Sometimes the robot forgets (either a learned thing or the pattern wasn't trained properly).

The data in memory will become stronger and stronger as more training is presented. Language or sentences are considered data in memory. These type of data will become considerably stronger than other data because language is fixed while other things constantly change. Language is what humans use to classify other data in our environment which includes visual objects, nouns, verbs, sentences, scenes, description, tasks, and the like. In other words, language brings order to chaos. This is why when we take input from the environment language has top priority over other data. This is also why our conscious activates sentences and visual scenes more than anything else when we consciously think.

The AI will average all the data in memory and create a fuzzy range of itself called a floater. Data in memory would include images, objects, pathways, entire scenes, and so forth. Averaging of data (or self-organizing of data) takes place when input is stored in memory. After the averaging, a fuzzy range of the data will be the result. In terms of sentences the average meaning of the sentence will be stored and not an exact sentence.

A. Averaging the Meaning of Sentences

When teachers say:

(Y1) “look left, right, and make sure there are no cars before crossing the street”

(Y2) “remember to see if there are no cars from the left and right before you cross the street”

(Y3) “don't forget to look at all corners to make sure there are no cars before crossing the street”

All the sentences are saying the same thing. This is why language is so important, we can interpret language infinite ways and they are all talking about the same things. The computer will recognize all of these things and it will average out what the meaning of the sentence is

Referring to FIG. 25, after many training of the pathway the AI has universalized the groups of pathways (Y1, Y2, Y3). Y1, Y2, and Y3 disappear and what you have left is the average of all the training data located in that area (Steps 86 and 88).

The AI not only averages out trees in pathways but entire pathways. The purpose is to universalize similar pathways into one pathway. This one pathway will contain the fuzziness of infinite possibilities. We can also take this universalized pathway and encapsulate that to make even more complex pathways.

The next two examples illustrate how language can be incorporated into the human conscious to accomplish tasks and solve problems.

A. ABC block

B. Answering universal questions

ABC Block

In this problem we want to use a basic intelligent problem that kids can solve. The ABC block is just 3 square blocks and the robot has to find a way to stack the blocks in an A B C format.

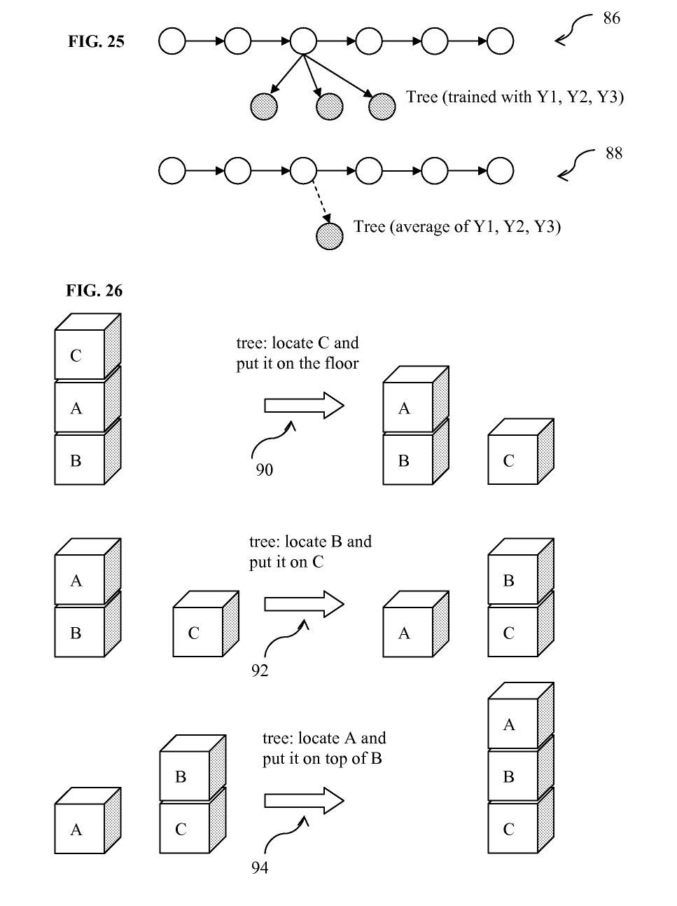

We accomplish this problem with the English language. We simple tell the machine: “I want you to stack the blocks up starting with C then B and finally A”. From this one sentence the robot should be able to finish the task. It doesn't matter what order the blocks are put in. It doesn't matter where the blocks are. If the robot understands the sentence it will carry out the command. Of course we have to train it to understand the steps to accomplishing this easy task. Let's say that we had the blocks in this order and we wanted the robot to stack the blocks up from ABC (in FIG. 26)

Referring to FIG. 26, we learned from teachers that in order to solve this problem we: “locate the C block”, “Take the C block and put it on the ground”, “then find the B block and put it on the C block”, “finally find the A block and put it on the B block”. These sentences are trees that tell you what to do in order to solve this problem. These trees were trained by a teacher many many times before you can attempt to solve this problem. By the way, these trees are your conscious (Step 90, 92 and 94).

These trees encapsulate the instructions to accomplish a goal. We train them by teaching the robot that this sentence is followed by these instructions. The robot will create pathways in memory that will store the instructions step by step. This may not sound impressive but let's say you wanted to solve something like lining up the entire alphabet letters in a certain order. If you preprogram the solutions there will be couple trillion possibilities you have to manually preprogram. With trees we can encapsulate instructions in the form of sentences. And these sentences can be encapsulated into even more complex problems, thus making a complex problem into a simple problem.

Answering Universal Questions

The answering of questions relies on patterns in order to be understood. We are able to find the patterns and universalize the pathways so that when someone ask us a question we can give them the appropriate answer.

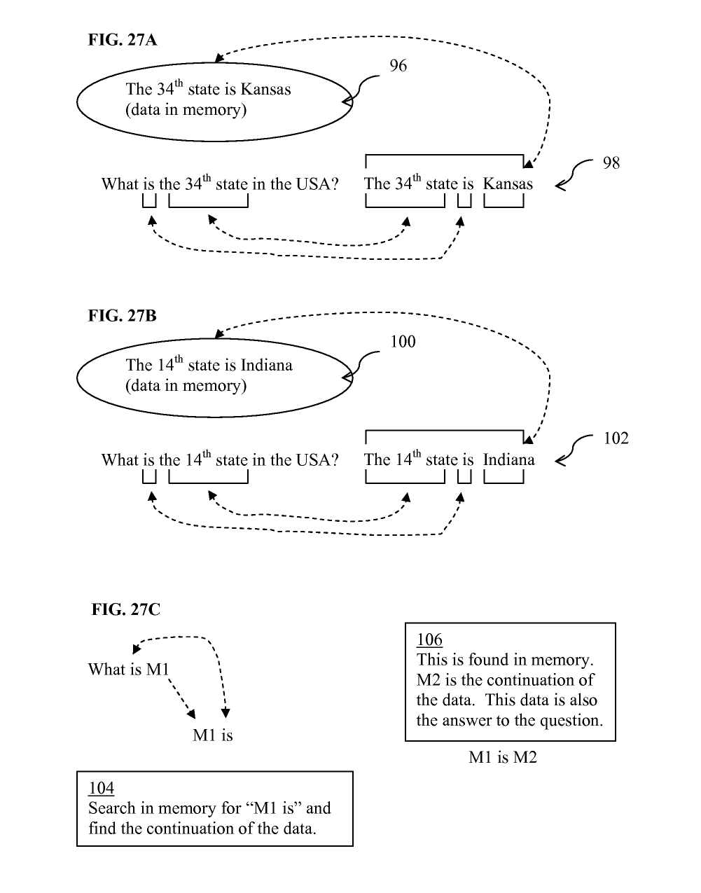

8=8 is an equal object or Dave=Dave is an equal object. They are equal is the relationship between the two objects. Whenever the computer finds two objects equal it will establish a relationship between the two objects and find patterns that revolve around these two objects. From (FIG. 27A-27C) we have taken all the equal objects and we have tried to find patterns between those equal objects. Answering questions is a pattern that relies on equality to find the answers. This may not be very clear when you look at the first example, but after looking at the second example and comparing that with the first example there is clearly a pattern there.

By establishing a relationship between equal objects the computer will be able to find patterns between different training data and forge a universal pattern that can answer a universal question. The examples in (FIG. 27A and FIG. 27B) have a pattern which is depicted in (FIG. 27C). In FIG. 27A data 96 in memory is used to establish equal objects to the sentence 98. In FIG. 27B data 100 in memory is used to establish equal objects to the sentence 102. In FIG. 27C a pattern has been established represented by blocks 104 and 106.

The pattern found in (FIG. 27C) can answer any question that has that kind of configuration. Examples of this would be:

what is 8+8? 8+8 is 16.

what is the 21st state in the USA? The 21st state in the USA is Illinois.

what is the first letter in the alphabets? The first letter in the alphabets is ‘A’

what is the last letter in the alphabets? The last letter in the alphabets is ‘Z’

As you can notice that this whole human level artificial intelligence program is all about finding patterns. I set up the different kind of patterns to look for and the computer uses the AI program to find those patterns and assign those patterns to language. Language will always be fixed (unless society changes it) but the patterns that represent language changes from one time period to the next. There are also multiple meaning to fixed words.

The Relationship Between HLAI and the Human Brain

The data structure of a human brain and something like a calculator are totally different. On one hand a calculator can process thousands of equations each second but the human brain processes only 1 equation per second. This doesn't mean that the calculator is more superior than a human brain. It just means that the brain is a different form of computer that processes information differently. The human brain is a very powerful computer that can learn from past experiences and understand common sense knowledge which is something current computers can't do.

The human brain consists of 10 billion neurons and 60 trillion connections. The data are stored in the neurons in terms of encapsulation and commonality. Although the brain has only 10 billion neurons it is able to store almost 8,000 trillion data because of the connections that each neuron has with other neurons. The data are also global in nature and each neuron will have associations with other neurons. All of the neurons and their connections are either strengthened or forgotten. The neurons get strengthened by a process of chemical electricity that makes their connections with other neurons stronger (or weaker).

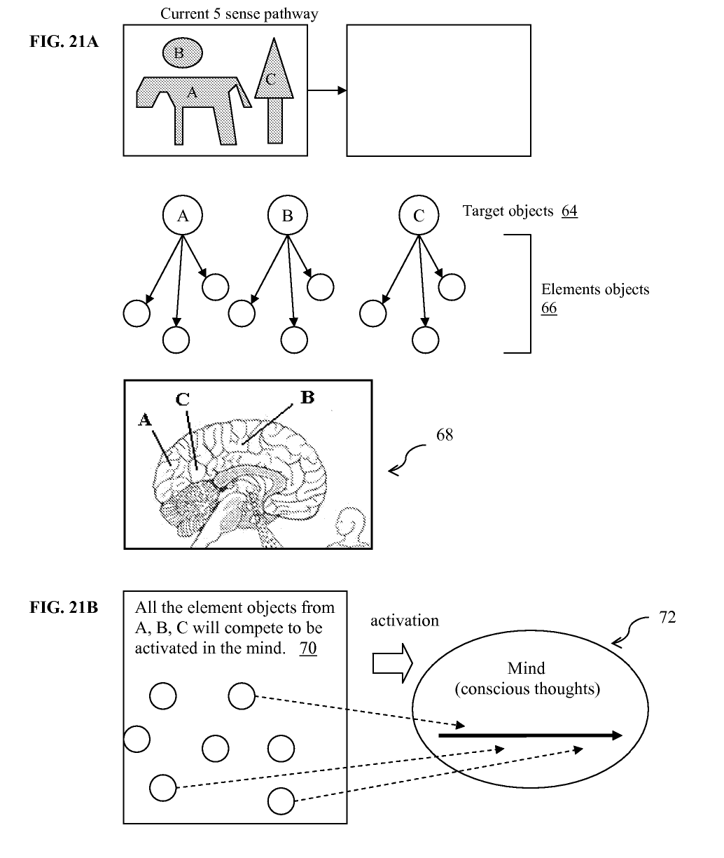

When an object is recognized like an image or a sound, electricity is run through that neuron and its connections (FIG. 21A). This is how psychologists can understand what parts of the brain does what functions—by using a computer to analyze the electrical activities in the brain. Since there are many sensations coming into our brain each second, there isn't just one area the brain is active but activity will run in multiple areas of the brain at the same time.

I did some observation of how the brain sends electricity throughout the neurons and came to the conclusion that we can actually simulate this activity in a software. First the brain locates an object (let's call this object the target object). In this case an object could be anything—it can be an image of a car or a sound of a dog barking. Once the brain locates the target object in memory it runs electricity throughout all of the connections associated with that object. This will strengthen not only the target object that has been located but it will bring all the other objects (call these element objects) closer to the target object.

When the AI locates the three visual objects: A, B, C in memory it will run electricity through these nodes and all of its connections (FIG. 21A).

Referring to FIG. 21B, the mind 72 has a fixed timeline. Only one element object can be activated at a given time in this timeline. This is how we prevent too much information from being processed and allow the AI to focus on the things that it senses from the 5 senses. Step 70 activates qualified element objects in mind 72 in linear order.

This finding is important because we know that the target object that the brain has located has to be strengthened. This is done by applying chemical electricity through that located target object. The only question I had was: “why did the electricity propagate throughout all of its connections too?”. Would that not strengthen all the element objects around the target object too?

The reason why the brain had to propagate electricity throughout all of the target object's connections is because that is how the conscious is presented. The conscious is the voice in your head that speaks to you. It also gives you information about a situation, or help you solve a problem, or tell you definition of words. Referring to FIG. 21A, all the element objects 66 from all the target objects 64 will compete with one another to activate in the mind (the mind can only take in a limited amount of information). When that information is activated in the mind a lesser amount of electricity will be applied to that information and its connections. This is how the mind travels from one subject matter to the next.

The brain modifies information by constantly applying chemical electricity throughout all the target objects coming in from the 5 senses (Step 68). The electricity strengthens not only that target object but it strengthens all the element objects that have association with the target object. This form of storing, retrieving, and modifying information in a network is what allows the host to have human-level intelligence. The next two paragraphs demonstrate how the conscious works in terms of reasoning and interpreting grammar.

Reasoning happens when two or more objects recognized by the AI share the same element objects. The more objects share an element object the better the chance it will get activated. For example, if you had a statement like:

If the weather is sunny and I have free time and my dog is blue then go to the beach.

So, if the AI recognizes “the weather is sunny” and “I have free time” and “my dog is blue” then the stereotype will activate: “then go to the beach”. The recognizing of the objects can also be in any order. These objects can also be a fuzzy range of itself such as the statement: “I have free time” can be represented as “I don't have to work today”.

Understanding entire sentences, which was discussed earlier, depend greatly on the conscious. Understanding grammar structure of a language will depend on things learned in the past (FIG. 5). For example, how are we supposed to learn a word like: jumped. The word jumped has an ed at the end and we know from English classes that if a word has ed at the end that means the verb (jump) happened already. So, when the AI encounters a word like jumped the conscious tells the AI that “words with ed at the end means the jump happened”. This is an element object that activated when encountering the word jumped. This element object tells the AI what the meaning of jumped is.

Predicting the Future

The main function of the HLAI is to predict the future based on the current event. When the AI is applied to a car the current driving state is the current event. The AI has to predict the future so that it can steer the car in the right direction. Out of all the pathways in memory the machine can only follow one given pathway, the optimal pathway. This optimal pathway represents the best pathway the AI can follow to act intelligently in the future. Predicting the future isn't a very easy thing to do. In order to do that the AI must first determine the worth of each pathway in memory based on two criterias: the closest pathway matches and calculating the worth of their future pathways.

The next couple of paragraphs are a recap of how the AI program predicts the future. In (FIG. 1) the program has one for-loop that repeats itself over and over again. The idea is: The computer takes in one frame from the camera, it calculates the best possible future to take, then it takes action. The computer takes in one frame from the camera, it calculates the best possible future to take, then it takes action. The computer takes in one frame from the camera, it calculates the best possible future to take, then it takes action. This loop repeats itself over and over again until the AI is shut down (the instructions in the for-loop must be accomplished within a predefined time limit, usually 1 millisecond). Human beings work pretty much the same way, we take in input from the environment, the brain calculates the best future course, then the human being takes action. This repeats itself over and over again.

In FIG. 1, the first step is to search the current pathway in memory for the closest matches (Step 4). The computer will list the ranks of the searches starting with the best match (Step 6). Next the AI will find future pathways for each of the matches and calculate their future prediction worth. Then, the AI will decide based on the matches and the future prediction on which pathway is worth the most (Step 8). Finally, the AI chooses one pathway to follow (Step 10). This one pathway is the optimal pathway and it will be used to control the AI.

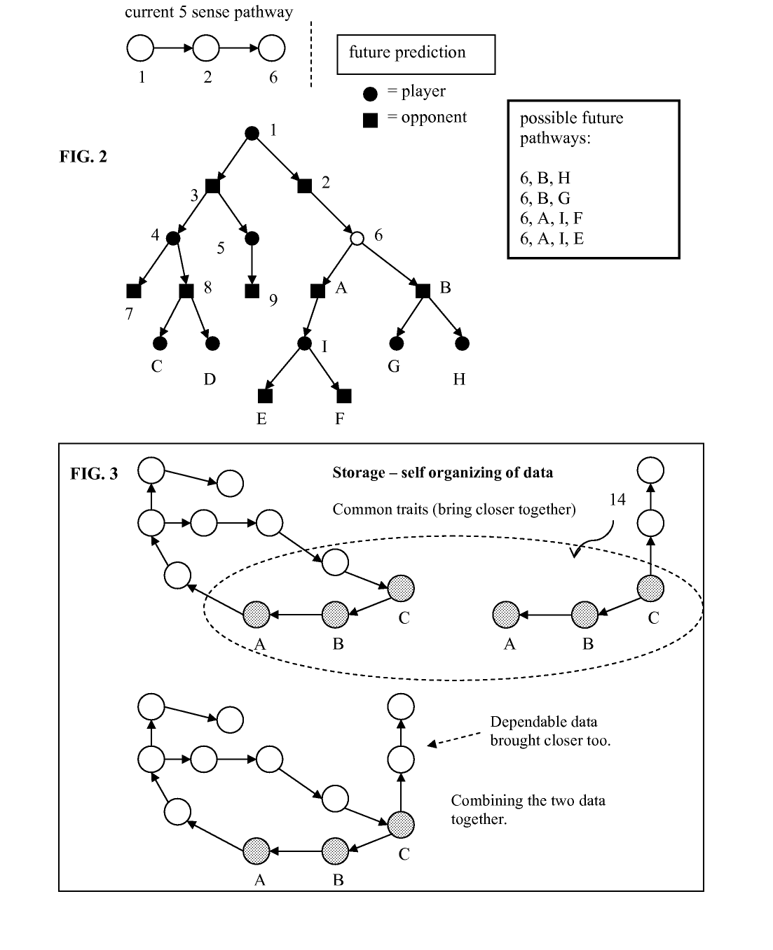

In FIG. 2, I show how the function works from a different angle. The computer basically matches the current pathway with the best match in memory then it calculates the best possible future to take.

This form of artificial intelligence method to predict the future has not been explored before because the possible outcome of an event in life is infinite and the computer can't store all the possibilities in memory. In order to drive a car the AI has to store all the possibilities of driving a car in memory. This would be impossible because the variations of life are infinite (can you imagine storing infinite hours of driving in memory?). This is why researchers have abandoned this field of AI. In my program I made it so that the movie sequences are stored in a fuzzy logic way. The most important data are kept and the least important data are forgotten. This will allow the AI to anticipate the most likely outcome of an event. Self-organization knits all the data together forming object floaters in memory so that one given data has a fuzzy range of itself. One example is a cat. A cat can come in all different kinds of shape, sizes, and color. The strongest sequential images of a cat are considered the center of the object (floater). After determining a predefined range of how fuzzy the cat object (floater) can be, anything that falls within this fuzzy range will still be considered a cat object. The AI will be able to take in any picture of a cat, regardless of how distorted or different it may be, and still identify it as a cat. This is how my program can store infinite amounts of data, by taking the average of an object and creating a fuzzy range for that object. Object floaters don't just apply to individual objects like cat, dog, or shoe, but entire situations or language. Every data in memory has a fuzzy range of itself. The next several paragraphs demonstrate how fuzzy logic is used to predict the future for similar or non-existing pathways in memory.

When my computer program doesn't find a 100 percent match in memory the AI has encountered a deviation (finding a 100 percent match is very rare). There are 4 deviation functions I have set up to solve this problem. It will allow the future prediction to do its job properly and find the most likely next step. I will be using videogames to illustrate this point. Videogame colored pictures can't be used so the images will be done with animated movies. The 4 deviation functions are:

A. Fabricate the future pathway based on minus layers.

B. Fabricate the future pathway based on similar layers.

C. Fabricate the future pathway based on sections in memory.

D. Fabricate the future pathway based on trial and error.

Fabricate the future pathway based on minus layers

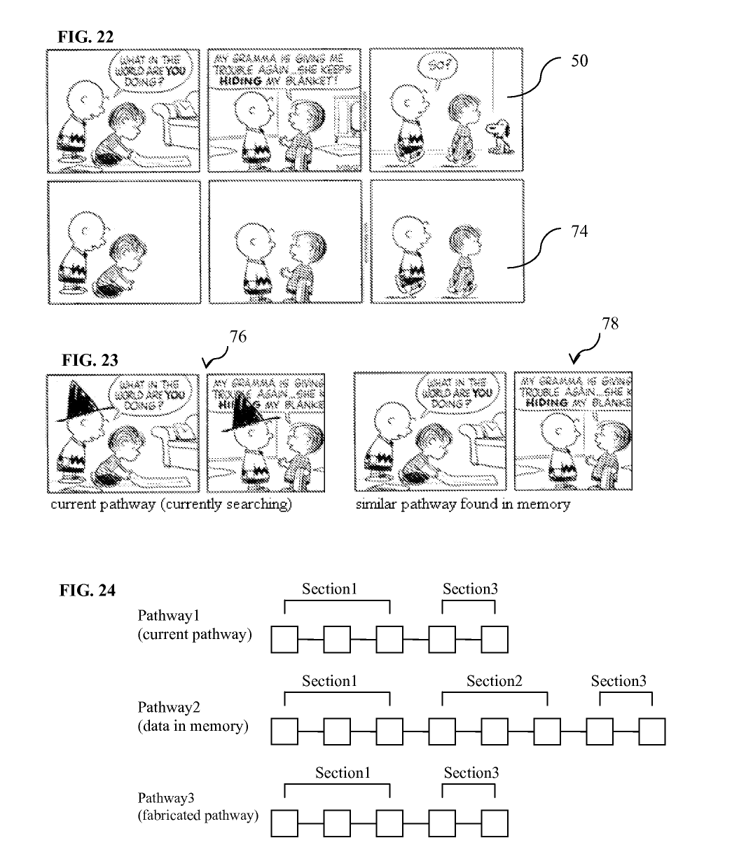

In FIG. 22 the AI minuses layers from the pathways and finds the commonalities between the current pathway 50 and the pathways in memory. For videogames/animation the AI minus object layers from the game. The background layer is minused from the game and the remaining layers matches the current pathway 50. This means the sofa, the blanket, the walls, snoopy, and the captions are minused. The two character layers (Charlie Brown and his friend) are used to play the game (pathway 74).

Fabricate the Future Pathway Based on Similar Layers

In FIG. 23 the AI will find similar layers between the current pathway and pathways in memory. For videogames/animation the AI finds similar object layers. The Charlie brown layer with the hat (pathway 76) isn't stored in memory. However there is a similar Charlie brown layer without the hat stored in memory. Because the Charlie Brown layer with the hat (Pathway 76) and the Charlie Brown layer without the hat (Pathway 78) look similar the computer will use Pathway 78 instead of Pathway 76 to play the game.

Fabricate the Future Pathway Based on Sections in Memory

In FIG. 24 the AI constructs new pathways from sections in memory. This process takes sections of pathways from memory and combines them to form new pathways for the AI to pick. Pathway1 is the pathway it is looking for in memory. However, there is no 100 percent match in memory. The closest match is pathway2. It takes section1 and section3 from pathway2 and fabricate pathway3. This fabricated pathway will be used to play the game.

Fabricate the Future Pathway Based on Trial and Error

The AI plots the strongest future state and fabricates a pathway to get to that future state using the other deviation functions.

With all 4 deviation function the AI program can fabricate pathways in memory if there are no exact matches found. All four deviation functions create the fuzzy logic of the system. It acts by giving the AI alternative pathways if an exact match isn't found in memory. It also gives the AI the ability to predict the future of pathways that are similar or non-existing in memory.

For future predictions, the weights of future sequences in the pathway has already been established by training and only require the AI to predict 3-4 steps into the future to receive an accurate prediction of thousands of steps into the future. In some cases future prediction isn't required because of this system to store/retrieve and modify information (FIG. 14).

The steps to calculating the worth of future pathways are: designating a current state in a given pathway and determining all the future sequences in the pathway; adding all the weights for each possible future sequences; calculating the total worth of each possible future pathway and ranking them starting with the strongest long-term future pathway (search algorithms such as A*, hill-climbing, depth-first search, breadth-first search, iterative deepening A* can be used to search for future pathways).

Long Term Memory

One other subject matter I will discuss is long-term memory. Long-term memory is just one long computer log of sequential movie events collected by the AI. The long-term memory is actually a timeline with references to sequential data collected by the AI (in increments of 1 millisecond). When the data in the network is forgotten the data in long-term memory is also forgotten. However, the forget rate isn't as smooth and linear as a straight line. The remembering of data is based on emotional factors, pain or pleasure, the AI's intelligence level, and other innate factors such as attractiveness or ugliness. Memory will be forgotten centered at the current state; the farther the data is from the current state the more it forgets. This doesn't mean that data 10 years ago is less clear than data 1 week ago. Sometimes data that happened 10 years ago is stronger than data that happened 1 week ago because the AI has a strong recollection of an event or that data is being recalled many times by the AI.

Finding patterns is the single most important trait used to produce human level artificial intelligence. The long-term memory is used in the pattern finding process. The 3-d storage and the 3-d environment are also used in the pattern finding process; along with thousands of other embedded data or functions. This part of the program is very complex and long and is beyond the scope of this present invention. The most important patterns are disclosed in this patent.

The long-term memory has embedded data in it to help the AI find patterns. Having the ability to rewind and fast forward movie sequences to find information is a valuable asset. For example, if someone wanted to know when the AI machine saw a car accident, the machine will use the long-term memory to locate the time it saw the car accident. If someone wanted to know how long it took the machine to finish a task the machine will locate the movie sequence that contain the task and give an approximate time it took to finish the task.

The 3-d storage which maps out a 3-d environment has embedded data in it to help the AI find patterns. For example, if someone wanted to know where the closest Mcdonalds is in a city, the machine has to look in the 3-d environment (3-d storage) and locate where the city is and the closest Mcdonalds is. If someone wanted to know the approximate distance from one location is to another location, the machine will use the 3-d environment to find the approximate distance.

All these patterns are found on its own through observation and learning. No fixed rules or policies are needed to learn how to do things. Answering questions is learned on its own, finding out solutions to problems are learned on its own, learning the rules of driving a car is learned on its own, and so forth. There are no predefined rules to tell the AI what to do and what not to do, everything is learned from society.

Learning from Childhood to Adulthood and how the Pathways Become More Complex

When the machine is at its early stages of life, it will have to build its pathways from simple data then as it gets older and there are more data in memory it will organize the pathways into complex intelligence. Just like how we humans have to learn to walk, to talk, to move, to eat, these machines have to go through life the same way. Let's illustrate the gradual forming of simple data into intelligent data by outlining a series of stages.

1. innate reflexes

2. trained to do things

3. sequential events

4. sentence commands

5. give robot option commands

6. practice makes perfect

7. copy other peoples behavior

1. Innate Reflexes

In this stage the robot will learn all the different objects that are in the environment from the 5 senses. Things like cat, dog, table, chair, red, blue, car, house, I, her, him, loud, soft etc. are learned and stored in memory. The 3-dimensional floater of all the objects will be created. Then the robot will start to move its arms and legs from innate built in reflexes. Movement of the arms, the legs, movement of the mouth, and controlling the vocal cords are the things that the robot must learn first. These experiences must be stored in memory in an organized way. Curiosity will be the factor that steers the robot into doing things that it never did before. Things like new objects it never learned before will have top priority over old objects it learned. New sensations will be more focused on then old sensations. By the time the robot learns most of the objects around him its memory banks will be filled with data and things around the robot will be more familiar. Meaning of the objects will also be established.

2. Trained to do Things

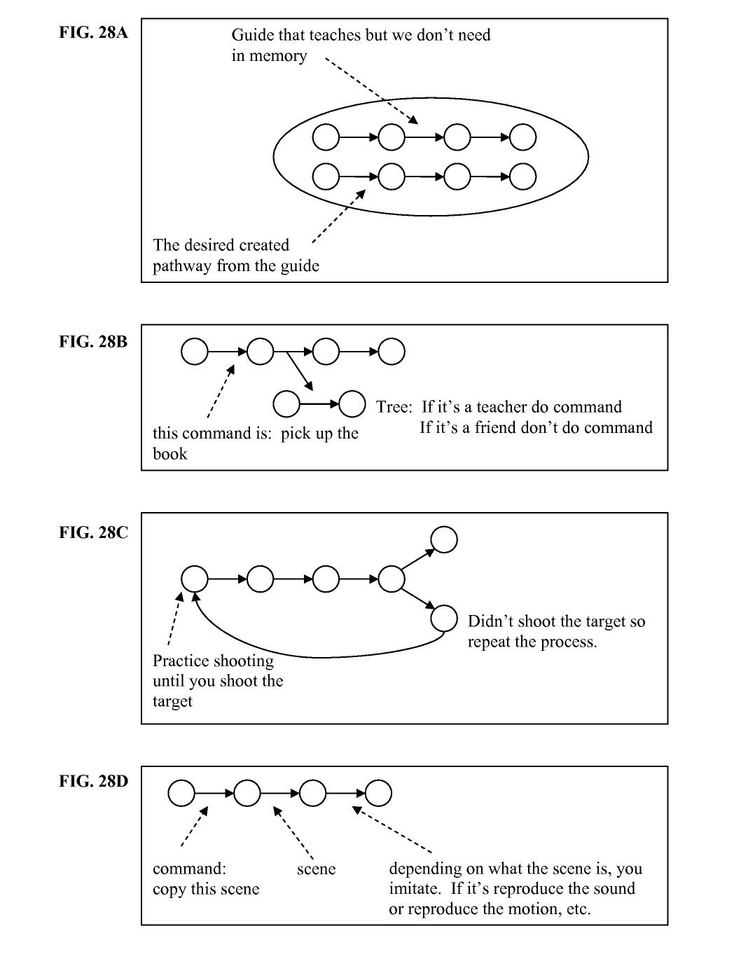

This part is where a teacher will guide the robot into doing things that are appropriate and to force the robot to learn things that it supposed to know (FIG. 28A). Things like walking, and grabbing object, and throwing things around must be learned. The guide is used so that the robot will learn important things that it can use to control the environment. A thing like walking is important because we want to get from one destination to another. Writing using a pencil is important because we must learn to write letters. Things like walking and writing and speaking must be learned by a guide because we can't preprogram the robot to learn these things.

Although the guide isn't something we want to store in memory, the point is that the more we guide it the stronger the desired created pathway will be (referring to FIG. 28A). When it is strong enough it can be used by itself and the guide pathway will be forgotten. The robot will find a way to use the desired created pathway to accomplish a goal. Walking for example, if the robot knows that walking will get it from one destination to the next, then when it sees food, it will use the walking path to go from its current location to the food. Reward is also playing a part in this learning process.

Also, during this process simple sequential consequences will be understood. Things like what is the consequence of dropping a ball, where should the ball be when you drop it, and solid objects and soft objects have different properties.

3. Sequential Events

In this stage the robot begins to learn how objects interact with one another. When two objects hit each other both objects suffer, when the robot fall down it's painful, when it grabs a solid object it has the same shape, but if it grabs a soft object it bends its shape. So, sequential events will be learned. The consequences of the robots actions in comparison to the environment will also be learned. By learning all these things the individual data in memory will turn more complex and long. The robot will be able to piece together the outcome of an event just by looking at its past. Another thing to remember is that curiosity is the key to new pathways. The more unique the event is the more the robot wants to learn it. The old events it learned many times will be ignored because it learned it already, but the new sensations will guide it to learn new things. Think of curiosity as a form of pleasure and old sensation as pain. Since this robot does things in terms of pleasure it will look for new data from the environment. At this stage things like lying and magic can't be distinguished yet. The robot will not be able to lie yet and if it sees a man flying in the sky or walking on water the robot will think it is real.

4. Sentence Commands

This part will require the robot to know basic grammar like the names of most objects that are around the environment. These basic grammar must be thought to the robot and understood by the robot. The rules program will do the rest by assigning the meaning for the grammar. Even hidden objects must be understood like jump, run, walk, loud, soft, etc. Once a basic language is established we can combine sequential events with grammar and force the robot to do things by using words as the tool. An example would be if you said sit and the robot sits. When you say: “pick up the book” the robot will pick up the book. When you say: “read the first paragraph” and the robot reads the first paragraph of the book. These are commands that you give to the robot to indicate what you want it to do. There is no deception, or lying involved in the command process. It's simply someone giving a command and the robot taking the action. The robot may not understand what you said and make a mistake, but having a voice in the head that tells the robot to do things hasn't been created yet.

5. Giving the Robot Option Commands

This part is an extension of the last stage. Instead of saying a word and letting the robot do things we can add trees to the command pathways and let the robot decide what it wants to do (FIG. 28B). This is very affective because trees combined with commands allow the robot to use if statements to accomplish a goal.

So, the tree decides what the robot will do. If a teacher gives the command then the robot will listen, if it's a friend that gives the command the robot won't listen. There are also innate likes and dislikes the robot will have and there are commands out there that tap into that kind of thing. For example, if the robot was given this command: “pick the food you like to eat”. Within the robots memory there are powerpoints that determine an objects worth. PM will tap into that and pick the one with the most powerpoints. Commands like: “pick the color you like”, “eat the food you like”, “play with the toy you like”, “buy the present you want”, “wear the clothes you love”, and so forth will all depend on the robot. These likes and dislikes can also be a learned thing.

6. Practice Makes Perfect

Now, let's get on with a more complex way the pathways can be formed. When we practice something like riding a bike, we are actually creating new pathways to ride the bike. Practicing will help the robot to decide the best newly created pathway to pick to accomplish a goal. We can build a pathway in memory that will treat practicing something as a command.

Referring to FIG. 28C, this example shows that by using English we can guide the robot to do infinite amounts of tasks. This example is a practice pathway. It uses a command that will tell the robot to do something until a desired outcome is present. If it doesn't accomplish the goal then it will repeat itself until the task is completed. At the same time this is happening more trees can be added to this practice pathway, like, if you practiced for 7 times and you still didn't accomplish a goal then quite. Or when you are hungry and you don't have the strength to shoot then stop practicing. The existing pathways will add, strengthen, or minus trees from it as the robot learns more. Instead of following commands there are other factors to consider before you take action to accomplish the commands. The robot will do the things that a society will consider appropriate at the time. If a society says it should lie in order to not do the task then that's what the robot will do. If a society says the command isn't appropriate in this type of situation then the robot will not follow it. If the robot finds the command dangerous and it can really damage itself, then it will not carry out the command. This is where the inner voice that is the core of the consciousness is built. The consciousness is the average of the things thought to the robot by society.

7. Copy Other Peoples' Behavior

This part is a very powerful tool used to learn things. We can go ahead and train a tree that will allow the robot to copy certain things from what it sees (FIG. 28D). Things that it sees on TV will be learned and copied by the robot. Copying will allow the robot to learn the most appropriate things to do in a society. When it is in a situation it will do things in terms of what society as a whole did. The way it dresses, the way it behaves in school, the things that it likes/dislikes, how to dress, how to take care of itself, how to get money, how to get food to survive, what to say to certain people, how to make friends, how to get good grades in school, and finding answers to questions. All these things are pathways that were learned by copying other people in our environment.

This part will require not only trees but also relations to past data and innate instructions of the robot. Pattern matching will find these hidden things and put them in the pathways. Something as complex as copying people require that you understand the relationship between the robot and other objects. If other people move their hand, you will copy them by moving your hand. You would need to know that your hand is one object and it belongs to you as an individual and that the other person you try to copy has a hand too and they are an individual too. Also, you have to understand when to copy them. If a copy is one second after you see the person do the action, then one second is the time it takes to copy their action.

From all these pathways we can build on each other and make even more complex thinking such as representing a hierarchy system. Things like parent-child relationships, who is the grandfather of the family, or what does having a brother really mean, will be represented by complex thinking. When people say “that's your father”, there are lots of complex things we need to know before we can understand that kind of thing. Complex things such as: “where do humans come from?”, or “parents are supposed to take care of their kids” or “everyone has one female parent and a male parent” or “the male parent is the father and the female parent is the mother”. It is a very complicated intelligent system when it comes to representing a family tree and in order to understand it we must first learn the simple things.

Training Pathways

The AI program records all the sequential movie frames in a timeline called long-term memory. Long-term memory also has reference points to all data (sequential frames and its encapsulated format) stored in memory. The sequential frames and its encapsulated format are broken up into sections and stored in different parts of memory depending on “what optimal pathways the AI program decides to pick”.

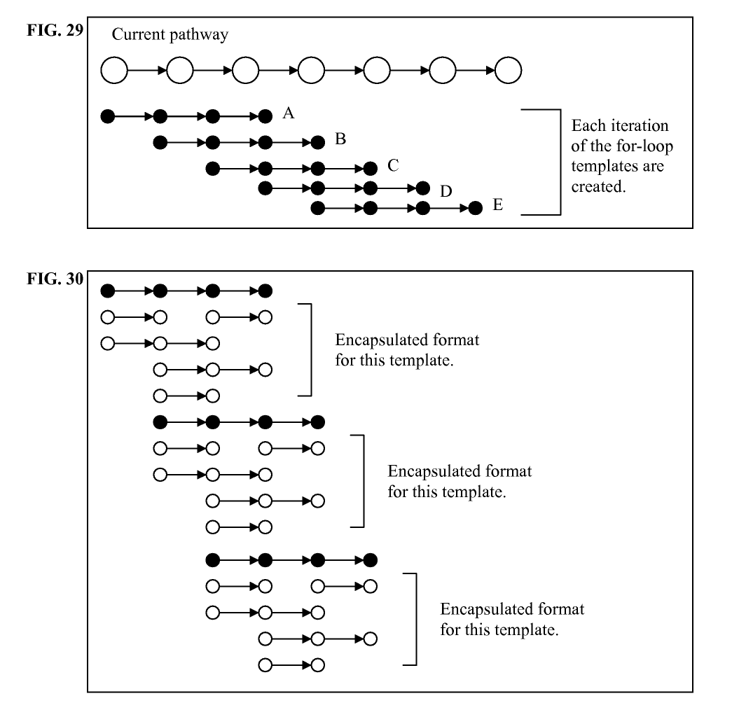

FIGS. 29-33 are diagrams to demonstrate how the AI program creates templates and how the templates are trained in memory. The training data for each iteration of the for-loop is known as a “template” (FIG. 29). Each template has its own encapsulated format (FIG. 30).

The templates are used to train data in memory in a streaming continuous manner where the AI jumps from one section of memory to the next to identify, store and modify information in memory.

The whole process of storing data in memory and remembering long information comes from a simple concept. We have to build a storage area that would lengthen the pathways as it learns more. This can be accomplished by templates.

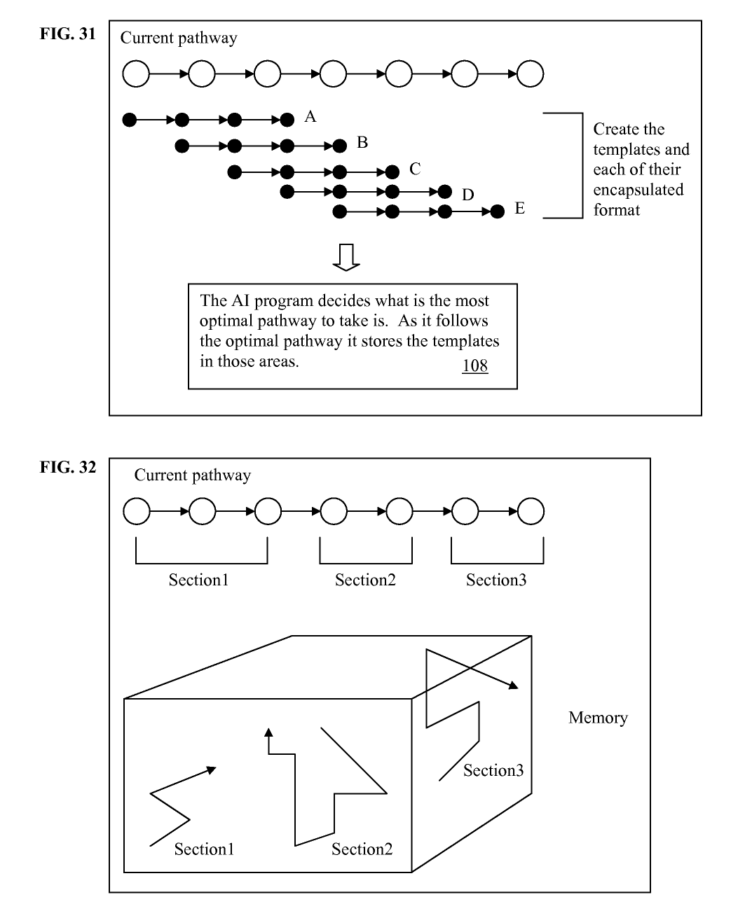

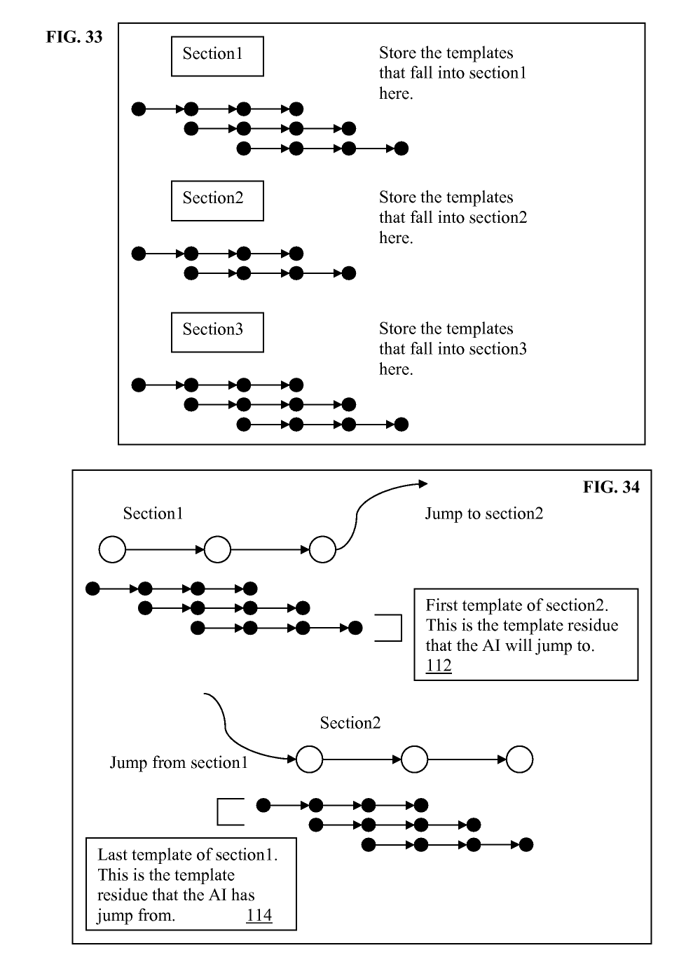

The process goes like this: first we have to create templates for the pathway we want to store in memory, current pathway (FIG. 31). Then we use the AI program to find the most optimal pathway. Referring to FIG. 32 and FIG. 33, remember optimal pathways have 3 different types of pathways: sequential pathways, minus layer pathways, and fabricated pathways. According to the follow pathway (the pathways the computer decides to take), we store the templates in those areas (Block 108).

The Template Residue

FIG. 34 are diagrams to demonstrate how templates are used to lengthen pathways in memory. The way the pathways remember long sequences is by the template residue. When the AI program jumps from one pathway to the next it leaves behind template residues in both pathways—the pathway it jumped from and the pathway that it jumped to. These template residue lengthens a pathway.

For example, let's take an easy example like Section1 and Section2 from FIG. 34. If the AI program decides to jump from Section1 to Section2, then Section1 should have some template residue 112 of Section2 and on the other hand, Section2 should have some template residue 114 from Section1.

The more template residue section1 storage area has of section2 then the longer section1's pathway is. When the training reaches a certain point section1's storage area will have a sequential pathway to section2 in its storage area. In other words, the length of section1 has increased to include section2 in its storage area. This is how the length of pathways get longer and longer.

The idea behind template residue and lengthening pathways is to prevent the AI from jumping from one section of memory to the next to find information. Also, to knit the entire data in memory so that most likely sequences are stored in the same area. This will prevent repeated pathways from being stored in memory. If two sections in memory have a copy of where it came from then one of the two pathways will eventually have a copy of both locations. The dominant pathway (with the strongest powerpoints) will have a permanent storage area of both pathways while the weaker pathway will forget. The next time the AI encounters the same situation or similar situation it will travel on the dominant pathway and will not jump to other sections in memory.

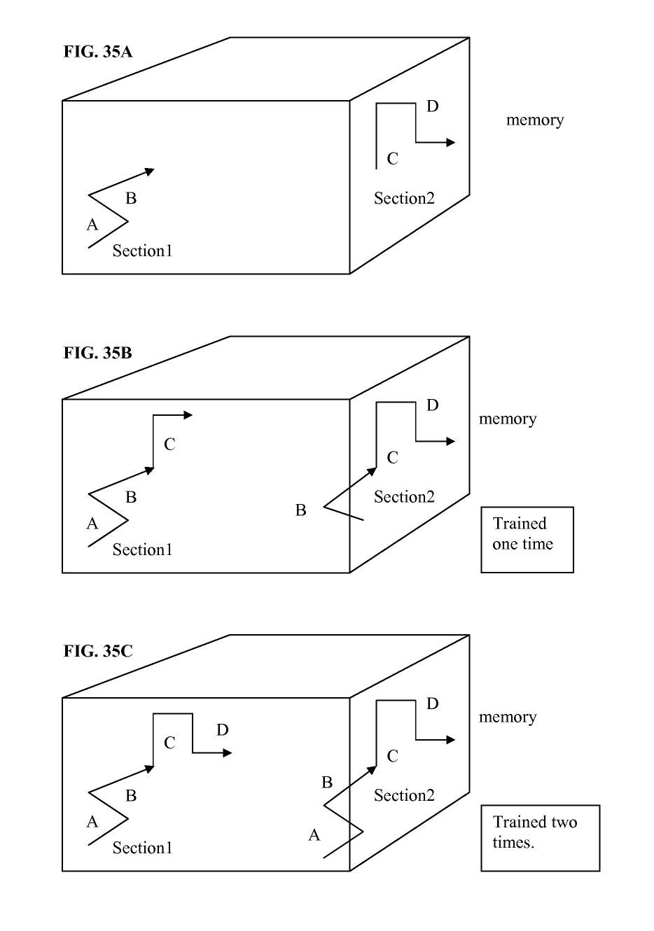

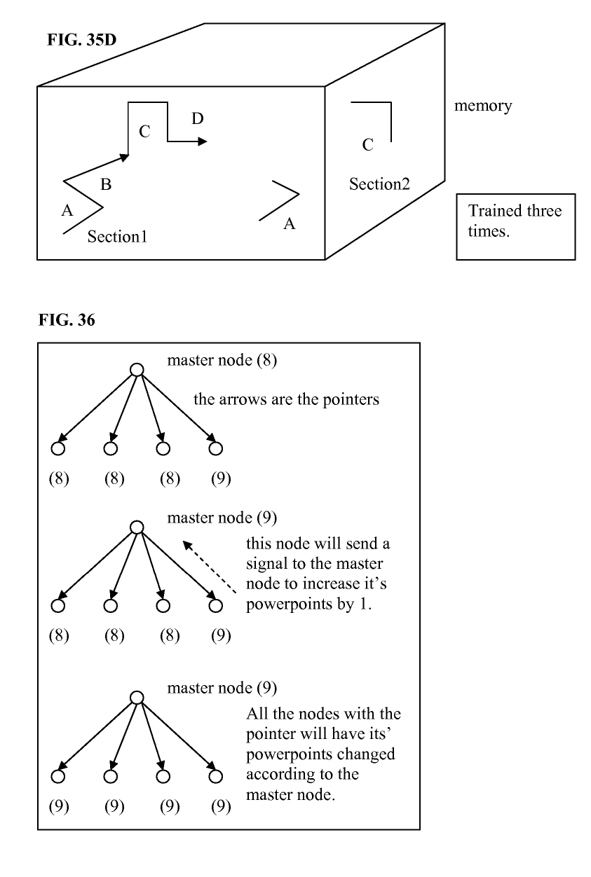

FIG. 35A-35D are examples to demonstrate how templates are used to lengthen pathways in memory. Notice that after encountering the same situation 3 times section1 has both the pathways that were originally separated in different parts in memory. Section1 remains in memory because that is the dominant location for that sequence, while section2 will eventually forget and only parts of the pathway remain (FIG. 35D). When the AI encounters this situation for the fifth time the AI will pick section1 as the optimal pathway to follow (it won't jump around in memory from pathway to pathway).

Retraining Objects or Templates

As I mentioned earlier, templates, pathways, and floaters are just objects. When we retrain the templates (example from FIG. 35A-35D), we aren't just training all the templates, but we retrain the templates and its encapsulated format in terms of priority. During the training phase the computer has only a certain amount of time to retrain the data before times up and the training stops. The important thing is that we should train the objects with priority first then train those that have less priority.

The priority of the object is discussed in later sections, but the point is that from all the data in the current pathway we break up the objects into priorities. Then we find each master node of the object and then we train the storage area with the object's templates.

FIG. 36 is a flow diagram depicting the process of how objects are trained in memory. There are millions and millions of same objects in memory. Remember that I said that all data in memory is global. Well, when an object is identified it must locate its master node. When that master node is located, it will be retrained and this master node will retrain all the sub-nodes that depend on the master node. Because the master node was retrained all of its sub-nodes are also retrained. This is how data in memory is considered global and not individual. One same object in memory has profound affects on other same object in memory.

How to Get Meaning and Stereotypes from Objects

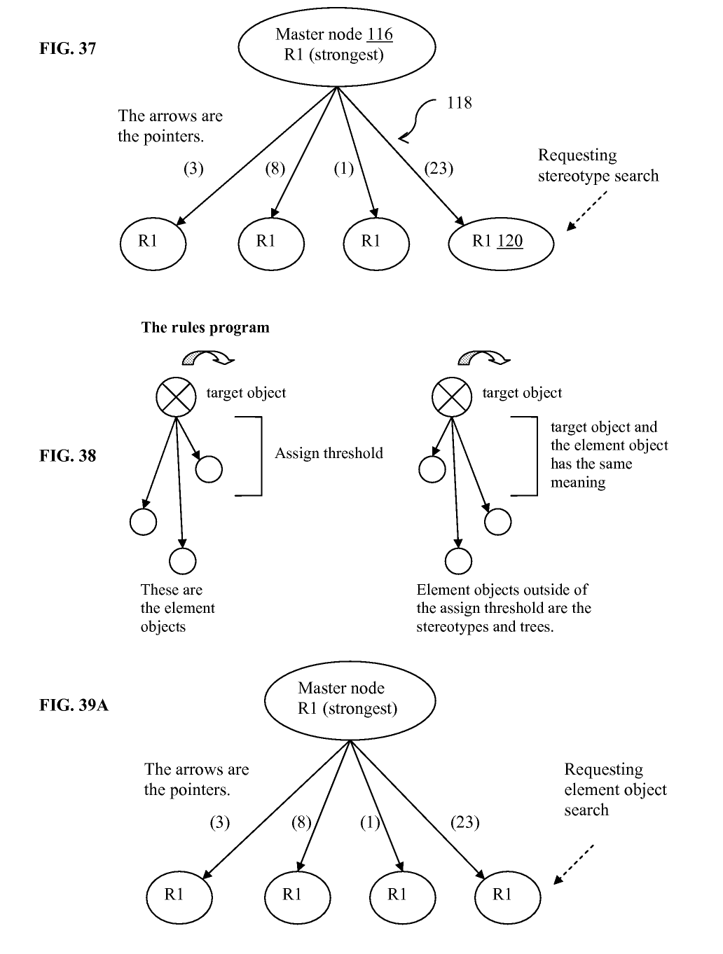

FIG. 37 is a diagram depicting the structure of repeated objects in memory. As you have no doubt noticed all same information is interconnected and anything that has association to the information is interconnected. The reason is because all data has a master node 116. This master node 116 has connections to the sub-nodes throughout memory. If one sub-node is changed a signal will be transmitted to the master node 116 and it will be changed. When the master node 116 is changed all the sub-nodes are changed too because each sub-node have a pointer 118 to the master node 116. This system is very important because now we can get meaning/stereotypes (element objects) from not only the strongest node (master node 116) but the rest of the sub-nodes too.

Referring to FIG. 37, in the case when a sub-node 120 is requesting for stereotypes, it will first identify the master node 116 and the master node 116 will determine which pointers are strong and which are weak. Usually the most recent created pointer connection is the strongest connection and it contains the strongest meaning/stereotype. All these different same nodes throughout memory will compete for their respective meaning/stereotypes to activate. How much of the stereotypes will be activated will depend on how long the robot was focusing on the object. This competition will also be fought with other object nodes and their stereotypes.

Advance Version of the Rules Program

FIG. 38 are diagrams depicting the rules program. The rules program is designed to bring association between two objects in memory. The more association two objects have the closer they will be from each other (their connection weights become stronger). If two objects are close enough they are considered equal and both are declared the same object. The assign threshold is a radius centered at the target object to indicate that any element object that passes the assign threshold is considered equal to the target object. Other element objects that fall outside of the assign threshold and have association to the target object are either stereotypes or trees.

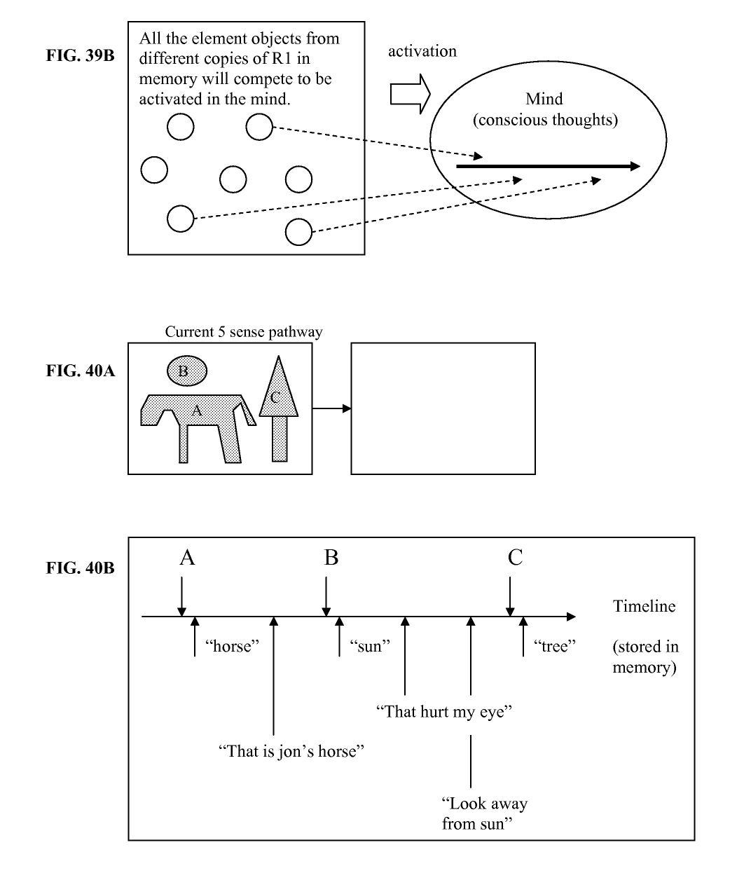

The human conscious works by identifying target objects from the current pathway and using the rules program to activate closest element objects from the target object. The key here is that there are many same target objects in memory (FIG. 39A). The rules program has to track the strongest copies of the target object from memory. Then the rules program will take the element objects from all the copies of the target object in memory and decide which of the element objects to activate (FIG. 39B). The strongest copy of the target object is the master node.

From all the same target object copies in memory the AI has to extract their respective element objects and all the element objects will compete with one another to be activated. The element object with the strongest association will be activated (FIG. 39B).

This means that the AI program finds the meaning to a word/sentence/or object in a global fashion. The entire network must be searched in order to find the meaning to an object. This technique not only works for the meaning of words/sentences/or objects but the stereotypes of the word/sentence/or object. The self-organization is there to bring common objects together so that repeated data is brought to a minimal.

Details on what is Being Trained in Memory

The current 5 sense pathway (FIG. 40A) will store not only the 5 senses that are coming into the AI, but the conscious thoughts that are activated by the AI. Both types of data are crucial for many functions including recalling information and finding patterns.

FIG. 40B demonstrates that the current 5 sense pathway stores the 5 senses along with the activated conscious thoughts. The visual representation of A B C are the 5 senses (visual) and the sounds: “horse”, “sun”, and “tree” are the learned groups. As the AI recognizes and identifies ‘A’ from memory the sound “horse” gets activated. When the AI recognizes and identifies ‘B’ from memory the sound “sun” gets activated. And when the AI recognizes and identifies ‘C’ from memory the sound “tree” gets activated.

In FIG. 40B, objects above the timeline are from the 5 senses (target objects) and the objects on the bottom of the timeline are activated element objects. Visual ‘A’ and the sound “horse” are equal because they both are stored in the same assign threshold (very strong association). This means that the letter ‘A’ and the sound “horse” are both one and the same objects. On the other hand, stereotypes and trees that get activated are related to visual images ABC, but are not the same objects. “that is jon's horse”, “that hurt my eye” and “look away from the sun” are either trees or stereotypes activated based on the visual images ABC.

This is very important to how the AI stores information in terms of “fuzzy logic” instead of storing information exactly as the AI interpret the information. Because such information is so complex I'm going to show some simple examples to give the reader an idea why I had to store information in this manner.

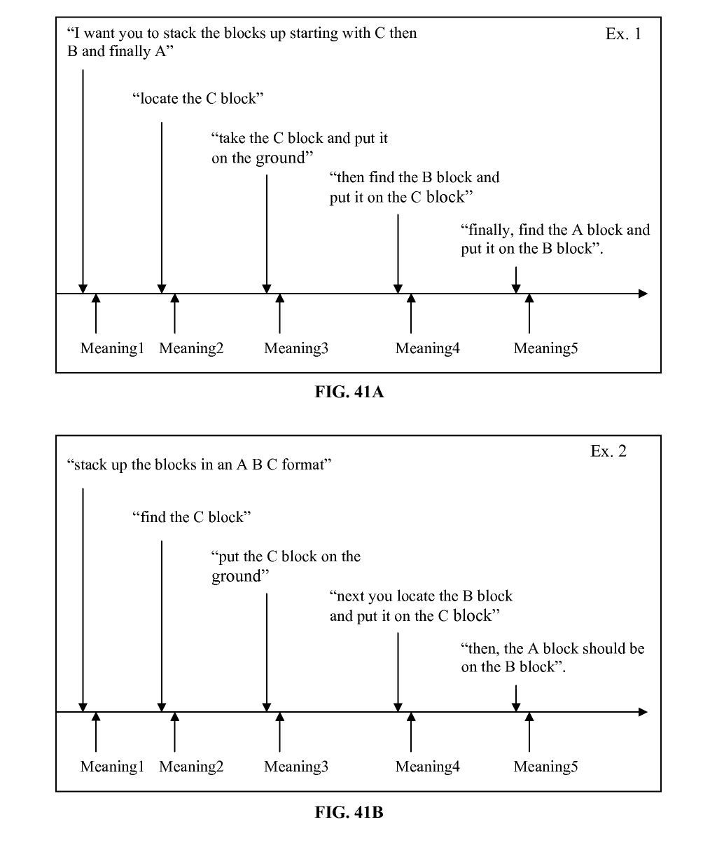

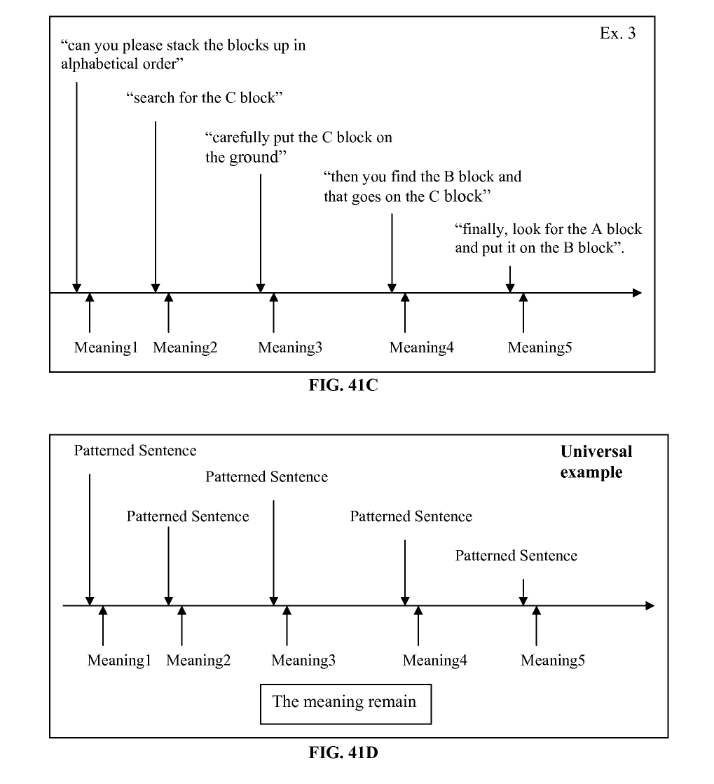

FIGS. 41A-41D are different examples of the ABC block and how to solve this problem in terms of “fuzzy logic”. I have given three examples of the same problem but different situations and different sentences (FIG. 41A-41C). Visually, the same problem will look very differently—this problem can be in a classroom environment, it can be watched on tv, or the setting can in a stadium. The one thing that binds all these examples together is language. Like I said before language brings order to chaos and is very important to the development of complex intelligence.

All three examples of the ABC block problem are very similar (FIG. 41A-41C). In fact, the instructions to accomplish the task are identical. The only difference is that people use different sentences to mean the same things. As discussed in previous lessons, the meaning to language are considered hidden objects. The AI uses patterns to find the complex meaning to language and assign a hidden object to the sentence. Hidden objects are also encapsulated and therefore subject to forget. Within all the complex patterns in the encapsulated hidden object are common traits shared by same sentences. These common traits are grouped together and it defines what the language means in a fuzzy logic way.

In FIG. 42, letters A B T are the common traits (meaning3) for both meaning1 and meaning2, so they will be grouped together as one common trait. As self-organization occurs in the storage area, common traits will be pulled closer to one another. The common traits will be grouped together within multiple encapsulated hidden objects in meaning1 and meaning2. As the AI learns more and more these common groups get stronger and stronger. This will then create a universal hidden object represented by meaning3. That meaning3 can be represented by infinite sentences that will mean the same thing.

As the AI learns the same scenes over and over again, the sentences used in each learning scene are different but the meaning to the sentence remains the same. This will allow the AI to average the sentence that is used in each situation (sentences used in real life are different everytime). The only thing that remains is the meaning of the sentence. Because the meaning and the sentence is one and the same object, even though the exact sentence disappears from memory the meaning remains (thus the sentence is not actually deleted from memory).

The patterned sentence is actually the average of all the similar sentences. The computer found a universal pattern to the sentence that correlates with the meaning of the sentence. This will allow the AI to understand infinite possible variations of the sentence. For example, the sentence: “put R1 on the ground”. R1 is a variable that can be anything.

As a result of self-organization all three examples (FIG. 41A-41C) have been averaged out and a universal pathway is created (FIG. 41D). This universal pathway to solve the ABC block can now be used to solve this problem under “any” circumstances. It doesn't matter where the blocks are, it doesn't matter what the blocks look like, it doesn't matter where this problem takes place. The problem can be solved under any circumstances.

Although an exact pathway match would be preferred instead of the universal pathway, life doesn't work that way. Life is dynamic and humans don't sense and interpret things exactly the same way twice.

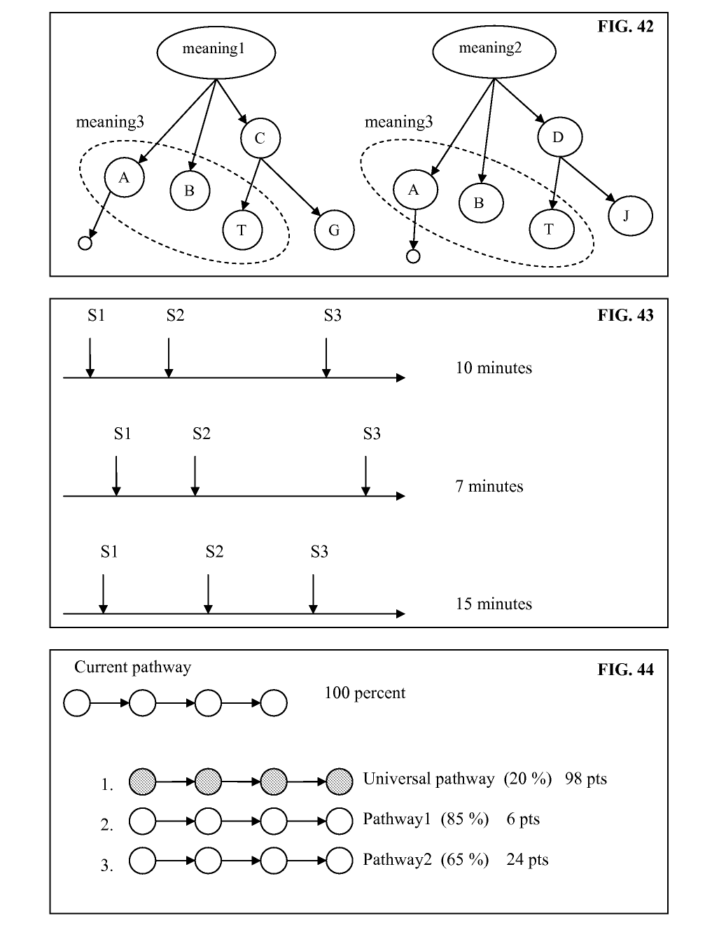

Another consideration is timing of the problem. The three examples in FIG. 43 can be different lengths. One can be 10 minutes, another can be 7 minutes, and the last one can be 15 minutes. The timing will also be averaged out and there is an approximate time that certain tasks has to be accomplished (the average timing of certain accomplishment of tasks is also used to find complex patterns to intelligence).

The final topic of this section is the decision part of the AI program related to this ABC block. FIG. 44 is a diagram showing decision making by the AI program. The AI was designed to find the best match in memory. However, just because there are higher pathway matches in memory the AI will not always pick the highest percent match. The powerpoints of the pathways are also a big factor when considering which pathway to choose. For example, if the universal pathway for the ABC block is considered a 20 percent match to the current pathway with a very high powerpoints and there is another pathway that is 85 percent match but has a very low powerpoints, then the AI will pick the 20 percent match instead of the higher percent match because the powerpoints overshadow what is actually being sensed.

This type of decision making makes sense if you think in terms of the human conscious and not what you actually sense from the environment. In very complex intelligence the majority of decision making isn't based on the 5 senses. Decisions are based on what you have learned in the past.

Self-Organization Using Both Learned Groups and Commonality Groups

Both the learned groups and commonality groups must co-exist in the same storage area. This means that commonality groups that have 5 sense traits are grouped in the same general area, but at the same time groups that are learned to be the same but are totally different in terms of 5 sense traits are also grouped together in the same general area.

One example of this is the face. The face is a learned object because it's a word that represents a group of visual images. The face encapsulates other learned objects such as words like: eyes, nose, mouth, ears, hair, chin, cheeks, and eye brows. For each of these learned objects are their respective infinite variations in terms of visual images.

The learned groups guide the commonality groups to be stored in one area. For example, if you have real-life face images of two humans—a female and a male, and you have a face image of a cartoon character (such as Yugioh), these images are totally different from each other in terms of physical appearance and measurements of things like eyes, nose, mouth, hair color, and so forth. However, the fact that all three images is a face is what groups them together. The learned group “face” brings the three images closer to one another. Within this learned group the commonality group will also self-organize and bring images with common traits closer together. In the case of the three face images, the female human face and the male human face will be closer together, while the cartoon face is farther away.

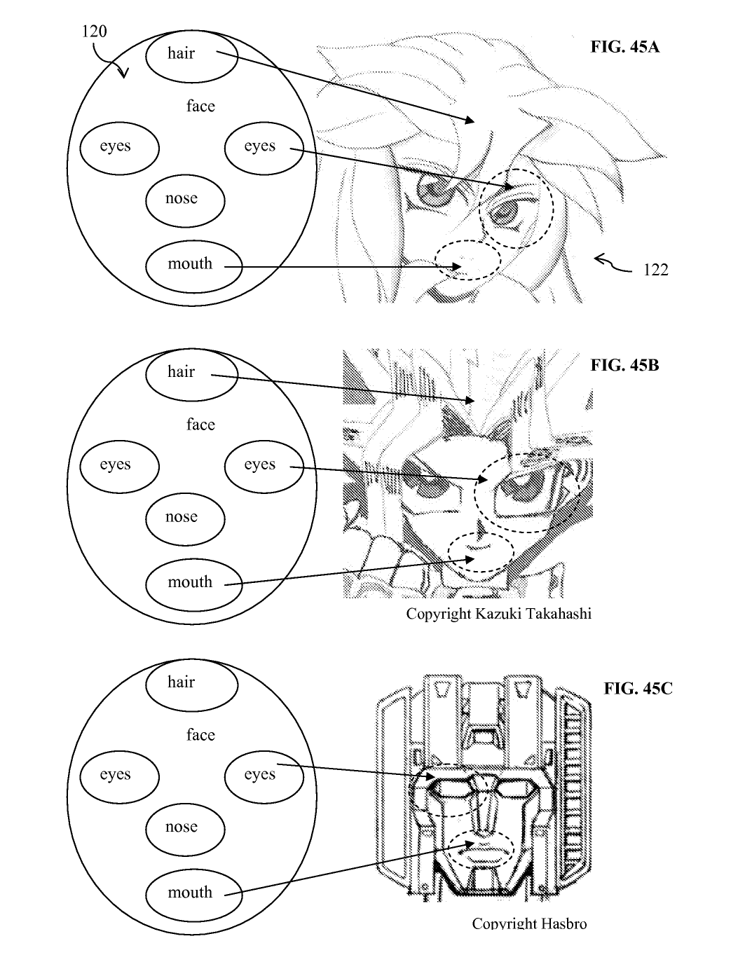

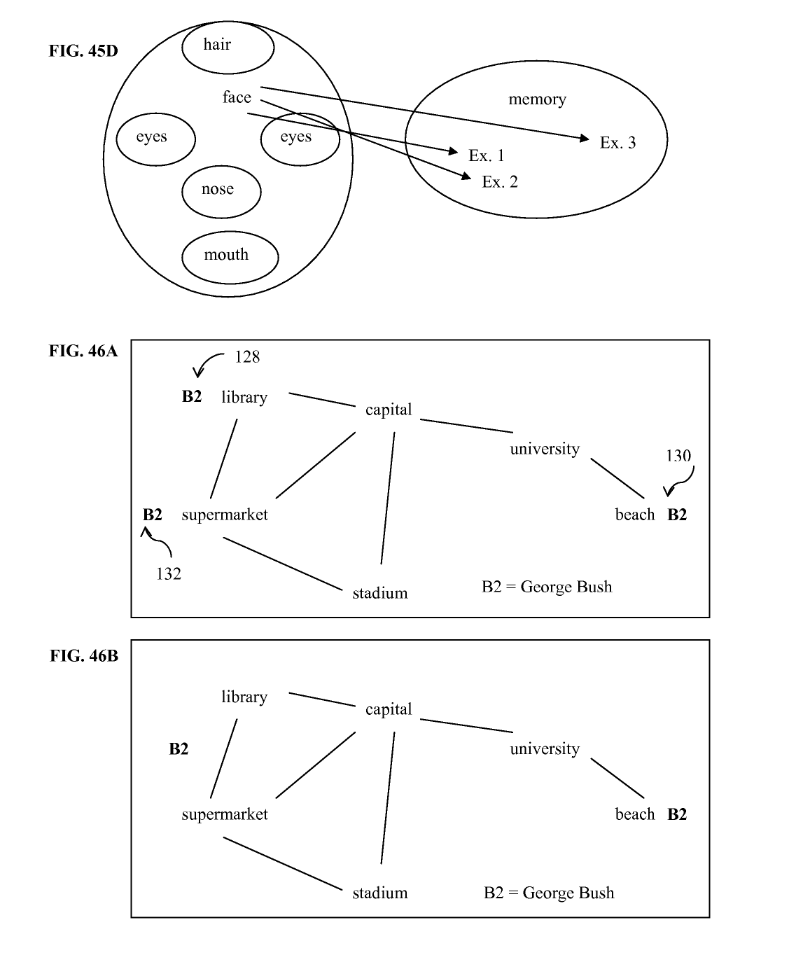

FIGS. 45A-45D are illustrations showing how learned groups and commonality groups organizes face images. On the first example (FIG. 45A) the picture is an anime character 122. Notice that an anime character 122 has eyes larger than a human, the nose takes the shape of a triangle and the mouth is a small line. These visual images do not correlate with the face of a human being. However, because we learned that these visual images are classified as a certain word (eyes, mouth, hair, nose, face, etc.), we group them as the same (learned groups 120).

On the second example is a face of Yugioh (FIG. 45B), the popular kids cartoon. Just like the first example (FIG. 45A) all the major parts of the face is classified in terms of learned words. Although the eyes deviate from what we would call eyes on a human we learned that that image is an eye. The first two examples (FIG. 45A-45B) have very similar visual traits: the eyes are large, the nose is a triangular shape, and the mouth is a horizontal line.

In example 3 (FIG. 45C) the same technique is being applied. The robot face looks different from a human face. But, because we identify certain images belonging to certain English words then that particular image belongs in that word group.

As the AI learns more and encounter more and more faces it will have an easier time classifying that image in which groups. From the three examples in FIG. 45A-45C the first two faces (anime and Yugioh) will be grouped together closely, but the third face (robot) will be farther away (FIG. 45D). This is how the storage preserve both learned groups and commonality groups together in the network. This would also help tremendously in terms of searching for information in the network because all the data are organized in an encapsulated fashion.

All these learned groups (encapsulated or non-encapsulated) do not have to be activated by the rules program. Sometimes the conscious activate something else that is considered a learned group. It activates a learned group without even thinking. In FIG. 45D, all the AI needs is the learned group “face” to activate and every image in the face falls into learned groups that are contained in the “face” group. The image of the eye will be in the “eye” group without being activated, the image of a nose will be in the “nose” group and so forth. The “face” learned group was there just to identify an approximate location in memory. The self-organization does the rest of the work. These things are done at an unconscious level. The one sound “face” or an identification of a face (hidden object—learned group) is all that is needed to store the image of a face and all the encapsulated images in the face image in its respective learned groups.

Averaging Data (Floaters) in Memory

The AI program will learn things from its environment and store all the data according to the configuration of data in memory. The 3-d environment is created because the things we see around us stay the same all the time. Most of the images we see stay the same. This is important because memory forgets the temporary objects and remember the permanent objects—things that stay the same all the time. The 3-d environment will be created in memory because the environment (majority) is fixed.

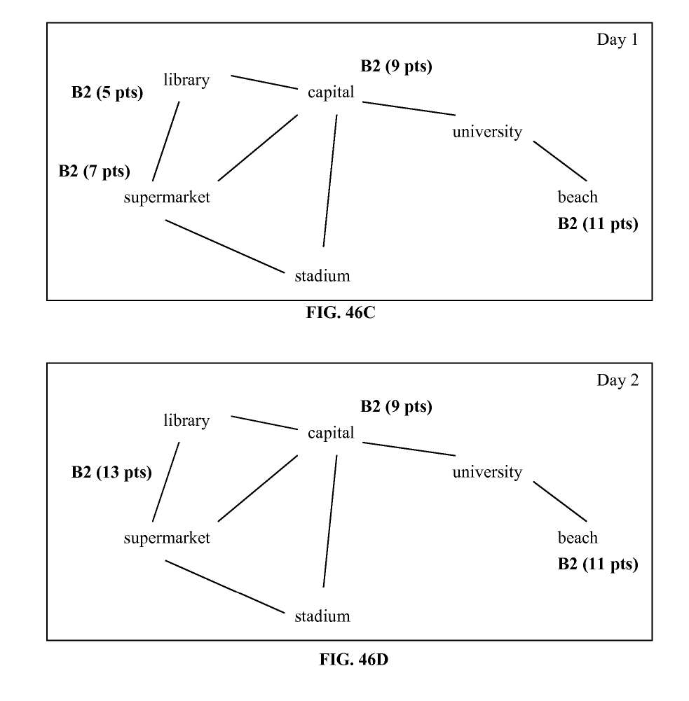

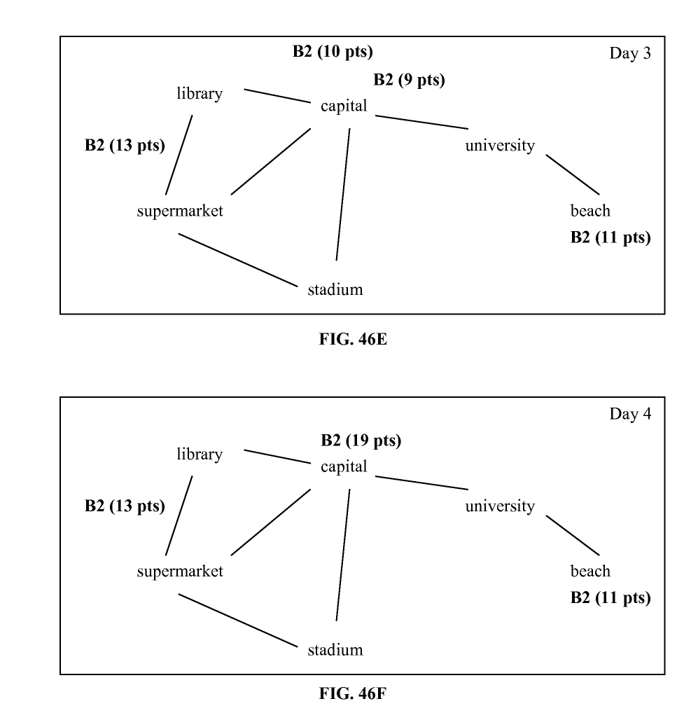

What about objects that don't have a permanent fixture in memory and moves a lot? The answer to that question is that the computer tries to self-organize all copies of that object in memory and give the object an average location in memory. When we see moving cars, people walking, and shows on television, we are actually storing those sequences in that particular 3-d environment. FIGS. 46A-46F are illustrations demonstrating how moving objects self-organizes in memory. Referring to FIG. 46A, if we are at the supermarket and we see George Bush 132, we are actually storing the movie sequence of George Bush in the supermarket area in memory. Next, if we go to the beach and we see George Bush 130, we are actually storing the movie sequence of George Bush in the beach area in memory. Finally, if we go to the library and we see George Bush 128 we are actually storing the movie sequence of George Bush in the library area in memory. This gives us 3 areas in memory that we have encountered the object: George Bush.

In FIG. 46A, B2 represents the area the AI encountered George Bush. Notice how close B2 is between the library and the supermarket. Self-organization will knit B2 together and average out the storage area. The B2 on the Beach is too far and self-organization can't bring that part of B2 closer to the other two copies of B2. After many training of data in memory B2 will have a more permanent location.

In FIG. 46B are two copies of B2 in memory. The B2 from the library and B2 from the supermarket are close so they merged into one object and both of the powerpoints from both copies are combined.

In a more dynamic environment and there are many moving objects the computer does all the hard work to self-organize data and determine where to store the object. Objects that are dominant in one area may not be dominant in the future, so multiple copies of the same object shifts in terms of powerpoints within a dynamic environment. This means that the master node is represented from one copy of the object to another copy of the object as the robot learns more.

FIG. 46C-46F demonstrates that the master node of B2 can be represented from different copies of B2 in memory.

(FIG. 46C) On day1 the most dominant copy of B2 is on the Beach with 11 points. (FIG. 46D) Then on day2 the library B2 and supermarket B2 merged into one copy and became the dominant copy of B2. (FIG. 46E) Then on day3 the robot encountered B2 at the capital and a copy of B2 is recorded there. (FIG. 46F) On the fourth day both copies of B2 from the capital merges into one and it became the dominant copy of B2 with a total points of 19.

The network will keep on storing and modifying information in the network based on what it senses from the environment. The most important data that are trained often are kept in the network and data that don't get trained often gets deleted from the network. This works for all data types (all 5 senses and hidden objects) in memory including: individual objects, floaters, pathways, scenes, and complex situations.

Self-Organizing of Entire Pathways and Situations

In the last section we explored how the AI can self-organize individual objects like people. In this section I explore how self-organization averages entire pathways or situations in memory. I will use the ABC block problem again. This problem is widely known in computer science and scientists have been using this example to demonstrate AI techniques in software programs.

The AI program must learn how to solve the ABC block problem from a teacher. Teacher in this case can be teachers in school, parents, friends, or anyone that understand the ABC problem. The robot will take in the movie scenes and store them in memory frame by frame. The location that the ABC block problem was thought is where the AI will store that movie scene. If the robot learned how to solve the ABC block in school then the movie scene will be stored in the school location in memory. If the robot learned how to solve the ABC block at home then the movie scene will be stored in the home location in memory. Where ever the robot encountered the problem is where it will be stored in memory regardless of where the location might be in memory.

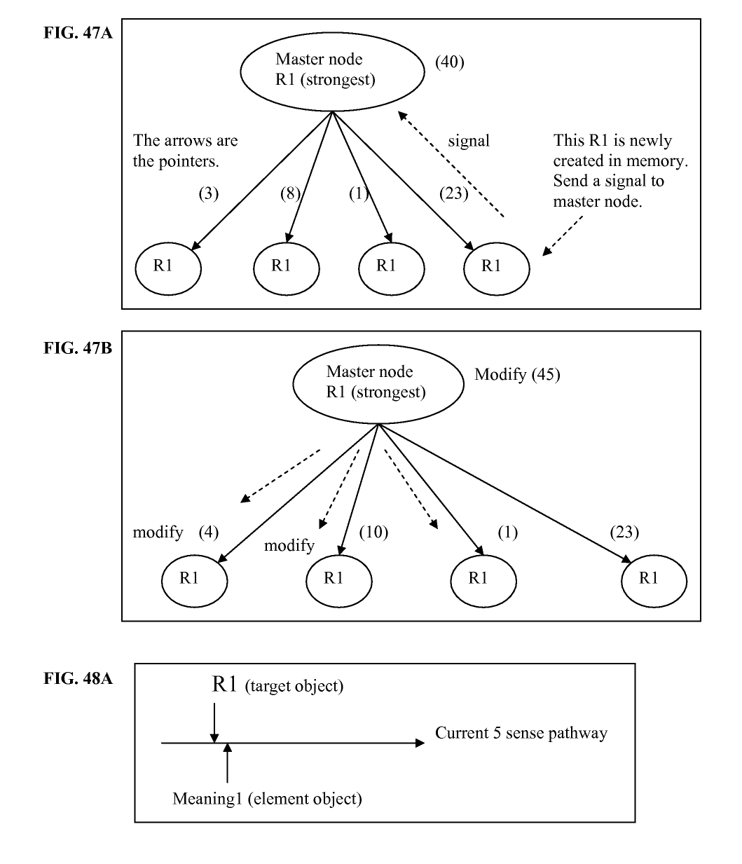

FIGS. 47A-47B are flow diagrams depicting the process of how newly created objects are trained in memory. The masternode will keep track of all the same copies (or fuzzy copies) in memory. If one copy is modified in terms of data or powerpts then the masternode will send a signal to all (or most of) the copies in memory to modify its internal data.

In the first diagram (FIG. 47A) the newly created R1 in memory is stored in memory. Next it sends a signal to the masternode identifying itself. The masternode will make a note on this and change its own powerpoints. Then it will send signals to other copies of R1 in memory to increase its powerpoints depending on the strength it has with the master node (FIG. 47B). If the connection is weak then the increase will be low. If the connection is strong then the increase will be high. In FIG. 47B the masternode's powerpoints has been increased from 40 to 45. The second strongest copy of R1 (besides the newly created R1) has powerpoints of 8. The masternode increased the powerpts by 2 points. On the other hand, the copy of R1 with 3 points had an increase of 1 point and the copy of R1 with 1 point hand no increase at all because the connection was too weak.

This type of retraining of data in memory not only works for R1 but also R1's encapsulated format. Since there are many encapsulated objects within R1, the AI will train the encapsulated objects in R1 based on priority—the most important encapsulated objects get trained first before the least important encapsulated objects get trained (priority of objects and getting the encapsulated format are discussed in later sections). A certain time limit is given to the AI to retrain, self-organize, and find patterns to data. When that time limit is reached it will stop storing and modifying data.

Self-Organizing Entire Situations

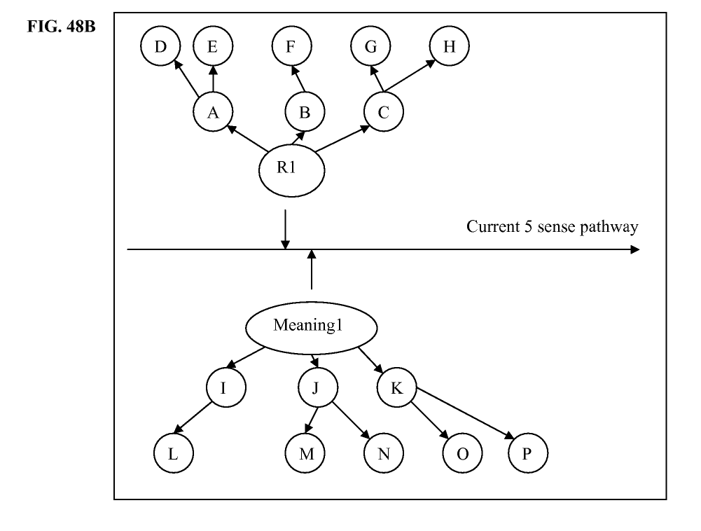

This part is a little tricky and is more complex than training individual objects in memory. There are several points I want to clarify first before moving on. The target object is stored along with its activated element objects (FIG. 48A). If the activated element object is equal to the target object then both are considered the same exact object.

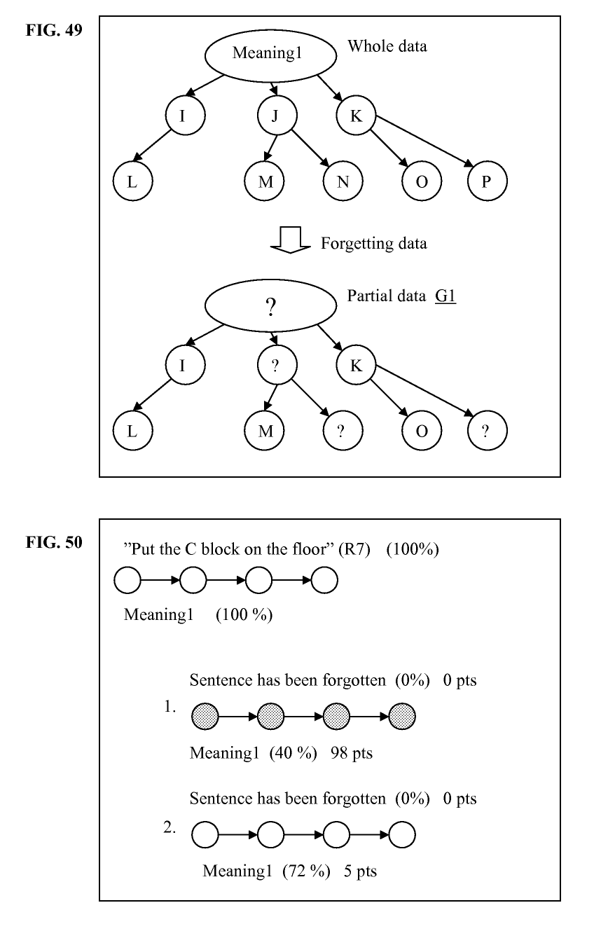

In FIG. 48B, the object R1 and Meaning1 are considered equal and are not separate objects. As time passes R1 and its encapsulated objects (indicated by capital letters) begin to forget and data disappears. The same will happen to data in Meaning1. Usually the meaning of a sentence remains strong while the sentence that relates to the meaning is weak. This means that the meaning will stay in memory and the sentence will disappear. When data in the meaning begins to disappear it will become a partial data G1 (FIG. 49).

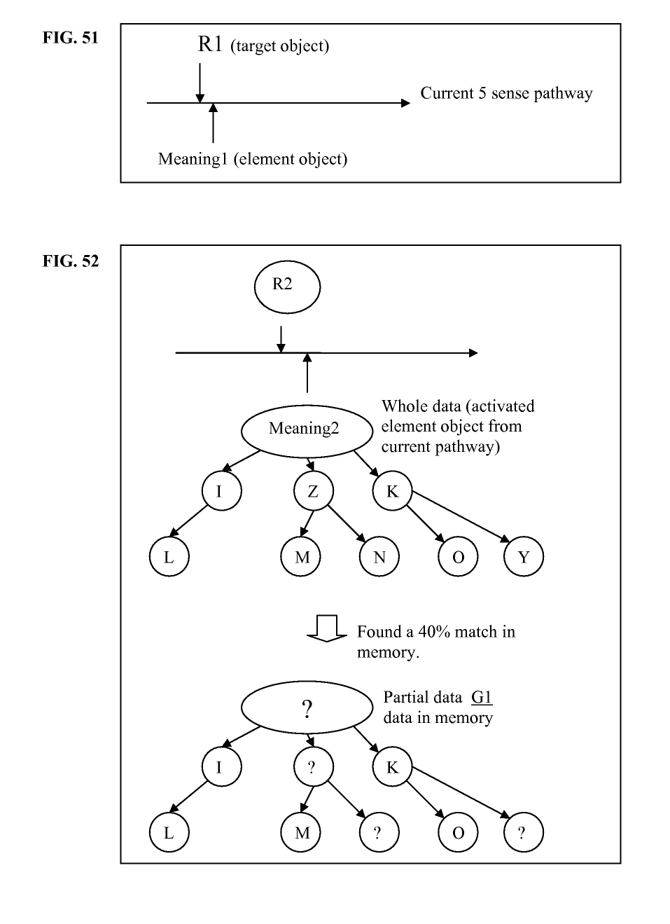

Referring to FIG. 49, if meaning1 in memory forgets partial data G1 remains. When searching for data in memory the AI tries to find the optimal pathway. In the example in FIG. 52 partial data G1 was found to be the most optimal pathway to choose based on a meaning of a sentence that is similar to the meaning of sentence R1 (well, partial data of the meaning of sentence R1).

Target objects R1 and R2 are considered similar but not equal (FIG. 51 and FIG. 52). In FIG. 52, instead of matching R2 with data in memory, the AI matched R2's meaning (Meaning2) with partial data of meaning1 in memory. Like I said before R1 and Meaning1 are equal and R2 and Meaning2 are equal. In memory, R1 has been forgotten so we can't try to match R2 with R1. However, the meaning to R1 remains in memory and the meaning is what will be used to match the data from the current pathway to the data in memory. In the case of R2, the AI activated Meaning2 as the meaning to R2. And because R2 and Meaning2 are equal we can use either one (or both) to try and find the best match in memory.

Alternative Scenario:

The AI program will use the target object to match what it is currently encountering first. Sometimes, both the target object and the meaning are used to find data in memory at the same time. If the target object can't be found in memory then it can use the activated meaning to the target object to match data in memory. The AI decides which pathway match is the strongest.

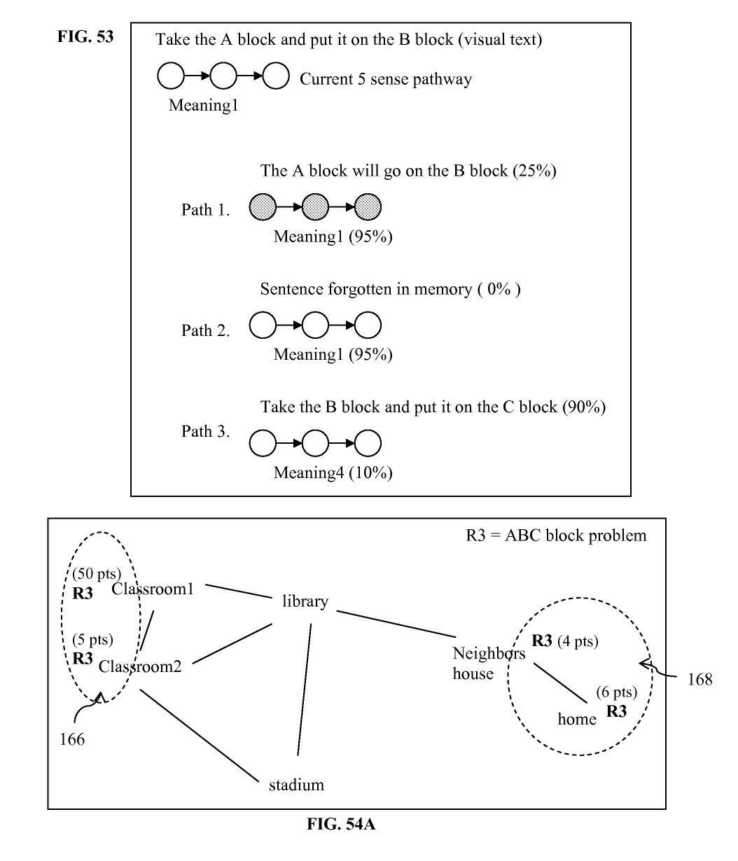

The AI program will use both the target object and the meaning to find the best pathway match in memory. In the case of the target object, visual text words and sound words can be deceiving because different sentences, even with a slight variation can mean totally different things. This is why the AI will take into consideration both the target object and its meaning to make a decision which pathway has higher points. FIGS. 52-53 are diagrams depicting how the AI program matches pathways in memory. FIG. 53 is one example of how the AI program decides which pathway in memory has the highest match percent (Path1 is the optimal pathway). Notice that even though the optimal pathway has a visual text match of 25 percent the AI picked that pathway instead of Path3 where the visual text match is at 90 percent. The meaning is more valuable and has more powerpoints in terms of match percent and that is why the AI decided to pick Path1 instead. The pathway in Path2 has its visual text forgotten (the data is so distorted that it's unreadable). However, the meaning still remains and that has higher match than Path3 where it has visual text and a meaning.

Powerpoints of the pathway is also a factor in decision making. The percentage match and the powerpoints of that pathway are used in combination to find the best match. The diagram in FIG. 50 shows that the AI found a similar pathway to R7 (the current pathway). The first pathway rank has its visual text forgotten so zero percent for both the match and powerpts. On the other hand the meaning has a match of 40 percent. Because the meaning was subject to forget the original meaning (Meaning1) has been distorted. But it has a very high pointpts of 98. On the other hand pathway rank 2 has a 72 percent match but the powerpts is very low with 5 pts. The AI picked the pathway with a meaning of 40 percent match and 98 pts. This illustrates how powerpoints affect the way decisions are made in the AI program.

The Averaging of the ABC Block Problem

In previous sections we discussed how to average individual visual objects in memory such as people and items. In this section I have extended the object to include entire situations. Imagine that R3 represents the ABC block problem. If a child was thought the ABC block problem at school, at home, and at a neighbor's house, then how does the average of the ABC block problem look like in memory? The answer is we average out the object just like how we average out individual visual objects in previous sections.

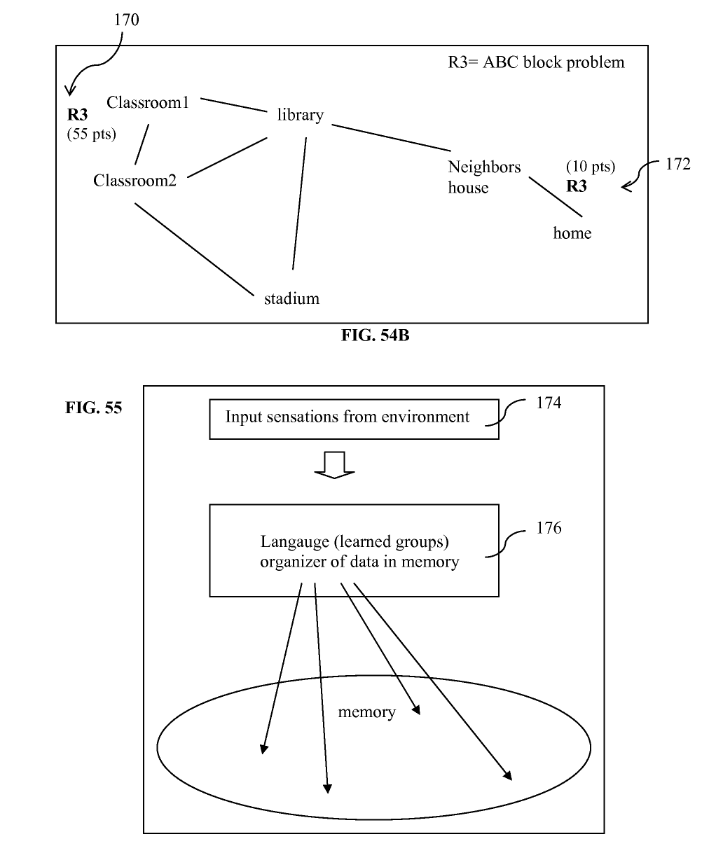

The diagram in FIGS. 54A-54B shows how the average location of the ABC block problem is created and stationed in memory. Imagine that a child learned the ABC problem at school in two separate classrooms—classroom1 and classroom2. In classroom1 the teacher thought the child many times in different areas of the room so the powerpoints is 50. In classroom2 the teacher thought the child 2-3 times so its powerpoints is 5. In two other areas the child was thought how to solve the ABC block problem by parents or neighbors. In the neighbor's house the neighbor thought the child how to solve the ABC block problem 2 times so the powerpoints is 4. At home the child was thought the ABC block problem 4 times by his parents so the powerpoints is 6. In FIG. 54A self-organization will knit R3 together and average out the location it should be in (location points 166 and 168). Referring to FIG. 54B, notice that R3 170 didn't move much from classroom1. The reason is because the majority of training examples came from classroom1 and the average copy of R3 is closer to classroom1 than classroom2. In the second diagram two copies of R3 remain. One is located near classroom1 (R3 170) and the other copy is located between neighbor's house and home (R3 172). Because the two copies are so far apart they are not subject to self-organization.

If a new copy of R3 is created in memory, that copy will send a signal to the masternode and the masternode will increase the powerpts of every (most) R3 copies in memory depending on the connection strength. So, regardless of where the ABC block problem is encountered the AI program will train itself globally. If two or more copies of R3 are located in the same general area the self-organization function will knit those R3 copies together and free up disk space. The masternode will also be reassigned if one of the copies in memory besides the masternode has the highest powerpoints.

The storage of data would include both the target objects and the element objects activated by the rules program (FIG. 51). When new data is created (this includes the element objects activated by the rules program), a copy of that created object must send a signal to the masternode. “Both R1 and Meaning1 must sent a signal to their respective masternode after that data is created”. This is how data in the network is trained globally.

Language Organizes All the Data in Memory

Language brings order to chaos in our world. Language is used to classify things that we learned to be the same and this is a valuable asset to intelligence. Extremely complex intelligence needs a very sophisticated language in order to develop. Without language complex intelligence can't develop.

The whole idea behind the human level artificial intelligence program is to build a software that can learn language and using language to organize all the data in memory.

FIG. 55 is a diagram depicting the organization of data in memory based on learned language. Because language looks the same visually (words, letters, strings of letters, and sentences), they are already closely grouped together in memory. And because we learn language generally in the same area by a teacher, it is grouped even closely. From all the school that a human being has gone through—grade school, intermediate school, high school, and college, the knowledge acquired over the years was learned in classrooms or televisions or computer monitors. Because we were stationed in one area for a year to learn knowledge the computer was able to organize those data adequately.

What I'm trying to say is that language is organized in memory in terms of visual representations and sound representations (visual words and sound words). All the meaning to language is also established in memory in one general area. The whole language database is the organizer the AI uses to classify all data coming into memory regardless of what sense it came from—sight, sound, taste, touch, and smell (block 174). If new sensations are encountered the computer will know where to organize that new sense in memory. If similar data is sensed it will organize that sense in the most appropriate area in memory. In other words the learned groups organize the data in memory (block 176). The self-organization organizes both the learned groups and commonality groups. Thus, giving the network the power to learn language and use language to organize data in memory (FIG. 55).

Hidden Data

Human conscious thoughts doesn't just have one function it serves, but it does many things at the same time. As always language is what organizes these thoughts. Language can tell us what the meaning to words/sentences are, it can tell us information about an object, or instruct us to solve complex problems.

In previous sections I discuss the 7 stages of how human intelligence is developed. These 7 stages include a lot of things such as learning the meaning to words/sentences, learning to plan tasks, solve problems, copy other peoples' behavior and so forth. All these things are leading up to one thing and that is to understand and learn all the meaning to most words/sentences in the English language.

When that understanding of every word/sentence is established then we can use the self-organization function to encapsulate entire situations in terms of language. Understanding words/sentences means finding the meaning to words/sentences by finding the complex patterns. Solving the ABC block problem is one example that I have used to demonstrate how language is so crucial to learning ambiguous situations. All the steps to solving the problem come from sentences. The movie sequences that all training examples have do not look similar in any shape or form. The sentences used (most notably the meaning of the sentences) is what binds all the training examples together.

In this section I will explore the different ways that conscious thoughts produce intelligence in humans by giving examples. Some of these examples have already been used many times in this patent but it is necessary to understanding how complex intelligence is formed.

What kinds of data or functions are used to find complex patterns to language?

In visual frames there are hidden data set up by the programmer that will provide additional information about a movie sequence. These hidden data are set up to establish additional data and allow the AI program to find patterns that can't be recognized by what is actually on the visual frames. Action words such as jump, walk, throw, and run have patterns that can be identified by these hidden data. Also, patterned sentences from hidden data can provide meaning to object interaction. Below demonstrate patterned sentences. R1, R2, R3 can be any object.

1. R1 is on R2.

2. R1 is walking toward R2.

3. R2 is on R3 and R3 is on R1.

4. go around R1.

5. R1 is 3 feet from R2.

6. R1 is below R2.

7. R1 is under R2 but over R3.

8. R1 collided with R2.

The hidden data is wired to the visual frames. All the image layers or what is considered an image object will have measurements that provide the AI with information about where that image object is in relations to other image objects in the movie frames. The hidden data also provide information about the properties of the image layer such as the center point of the image layer and the overall pixel count.

Since the hidden data is wired to the visual frames that means the learned group that is equal to the visual frames has a reference to the hidden data. This is important because the AI will use a combination of the three groups in order to find complex patterns and assign these complex patterns to sentences.

A note on hidden data, when the visual image (commonality group) is forgotten, the hidden data still has the learned group. If both the commonality group and the learned group are forgotten then the hidden data stands alone. “The hidden data can exist without either a learned group or a commonality group or both”.

Hidden data contained in the visual frames:

For different senses the hidden data are represented differently. For simplicity purposes hidden data from visual movies will be discussed. These are the hidden data for visual movies:
1. Each image layer has a normalization point (center point for that image).
2. Each image layer has a location point in the frame. The point is the normalization point.
3. Each image layer has an overall pixel count.
4. Each image layer has data that summarizes all the pixels that it occupies including pixel color, neutral pixel count, patterns in the pixels and so forth.
   Image layer (or image object) interaction from frame to frame:
1. Each image layer will have a direction of movement (north, south, east, west, northeast, southwest etc.). This can represent words such as north, south, east, direction, down, up, bottom etc.
2. Each image layer will have coordinate movement in terms of x and y from frame to frame. This can represent words like: moving, walking slowly, fast, slow, one step, stationary, taking a break and so forth. If this data is combined with the direction of movement then more words can be represented such as: moving south, jump, walk, throw, trajectory, the car took a nose dive into the water, the book fell, turn around, jump up, look down, move sideways and so forth.
3. Each image layer will have relationships to other image layers in the current pathway. The relationships will include the coordinate points between the two image layers and the direction between the two image layers.
4. Each image layer will have a touch sensor that lights up when it touches another image layer. This can represent words like: touch, collision, slide, skim, and so forth.
5. Each image layer will have a degree of change from one frame to the next. If it changes its shape dramatically it will be recorded. If it changes its shape gradually it will be recorded. This is important because if the image layer touches another image layer the degree of change will tell if the interaction caused the image object to change or it didn't cause the image object to change. A car accident definitely changes the way a car looks after the collision, while solid objects moving very slowly and colliding don't change its shape.
6. Each image layer will have scaling and rotation data. Did the image layer grow larger in size? Did the image layer rotate to the right? If it did what is the degree of rotation? Words such as: grow bigger, deflated, change its size, rotated, towards, move away from, and shrink can be represented by this data.

These are just some of the hidden data that will accompany visual images and movie sequences. The programmer can add in more data, but the AI will take a longer time to find patterns among the hidden data. This is where the programmer should decide how much hidden data to include. Too much hidden data will overwhelm the system and too little will prevent the pattern function from doing its job properly.

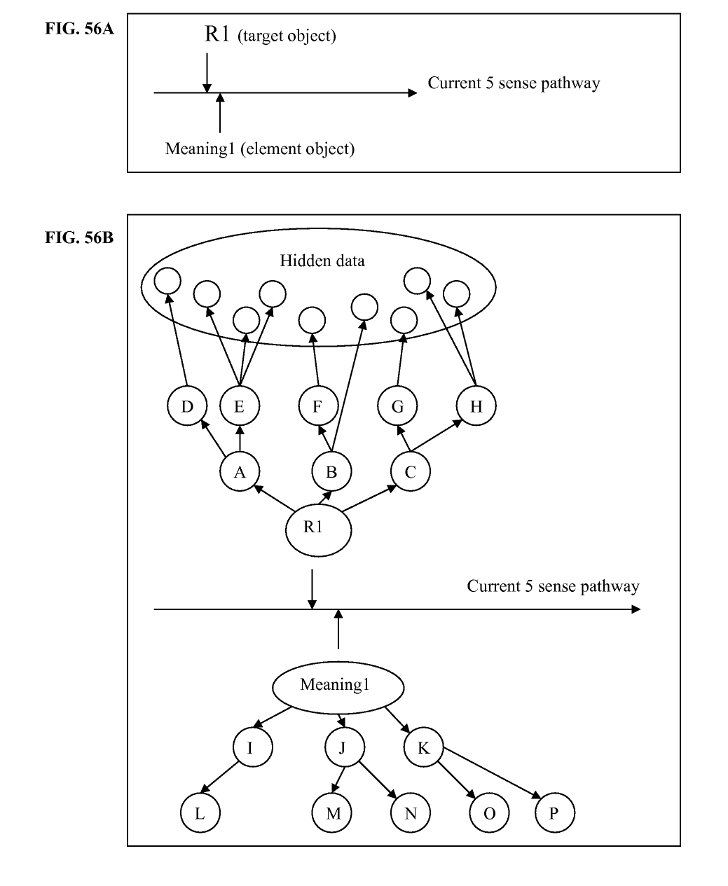

FIGS. 56A-56B are diagrams demonstrating the 3 types of data in the current pathway: 5 sense data, activated element objects and hidden data. The diagram in FIG. 56B is the same diagram in FIG. 48B but I included the hidden data in the current 5 sense pathway. All the visual images in the current pathway will be broken up into image layers and determined their respective 360 degree floaters. Each image layer generate hidden data and establish relationships to other image layers in the movie sequence. R1 is stored in memory along with its hidden data (FIG. 56A). Then the rules program activates Meaning1 based on the target object R1. This means R1 and Meaning1 is the same object. This also means that the hidden data located in R1 is shared with Meaning1 (FIG. 56B). If the AI program forgets R1 in memory and the hidden data hasn't been forgotten then Meaning1 will have the remaining information from the hidden data (hidden data is subject to forget as well).

All three groups: commonality groups, learned groups and hidden data are subject to forget.

Forgetting in Commonality Groups

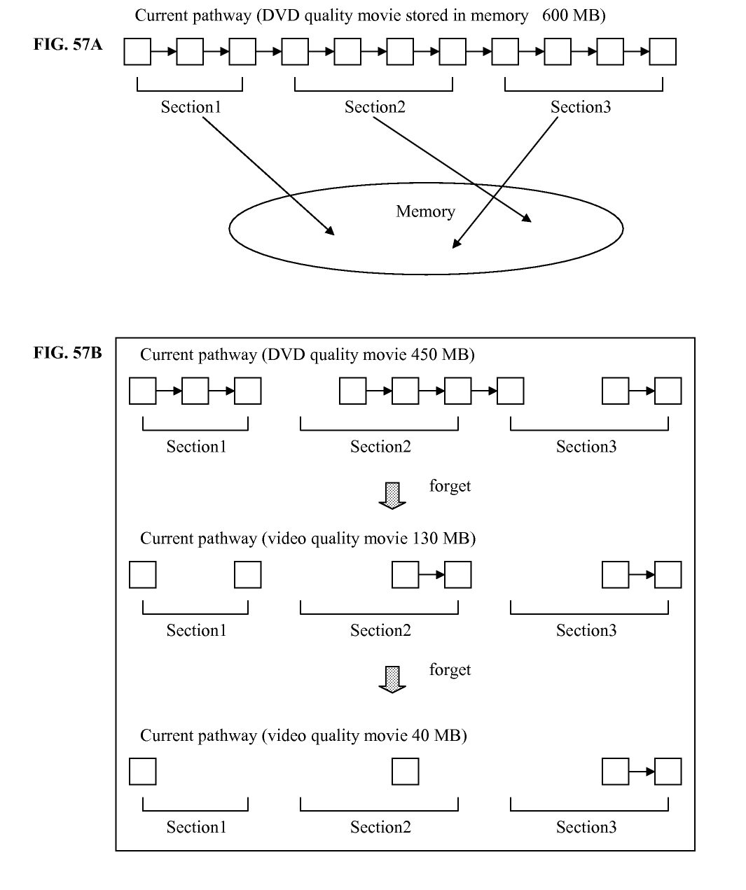

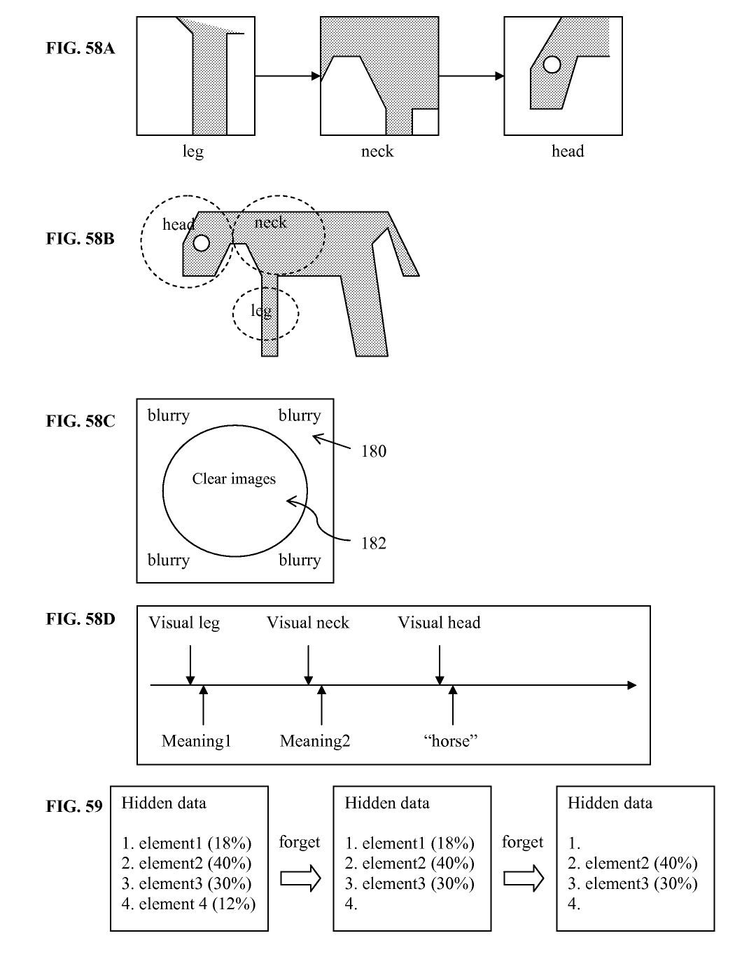

FIGS. 57A-57B are flow diagrams illustrating how commonality groups or 5 sense data forget information. Commonality groups forget based on what encapsulated groups are trained the most. If different eyes are trained such as human eyes, anime eyes, cartoon eyes, dog eyes and so forth, the eyes that are trained the most (the robot encounter the most) will be dominant. Another example are lines, if the robot encounters a straight line more than a curve line then the straight line will be dominant and will be a stronger object than a curve line.

In FIG. 57A, the visual movie sequences (commonality groups) will be stored in memory with DVD quality. As the AI forgets the information (based on strength of commonality groups) the AI will have its video quality lowered (FIG. 57B). By the time the information is forgotten the movie quality is so distorted it is not recognizable and the movie sequence is not connected anymore but broken up into multiple sub-movies. Only the strongest memories get remembered while the minor things get deleted.

Forgetting in Learned Groups

FIGS. 58A-58D are diagrams illustrating how learned groups or activated element objects forget information. The learned groups forget information in terms of objects encapsulated in that learned group. The sub-learned groups leading to that learned group is used to degrade information. Imagine that you looked at a leg of a horse then you moved to the neck of the horse then to the head of the horse. The learned groups leading to the activated word “horse” is presented this way: leg→neck→head→horse (FIG. 58A-58B).

Humans see things not in terms of frames in movies where the pixels are equal in visibility (FIG. 58C). The human eye focuses on an image. The image it is focused on is clear while images that fall in its peripheral vision are blurry (pointers 180 and 182).

In the example in FIG. 58B the robot focused on the leg first, then it moved to the neck, and finally it moved to the head. It is at the point when the robot identified the head when it recognized that the image layer is actually a horse (FIG. 58D). Some people would see the leg, and because they are experts, they identified that image as a horse. For most of us when we see the leg we might think it's a donkey or a dog. For different people identification and activation of image objects is different.

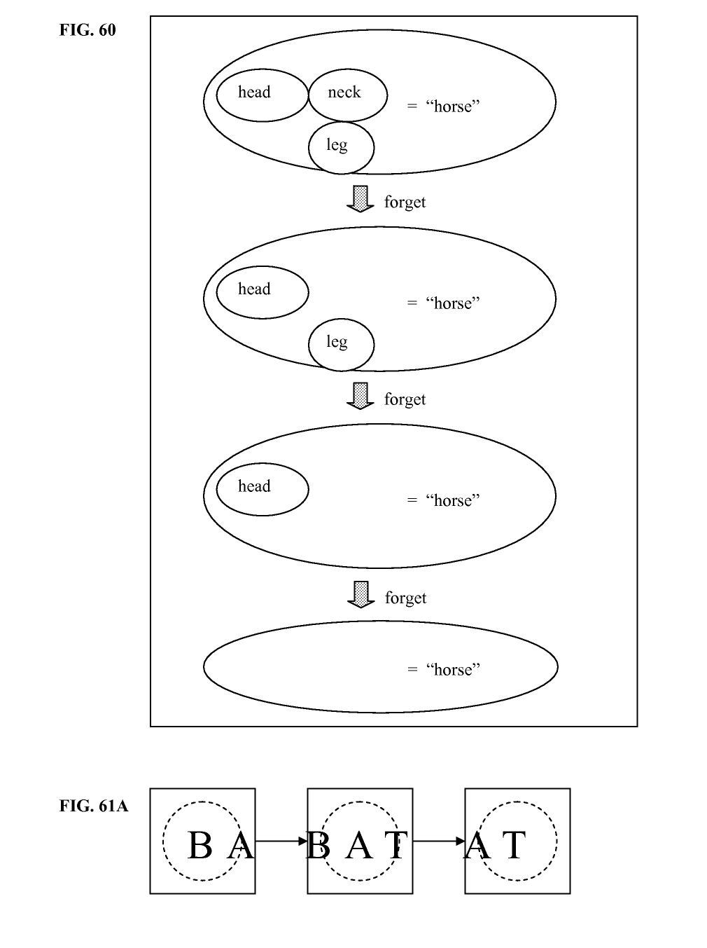

Since the leg, the neck and the head is part of the image layer and that image layer is identified as a “horse”, then leg, neck, head are all objects encapsulated in the sound “horse”. The AI will store this data in memory and the encapsulated objects will forget based on its encapsulated format (FIG. 60). Whichever objects are the strongest gets forgotten last and which objects are weak (low powerpts) will be forgotten first.

The learned groups have coordinate points (From the hidden data of the visual image layer the learned group equal) on each frame. The objects that are contained in a learned group will be considered its' encapsulated objects. This is why leg, neck and head are all learned groups contained in the “horse” learned group. Each of these learned groups will correspond with the normalization point that their visual image layer has. That is why the leg group is below the neck and the head is to the left of the neck (FIG. 60). The “horse” group encases the leg, neck and head and has a normalized point that is the center of the leg, neck and head. Also, the AI need not activate the word for that image layer. For example, if the image of the leg is encountered by the AI the sound “leg” may not activate, instead maybe a reference of the leg floater is activated or something else that is equivalent to an image of a leg.

Another theory is that the AI uses strong learned groups “in memory” to forget information. All the strongest sub-learned groups contained in the learned group will be used to forget information. The strongest sub-learned groups will remain and weaker sub-learned groups will forget. It could also be both theories above that learned groups forget information.

Forgetting in Hidden Data

FIG. 59 is a flow diagram illustrating how hidden data forget information. Data in hidden data are called elements. Each element doesn't have a predefined priority. Instead, the priorities of the elements depend on pattern groupings and pain/pleasure. If the AI encounters certain elements over and over again, it will have a higher priority number (common groups having the same elements and grouped together). If the AI doesn't encounter certain elements and that element isn't trained often, then that element will have a lower priority number (common groups don't have this element). Another factor to priority of elements is pain and pleasure. Pain and pleasure is discussed in other parts of this patent but I will summarize what it does. When the robot encounters pain all the pathways and its encapsulated format leading to that pain will have their powerpts decreased. On the other hand when the robot encounters pleasure all the pathways and its encapsulated format leading to that pleasure will have their powerpts increased. Objects in the pathway closest to the pain/pleasure will have their powerpts modified strongly while objects farther away from the pain/pleasure are modified mildly. The AI program tries to locate the object or objects that caused the pain/pleasure. When the AI program identifies the objects that caused the pain/pleasure then it will assign higher priority to those objects.

What are the hidden objects assigned to words/sentences?

In previous sections we talked about how words/sentences are assigned meaning using the rules program. The meaning of the words/sentences is actually hidden object or a combination of hidden data, commonality groups, and learned groups all combined together to form a complex pattern (in this section a fourth group is discussed, patterns). This meaning (complex patterns) is then assigned to something that is fixed. Since language is fixed the rules program assign the meaning to words/sentences.

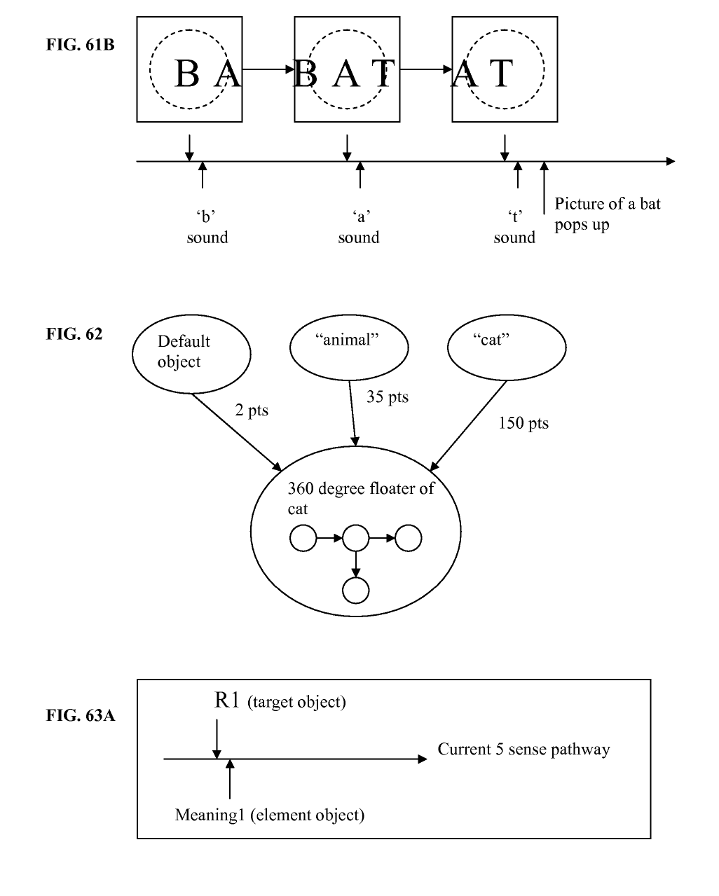

FIGS. 61A-61B are diagrams illustrating how the AI program reads in the word bat. When the robot reads text from a book it reads text exactly like a human being. From a movie sequence the words are seen one letter at a time. The letters are focused on and identified by the robot. The recognizing of these sequential letters make up words that mean something. FIG. 61A is an example of how the robot will identify the word “bat”.

At this point, while we read in each letter of the word the sound that accompanies the letters are pronounced in the mind (FIG. 61B). That sound is the meaning because it has very strong associations with the letters. By the time the robot finish reading in the “T” the sound “bat” will pop up in memory. At that moment more element objects that have association to the visual text “bat” activates in the mind—element objects such as a picture of a bat.

Small length words such as “bat” can be identified in memory without reading in every single letter. The whole text image “bat” can represent the word. But much longer length words like “computerization” might require the robot to focus and identify multiple sequential words in order to understand. (since there are so much meaning to the word “bat” the conscious will tell the robot what type of bat it is. If reading a book, there are other words and suggestions to indicate what type of bat the word means. The lessons thought in English classes will guide the robot to look for clues here and there to find the true meaning to the word “bat”).

The movie sequence of recognizing words/sentences is actually stored in terms of fuzzy logic. The text in the movie sequence can be in any font or it can be in any font size. The paper can be in any color or the text can be on a computer screen or a wall. You can even line up chopsticks to represent the text. The different ways of expressing the word “bat” can be infinite but the meaning to the word will always be fixed. When the AI program averages out all the training examples a fuzzy range of the movie sequence will be created in memory. In this moment the different ways of expressing the text word “bat” can be understood by the AI program regardless of how distorted or fuzzy that movie sequence may be. But there is a threshold in which different movie sequences will be considered the word bat or not. (the meaning of the words/sentences will also be in a fuzzy logic way. In fact, all data in memory will be in a fuzzy logic way. This is the whole point about building a network that can store infinite data).

All Objects Created in Memory has a Default Learned Group

When data is created in memory it will automatically be assigned a default learned group called default object. Anything that it is assigned in the future will be derived from default object. For example, if the robot learns one cat image that wasn't learned before, the robot will store this newly created image and assign it a default object. When the robot learns more and a floater is created of this cat object the rules program will assign the learned group “animal” to the floater. This means the sound “animal” and the 360 degree floater of cat is equal. The learned group “animal” is derived from the default object. Now, we can give the cat floater a more specific identification. We can train it to identify the 360 degree images of cat and assign it to the learned group “cat”. Although animal is one possible learned group to identify the cat images, the learned group “cat” is a more specific term used to represent the 360 degree images of a cat. This encapsulation of learned groups to identify an object is created in memory. The AI program will activate the most specific learned group to represent an object. In this case the most specific learned group is the sound “cat” to represent the visual images of a cat.

FIG. 62 show different learned groups assigned to the same 360 degree floater of cat. The most specific learned group has the strongest connection. In this case the sound “cat” has the strongest connection weight to the 360 degree floater of cat. All objects in memory regardless of how weak is referenced to a default object. You will see later how these encapsulated learned groups will be used to find meaning to sentences.

Hidden Objects

The whole point about hidden objects is that only the computer knows what these hidden data are. The computer will take the data from the current pathway and average this data out with the data in memory. The data in the current pathway have four types:

1. data from the 5 senses (commonality groups)

2. data activated by the rules program based on the 5 senses (learned groups)

3. hidden data embedded in the 5 senses.

4. patterns and identification

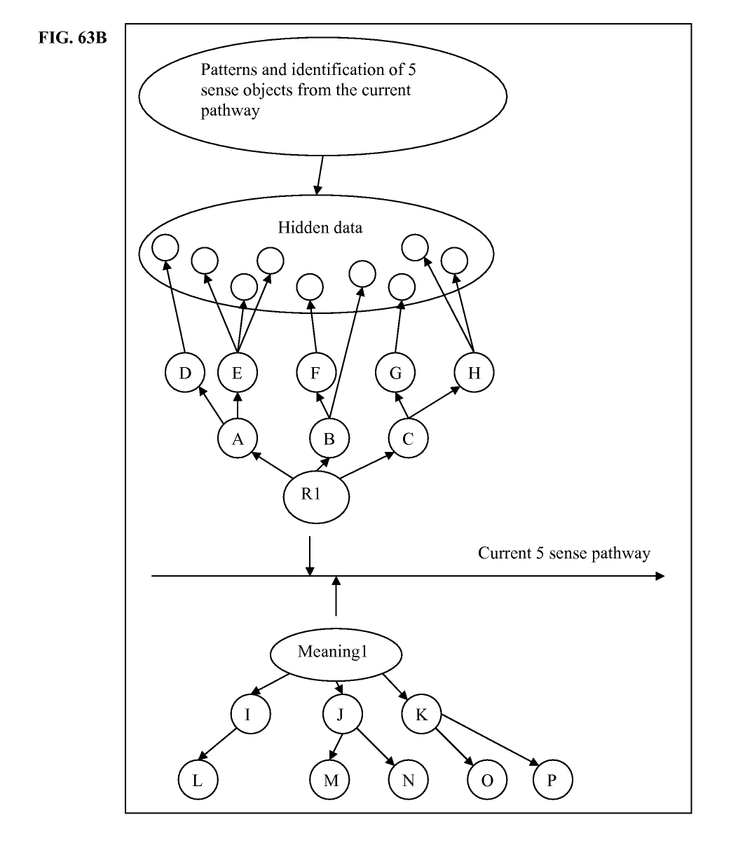

In the previous section I added hidden data to the 5 senses and explained how that data is integrated with the current pathway. In this section I have included one more data type (patterns). FIGS. 63A-63B are diagrams demonstrating the 4 types of data in the current pathway: 5 sense data, activated element objects, hidden data and patterns. Patterns are created in the current pathway only after self-organization. This part is very important to convey fuzzy logic in pathways and how patterns are used to create universal pathways. (I slowly introduce these data types so that the reader can understand what the current pathway contains and to understand each data type thoroughly).

In terms of searching for data the AI program will use the common traits of the current pathway (the first 3 data types) and compare them with the data types in other pathways in memory. In terms of self-organization the AI program will group common traits together and either create or strengthen existing common traits in memory. It also finds patterns within these common traits and creates a sort of patterned sequence based on the four data types above. After the self-organization is done the most dominant hidden objects in memory will stand out from the weaker hidden objects. The hidden objects will be assigned to words/sentences by the rules program and will represent meaning to language.

In some sense only complex words or sentences have hidden objects as meaning. Other data from the 5 senses are much more straight-forward. For example an image of a dog has the meaning of the sound “dog”, the sound of a cow ‘mooing’ has the meaning of a visual image cow, and the visual image of a cat has the meaning of the sound “cat”. These are simple examples of meaning to words. A more complex form of this is putting these words together to form sentences. This form of sentence objects need a more complex way of stringing meaning together and that is why hidden objects are used to assign meaning to complex words or sentences. A word like “universe” isn't something that can be represented with a visual image (it can be). But a true meaning of the word has to be from complex intelligence and this complex intelligence can only be formed by using hidden data and finding and fabricated patterns within these hidden data.

Patterns and Identification of 5 Sense Objects

All four types of data in the current pathway will be used to find any repeated patterns with similar pathways in memory. These four data types are: commonality groups, learned groups, hidden data, and patterns. Instead of explaining what the different kinds of patterns exist I will use simple examples to illustrate this point.

1. Sentence Represented by Sound

The first thing the AI program will do is identify the 5 sense objects from the current pathway. If there was a picture of the text word “cat” and right next to the text word is a picture of cat, then we identify that the text word “cat” is identified by the visual picture of cat. If someone said “cat” and pointed at a visual image of a cat then that sound “cat” identifies the visual picture in the movie sequence. (a more complex way of identifying 5 sense objects is through conscious thought. This will be discussed in later parts of the patent).

If the AI program can't identify the 5 sense objects from the current pathway then it will identify the 5 sense objects using the default way—identified in memory. For example, if the robot had no visual sight and the only sense his got is sound, then when the sound “cat” is recognized by the robot, the identification is referred to in memory. If the robot has sight and sound then if a cat image is within the robot's sight then the sound “cat” is identified as the visual cat image.

Now, imagine there were two sentences, one with a question and another with an answer. The robot only have one sense: sound. These sentences are sound recognized by the robot. Since there is no vision the AI program will refer to the data in memory.

Sentences: What is 5+5? 5+5 is 10.

Identification of the words/letters in the sentence happens sequentially. The words/letters are known as the target object. The AI searches for these target objects and activate element objects that have strong association to the target objects (learned groups). The AI program will attempt to use measurements in the hidden data to find patterns. Since sound is linear data we don't have to worry about 3-dimensional space. But time is important. “The computer will average out the timing of similar pathways”.

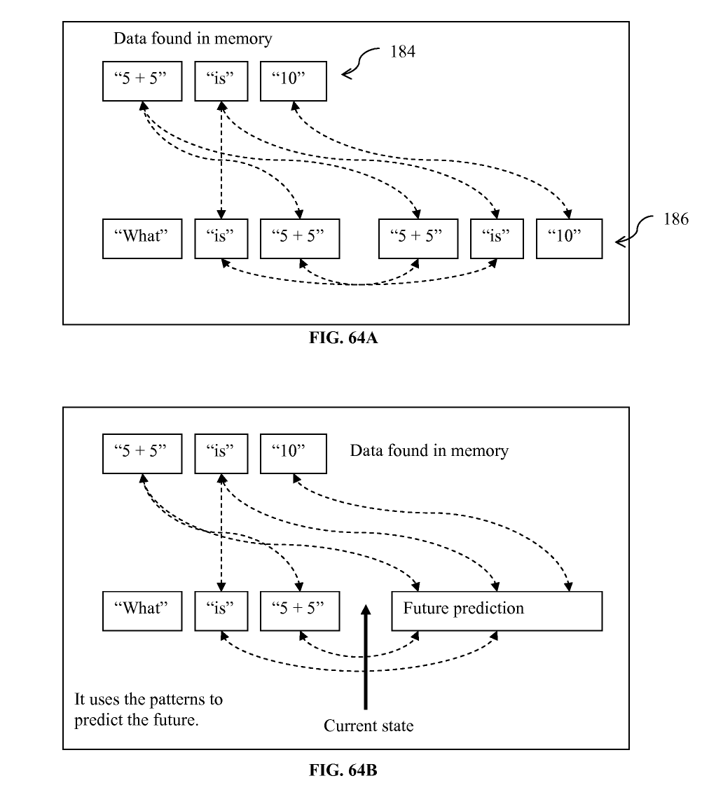

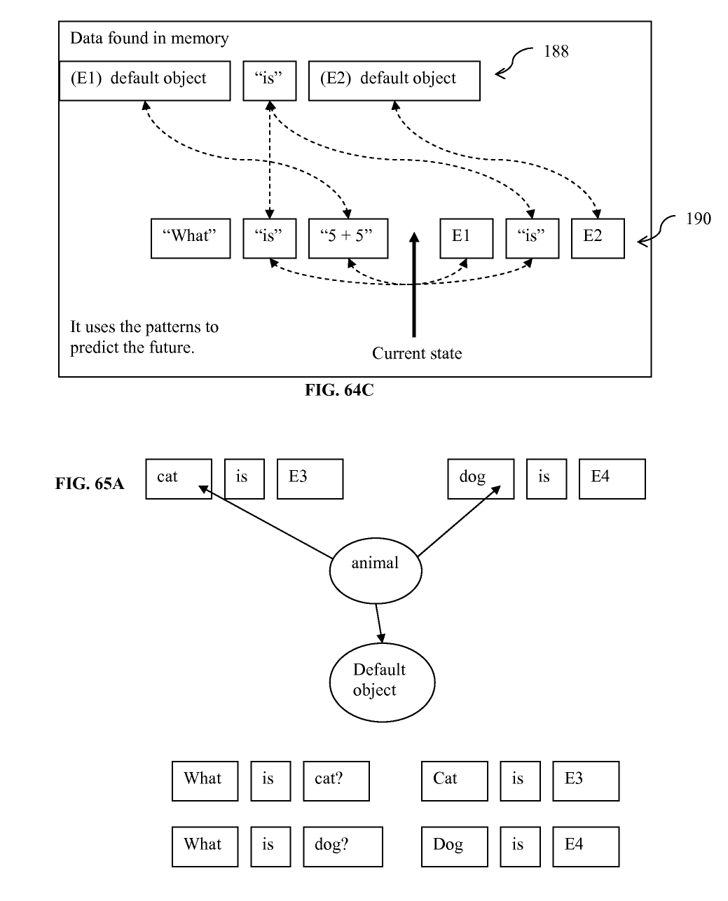

FIGS. 64A-64C are flow diagrams showing how the AI program finds patterns to similar pathways and output a universal pathway. FIG. 64A is an example of one pattern found. Equal objects is very important. The AI will attempt to establish an equal connection with the sequential data 186 in the current pathway and data 184 from memory. Once all these data are found, the AI will compare this example pattern with other similar examples in memory and establish a universal pathway. This universal pathway contain the instructions to find future data based on the current state (FIG. 64C). For example, if the AI encounters: What is 5+5? and the current state is at the end of the question, then the future prediction has already been established based on the pattern in the example (FIG. 64A-64B). The future prediction is “5+5 is 10”. Other similar Q and A can be predicted such as:

What is 8+8? 8+8 is 16.

The AI program averages out the patterns at every sequence in the pathway so that regardless of what state in the sequence the AI is in it already has a copy of the pattern that it needs to predict the future.

In FIG. 64C the universal pathway will contain the average of all similar examples in memory. Data 188 found in memory and data 190 from the 5 senses have patterns and the patterns are indicated by dotted arrows in the diagram. The default learned groups will accompany the data (target objects). The example shows that E1 and E2 are represented by default learned groups and this default learned group can be anything.

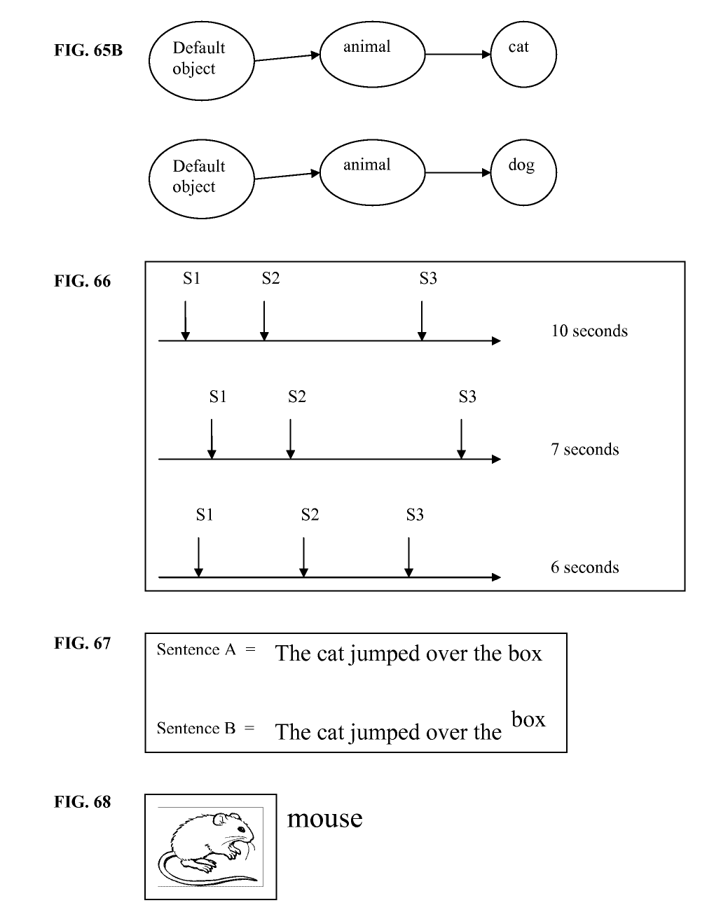

The learned groups that accompany the target objects may not be a default object but any of its hierarchical learned groups. The example in FIG. 65A show using a cat and a dog as target objects. Although they are different the fact that they share a hierarchical learned group establishes an equal pattern. The sentences don't make any sense but you got the point.

Both cat and dog are animals so that learned group will accompany the pattern to find more specific types of data (FIG. 65B).

The examples in FIGS. 65A-65B show that using hierarchical learned groups that are shared among data can lead to a more defined and specific pattern. The more specific the pattern is the better the future prediction is.

The timing of when the target objects (words) occur is averaged out by the AI program and a fuzzy range of how the sequences occur will be added to memory. The closer the timing of the target objects the more accurate the future prediction will be. Also the length of the target object is also averaged out so a word like “computerization” and a word like “bat” can be represented as the same object in the pattern. Remember we are only dealing with sound here (sound words). These words and sentences are linear in order. In the next section we will discuss how words and sentences are interpreted on a 3-dimensional visual environment (visual text words).

FIG. 66 is a diagram showing the different times events occur. Actually the timing of when objects occurred is part of the hidden data attached to the current pathway. The time of S1, S2, and S3 target objects recognized at different times. The AI program averages out the time and output a universal pathway that give an approximate time certain objects occurred.

2. Sentences Represented by Visual Text

When dealing with language on a visual 3-dimensional space, the AI has to worry about position of the letters/words. Text words on books and monitors are language represented on a visual 3-dimensional space. Just like sound words/sentences the AI program identifies words/sentences sequentially. This time the position of the words is a factor that must be taken into consideration.

FIG. 67 is an example of two similar sentences but in sentence B the word box is not centered as sentence A. These two are not considered identical, even though the computer reads in the words in the same sequential manner.

Using visual means to represent language is far more advance and has a lot more capabilities than representing language with sound. For one thing we can now manipulate visual images on the frames by moving images, deleting images, creating images, identifying images and assigning one image to another image. Language can now be represented in such a manner that the possibilities are limitless.

There is no such thing as built in assignment statements. In my AI program objects are assigned to other objects in terms of activation by the rules program. If the text word “cat” is encountered and the rules program activated an image of cat, then the cat image is equal to the text word “cat”. The only way for this to happen is if the text word “cat” is encountered many times along with the visual image of cat. Both the text word “cat” and the cat image is strong in terms of association that they are considered equal. The example below demonstrates this idea.

FIG. 68 is an illustration of a mouse and the text word mouse. If you keep showing a mouse picture and the text word mouse then these two objects will have greater and greater association to each other. When the association between the two are strong enough one object will activate the other object and vice versa. The example in FIG. 69 shows what happens when the text words mouse is identified by the AI program. The visual picture of mouse gets activated. The next time that we see the visual text mouse and a visual picture mouse, the AI program will identify that mouse picture with that text word mouse.

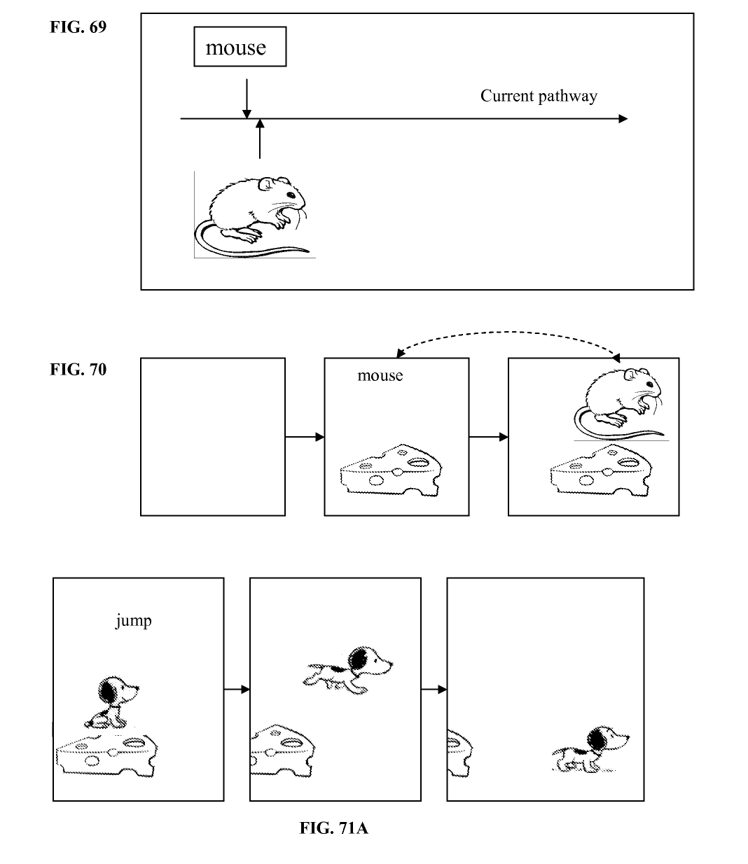

FIG. 70 is an illustration of how the AI program identifies the word mouse in the movie sequences. In the movie sequence when the text word mouse is identified, the AI program assigns this mouse word to the mouse picture in the next frame. The AI could have assigned the mouse word to the cheese picture but these two objects aren't equal. This technique is also used in words that take up multiple sequential frames in a movie—a word like jump.

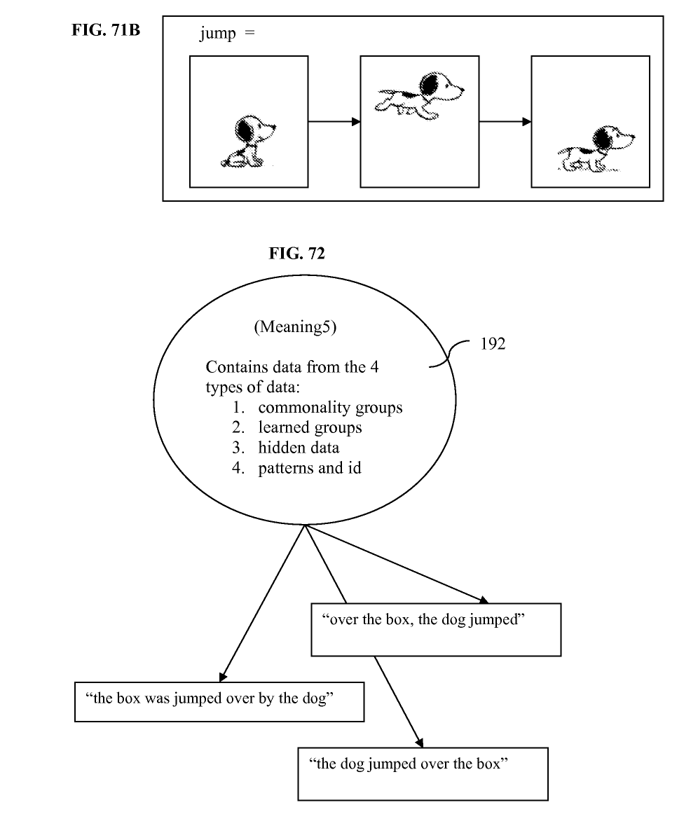

FIGS. 71A-71B is an illustration of how the AI program assigns the word jump to a movie sequence. The jump word is assigned to the jump sequence of the dog. The cheese is not part of the word jump (FIG. 71B).

These simple examples are used to demonstrate that when a sentence is identified by the AI program it will also identify if words in the sentence have a reference in the movie sequence. A more complex example is the sentence: the dog jumped over the box. The AI will try to find all the objects that are involved in the sentence. The object dog is involved. That means all the sequential image of dog will be cut out from the movie. The jump sequence is involved so the sequence of the dog jumping is cut out from the movie. The box is involved so the sequential images of the box will be cut out of the movie. Using all these objects from the movie the AI can combine these layers of the movie and form a sequence that only involves the sentence: the dog jumped over the box. Patterns are also involved to understand the sentence fully. For example “jumped over” means that the dog image layer is positioned above the box image layer.

Identifying Meaning to Sentences in the Current Pathway

The above example illustrate an exact meaning (the sequence that reflect the sentence) to a sentence (the dog jumped over the box). In real life the brain can only store a fuzzy range of the meaning to a sentence and not the exact meaning. The self-organization will average out similar examples in memory and forge a universal sentence pathway to cater to infinite possibilities. This universal sentence has a broader meaning that can cater to the example above and anything that is similar.

I will explain the self-organization part further because that will demonstrate how the universal pathway is created. If you had three sentences such as:

1. the dog jumped over the box

2. the cat jumped over the box

3. the rat jumped over the box

The meaning to this is quite apparent, simple replace R1 (default object) in the position in the sentence that has many variations. This will create a pattern in which during runtime the AI can replace R1 with the appropriate object and the meaning can be understood.

Universal sentence: the R1 jumped over the box.

The sentence can be even more universal by averaging the other object in the sentence: R1 jumped over R2. Now, the AI finds the meaning by replacing R1 and R2 with its appropriate objects during runtime. That fabricated sequence is the meaning to the sentence.

In this section the topic is: identifying meaning to sentences in the current pathway. This means that we have to identify the elements and patterns in the meaning and try to find the sequence that it belongs to in the current pathway. At this point the sentence that activated the meaning has nothing to do with this. Once the rules program activated a meaning to a sentence, that meaning has to be identified either in the current 5 sense pathway or in memory. (remember I said that all objects, target objects or element objects, must be identified). This is important because self-organization will group different or similar sentences together that have similar or the same meaning.

FIG. 72 is a diagram of different sentences assigned to the same meaning. Although all the sentences are different the meaning is virtually the same. This groups all the different sentences together. This is how the AI program will understand the same meaning of a situation regardless of what sentence is being used to explain the situation. The AI program will use all the elements from the meaning (Meaning5 192) and try to identify the sequence of the sentence from the current pathway. If there is no sequence from the current pathway that matches the meaning then it will be assigned the default setting which is identification of meaning in memory (for example, if the sentence was sound and the robot closes its eyes no sequence will be identified in the current pathway. But images and movie sequences from memory will activate providing a fabricated movie sequence).

More Examples of Fuzzy Logic

In this and the next section we will discuss about fuzzy logic and how sentences are represented in terms of fuzzy logic. Things that we say in a language can mean the same things. Sentences such as:

1. “stack up the blocks in an A B C format”

2. “I want you to stack the blocks up starting with C then B and finally A”

3. “can you please stack the blocks up in alphabetical order”

Although visually the sentences look different they mean roughly the same things. The meaning is what brings these three sentences together. This is what I mean by representing words/sentences in terms of fuzzy logic. The three sentences above are said during a particular situation but the exact sentence is not encountered everytime. This will store the sentence temporarily in memory because it doesn't repeat itself, while on the other hand the meaning and its encapsulated formats become stronger and stronger.

In this section I will try to present simple examples to illustrate my point about how meaning is assigned to words/sentences. Some of these examples might contradict my previous lessons but let's just say that there are several ways of accomplishing the same things.

The next example is to find the meaning to sentences that have this structure:

“F1 on F2”

F1 and F2 are variables assigned at runtime and it could be anything. Among some of the sentences that fall into this category are: triangle on square, circle on square, square on pentagon, mouse on cheese, and so forth. The sentence structure “F1 on F2” is a universal sentence that will cater to infinite possibilities.

In order to create this universal sentence the meaning of all the sentences have to be the same or similar. The variables F1 and F2 are default objects (default learned group assigned to a 5 sense data). Since all objects in memory are derived from a default learned group then F1 can represent any object in memory.

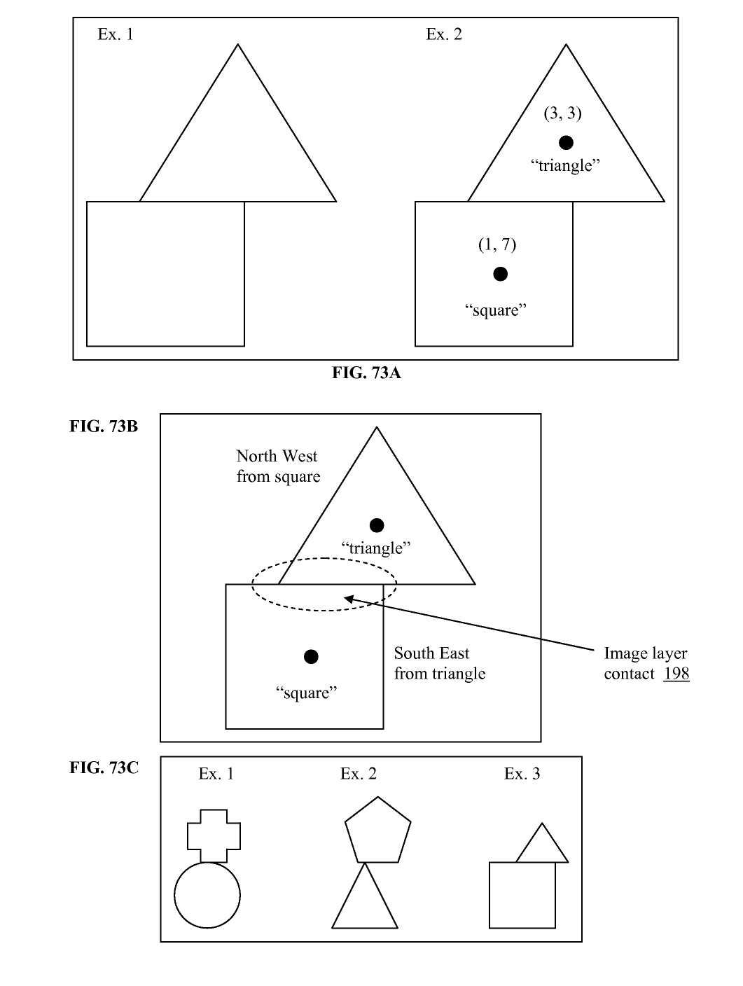

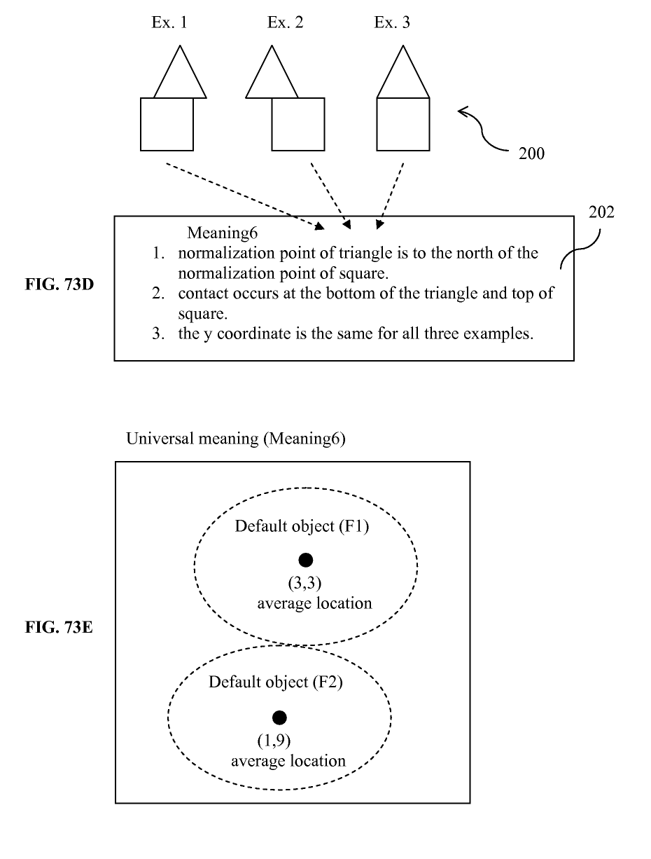

In example1 a triangle is on top of a square (FIG. 73A). On example2 is the learned groups and the hidden data that accompanies all the image layers (FIG. 73A). The dot in the center of the triangle and the center of the square is the normalization points. It is accompanied by the coordinate point in the frame. The learned group for each image layer is also attached to the image layer. The triangle image is accompanied by the learned group “triangle” and the square image is accompanied by the learned group “square”. In FIG. 73B the contact point 198 between the two image layers is shown. These are just some of the hidden data that is attached to the image layers, there are many more.

When the AI finish assigning these hidden data and learned groups to the image layers it will then establish relationships between image layers. FIG. 73C is an example of some of these relationships. The triangle is north west in relation to the square. The square is south east in relation to the triangle. The triangle is in contact with the square which means it is touching one another. The contact location is delineated by the dotted line.

Referring to FIG. 73D, after averaging out similar pathways in memory the computer will have a universal meaning that all examples have (or at least the majority of the examples have). Pointer location 200 is the different variation of the “triangle on square” examples. All three examples contain the data in Meaning6 (block 202).

In all three examples the meaning is the same. All statements in Meaning6 are true for all three examples. In fact, you can come up with infinite variations to visual images of a triangle on a square and the computer will still generate the same meaning.

In terms of what sentences are assigned to what movie sequences, it will all depend on the rules program to find the association between two objects. The more times you train a sentence with the movie sequence the stronger that association will become. The closer the timing of the sentence with the movie sequence the stronger the association will become. This means that the meaning can be assigned to any sentence and the meaning can be changed. For example, I can assign “triangle fly square” to Meaning6. All I need to do is train the rules program so that “triangle fly square” is assigned to Meaning6. I have to train it so that this sentence overpowers the previous sentence: triangle on square. All of this would mean that I can use words/sentences from different languages to represent the same meaning. This is why this form of language learning is universal.

Extension of the Last Example

Now we add in the learned groups to this example and see how a universal pathway can be applied to “F1 on F2”. FIG. 73C are 3 similar examples of “F1 on F2”. The only real difference is that the image layers are different, but the meaning of the sentences is the same. In order to create a universal meaning (FIG. 73E) for these examples we have to replace the image layers with their respective learned groups that all examples have. In this case all three examples have default object, so that will be the learned group that will represent the meaning.

The image layers can be represented by other learned groups as well. However, all three examples above share only one learned group—the default object. On the other hand, if we learned that all image layers in the examples are shapes. Then we can replace the default object with the learned group “shape”. If the image layers were animals like cat, dog, and mouse, we can use the learned group: “animal” as the universal variable. The more specific the learned group is the more specific the actual movie sequence can be. The less specific the learned group is the broader the movie sequence can be. In some sense all the pathways in memory are hierarchical in nature and it goes from general to specific. The AI program will most likely pick the most specific to predict the future because the more specific the meaning the more accurate the future prediction is the less specific the more inaccurate the future prediction is.

This is why it is so important for the AI program to encounter many examples of a situation in order to predict the future when that similar situation is encountered.

Complex Sentences and Meaning

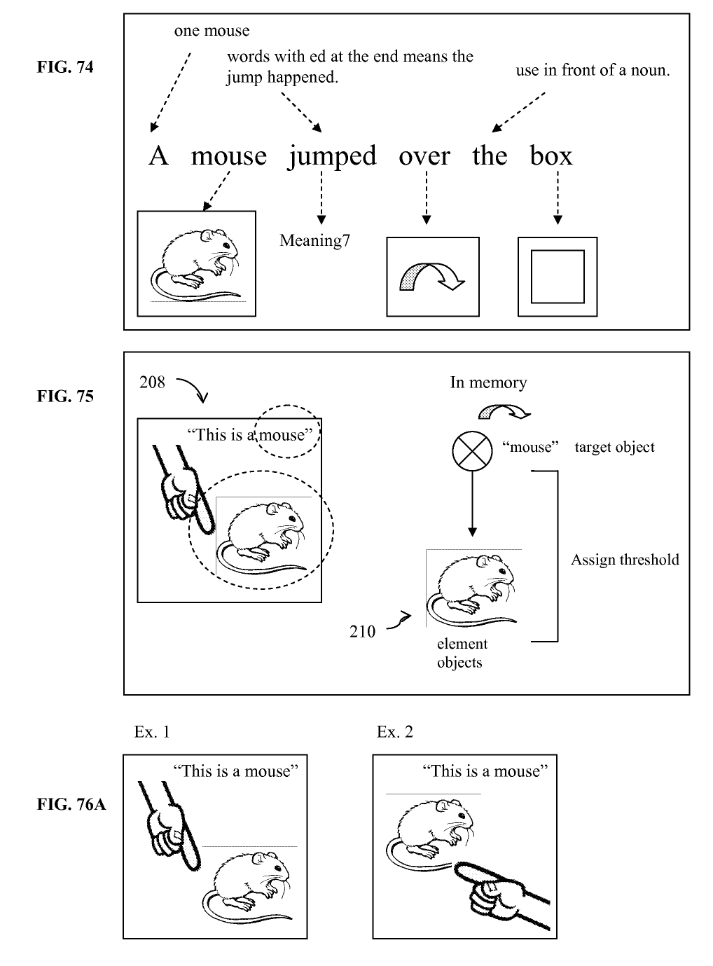

I would like to say that representing all words/sentences in a language can be done by the method presented above but that isn't how complex intelligence is created. In order to learn a complex sentence, grammar rules are included in the sentence to understand what different words mean and how the words interact with pictures or images in our environment (FIG. 74). This is where the human conscious comes in. Trees are instructions activated by the rules program to instruct the AI program to understand meaning, give information about an object or situation, or solve a problem. These trees are usually in the form of sentences or visual (and sound) movies that tell the AI what to do next.

Notice how complex understanding a sentence like the example in FIG. 74 really is. Understanding a sentence comes from teachers in school that thought you the rules of grammar in a particular language. We use other words/sentences to encapsulate those lessons and import these lessons to understanding structures and meaning in sentences. The computer uses all the activated element objects and the target objects to assign variables in meanings (meaning7) to get a better idea of what all the words in the sentence really mean.

Assignment Statement Example

In previous lessons I stated that assignment statements are done by what is activated by the rules program from the target object. However, in order to learn that the activation of element object from target object is equal, we have to use patterns. The sentence: “this is a mouse”, require that a pattern is found to state that the sentence is saying that an image in the picture is the equivalent to the word “mouse”. One pattern that can be used is the equality of two objects. If two objects are stationed in the same assign threshold they are considered equal. In order to understand the sentence: “this is a mouse”, the AI program must find “this” and “mouse” to be equal objects. In pattern finding the AI has to work with all the patterns that the programmer has set up. I won't disclose all the patterns just yet, but one of these patterns is the assignment state or equality of two objects. The only way to find out that two objects are equal is by looking at their respective location in memory. Do both objects fall into the same assign threshold? If the answer is yes then both objects are equal.

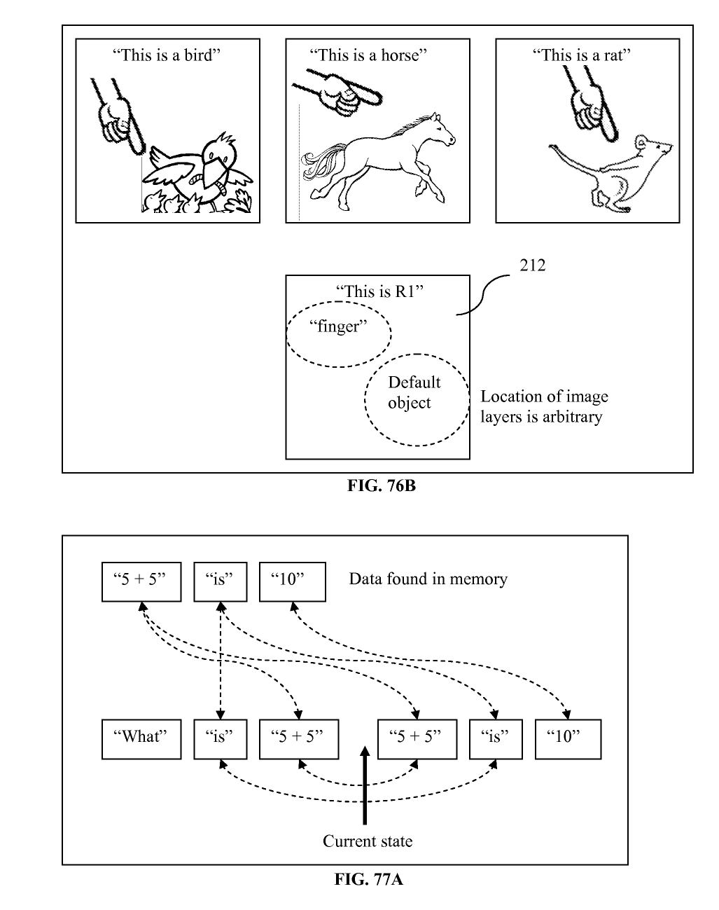

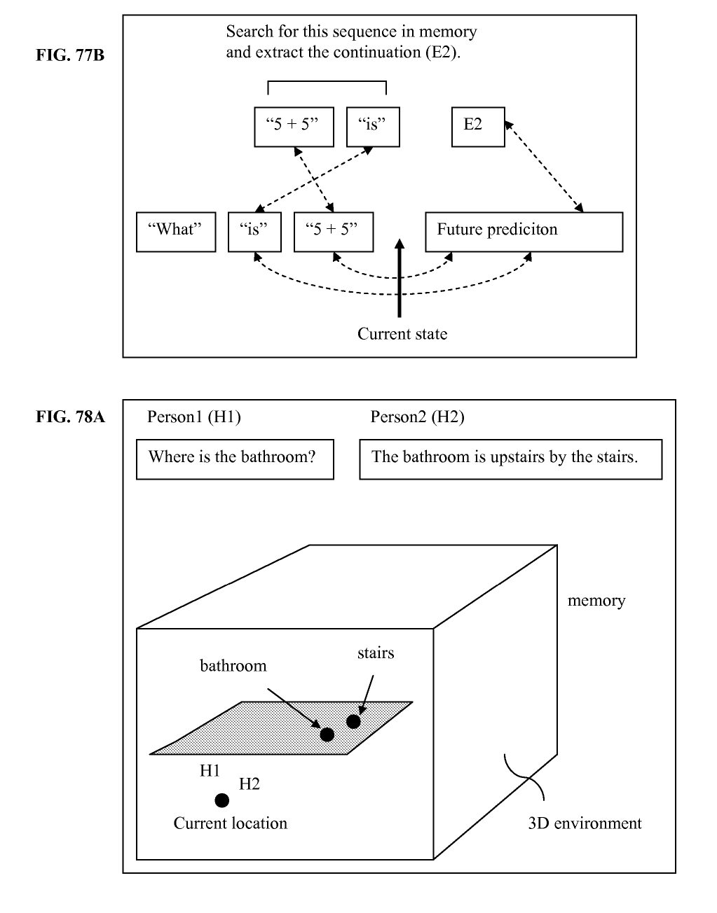

Referring to FIG. 75, in frame 208 “this” is referring to the image the finger is pointing to. The image layer is a picture of a mouse. In the sentence contains the words mouse and in the frame contains an image of mouse. The pattern resides in data 210 in memory where the sound “mouse” and the image mouse are equal. By averaging this example with other similar examples the AI program will understand that the sentence “this is a R1” is actually an assignment statement (FIG. 76A).

In FIG. 76A the AI program has to learn the different variations of the situation from 360 degrees (Ex. 1 and Ex. 2). The finger can be anywhere in the frame and the mouse can be anywhere in the frame. Each image layer can be different but belong to the same object. For example, the hand can be any image from the hand floater. The mouse can be any image from the mouse floater. The sound “this is a mouse” and the learned groups in the frames binds them all together and the computer will find the common traits among all the different examples.

We can extend the last example by introducing variables in terms of the objects. The different ways of presenting the sentence is illustrated in FIG. 76B.

The self-organization function will average the three examples in FIG. 76B and create a universal pathway 212 that will cater to all similar examples. This universal pathway 212 will be used to understand the sentence the next time the AI encounters a similar situation. The default object will be assigned an image layer in the frame at runtime, the “finger” will be assigned an image layer in the frame at runtime, and R1 will be assigned a sound (word) at runtime.

Patterns

In the last section I have given one example of the assignment statement. The assignment statement is one internal function used to find patterns. The sentence “this is a mouse” demonstrate how language represent the assignment statement (FIG. 75). In previous sections I outlined another internal function to find patterns which is searching for a particular data in memory and extracting information from this data. Answering questions such as “What is 5+5? 5+5 is 10” is one example of how the AI uses internal functions instructed by patterns in a pathway to predict the future (FIGS. 64A-64C).

I wanted to slowly introduce the different types of internal functions that are available to the AI program to find complex patterns within similar pathways. In this section I will outline most of the internal functions that are used by the AI program and give examples of these patterns. As always, words/sentences are used to express how the patterns work.

Equal Objects and Hierarchical Learned Groups Establish the Elements Involved in the Pattern

Equal objects and its hierarchical learned groups is what will establish the data that we want to find patterns to. It provides us with the means of sorting out what data are involved in the patterns. Let's review on the question and answer example, “What is 5+5? 5+5 is 10” (FIG. 77A). The equal objects in the pathway and the pathways in memory establish what will happen in the future before that future happens.

Referring to FIG. 77A, imagine that we are at the current state, the objects that we encountered can be used to predict what will happen in the future. Objects from the question are used to find what will happen in the future. Equal objects from the future and equal objects from the past are used to establish the patterns to get a future prediction.

The equal objects established in the pathway aren't just the objects we need to find patterns. We have to look for these objects in memory and find out the relationships between all the equal objects in the current pathway as well as the equal objects in memory.

Referring to FIG. 77B, after the AI determine all the equal objects in the current pathway and the pathways in memory (indicated by dotted arrows), the AI will compare this current pathway with other similar pathways in memory. The pattern is the result of common traits among all the similar pathways. After averaging the data the AI program will determine that in order to predict the future from the current state, the AI must use some of the objects from the question and search and look for some of these objects in memory and extract certain data from memory. The AI will utilize internal functions in order to accomplish these tasks.

FIGS. 77A-77B is just a review on how the AI program finds patterns to predict the future. Here are most of the internal functions used by the AI program to find meaning to language and predict the future:
1. the assignment statement—the rules program determine the assign threshold. If two objects pass the assign threshold that means both objects are equal. Patterns are used to assign this function to a sentence.
2. searching for data in memory—This function searches for and extract specific data from memory by using patterns that were found by similar examples. The AI program can extract data from linear sound, it can extract data from 2-dimensional visual movies, or any other 5 sense data.
3. determining the distance of data in the 3-d environment—finding the distance between two or more objects in memory based on patterns.
4. rewinding and fast forwarding in long-term memory to find information—the length of when certain situations happen and where it happened is based on patterns. Information will also be extracted from the movie sequences.
5. determining the strength and the weakness of data in memory. How strong is one data compared to another data and how the data changes during a time period depend greatly on patterns.
6. a combination of all internal functions mentioned above.

These are just some of the internal functions that are being used by the AI program. The most important is searching for data in memory. Most of the time this function will be used to find patterns. Instead of explaining each internal function to the reader, I decided to provide examples to illustrate how they are used.

### EXAMPLES

A. The assignment statement—the example in FIG. 75, “this is a mouse”, explains how this function works. The AI program creates an assignment statement to the sentence “this is a mouse”.

B. Searching for data in memory—the example in FIGS. 77A-77B, “What is 5+5? 5+5 is 10”, explains how this function works. The AI program uses similar pathways to find a universal pattern to answer the question. It not only searches for certain data from the problem but it also extracts data from pathways in memory.

C. Determining the distance of data in the 3-d environment (data in memory).

The pathways sensed by the robot will be stored in memory in a 3-d environment. For these 2-d sequential frames the AI will store them so that a 3-d environment is created. This 3-d environment will be used to find information.

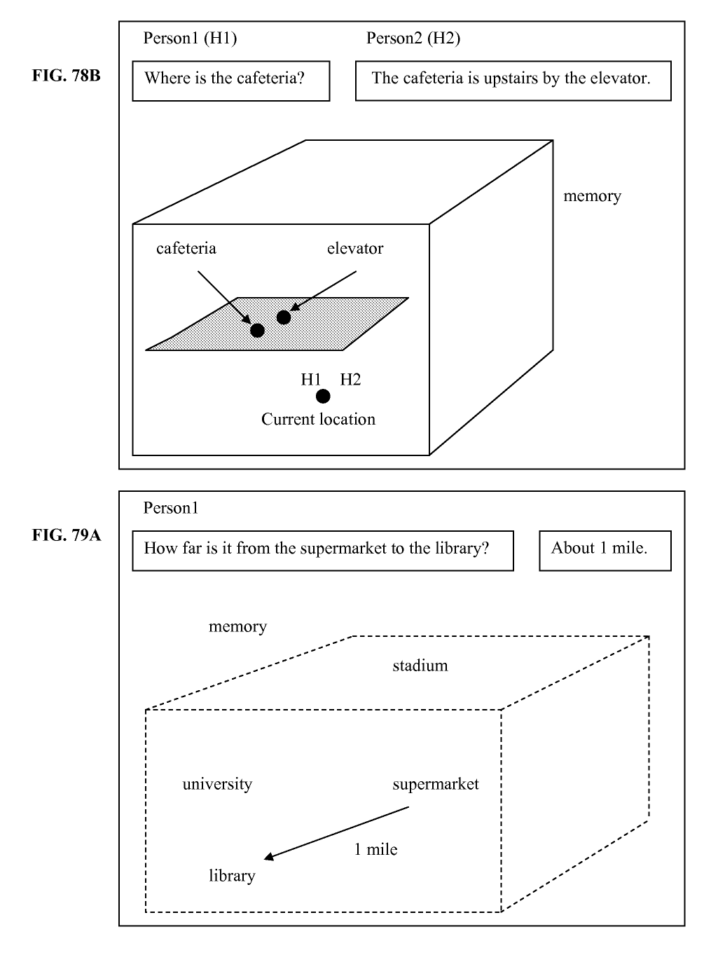

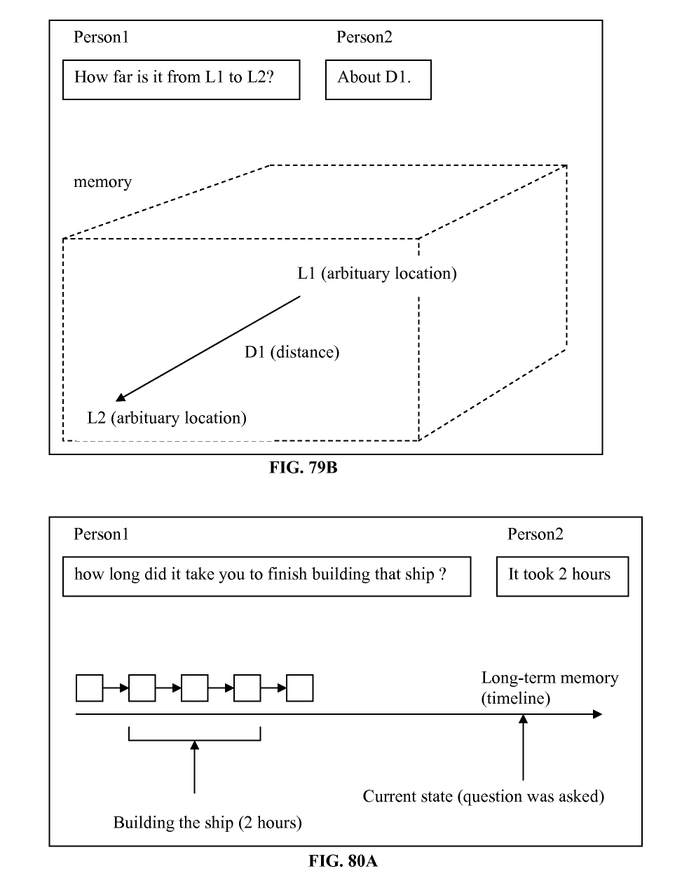

FIGS. 78A-79B are diagrams showing internal function: finding data from the 3-d environment. The question “Where is the bathroom?” is a question that require the robot to use the 3-d environment to extract the location of objects. In this case bathroom is the object. This sentence is derived from “where is the W1”. W1 is a variable representing an object. The AI encountered many examples of similar questions and was able to create a universal pathway. There are actually two ways that this question can be answered. The example in FIGS. 78A-78B present the first way to solve this problem the other way to solve this problem is by using trees to instruct the AI program to answer the question. The first way to solve this problem is by observing the sequential events that occurred and see if there are any patterns involved.

The AI will establish the target objects found in memory. Then it will attempt to find patterns between similar examples (FIG. 78A).

So, based on these two similar examples (FIG. 78A and FIG. 78B) the AI will forge a universal question and answer pathway. Instead of using visual data in our environment to find the patterns the AI uses the visual environment in memory to find these patterns. The current location is one floor to the cafeteria so the robot will not be able to see the cafeteria nor the elevator. Instead the robot uses the learned knowledge of the structure of the building to find out patterns to the situation.

The next time someone asks the question: “where is the principal's office?”. Because the robot understands the pattern the robot can answer the question. It will identify its current location. Then it will locate the principal's office in memory. Finally, it will output the location based on a visual picture of the two destinations (the current location and the principal's office). Outputting the answer to the question might be an encapsulated instruction in terms of knowing how to say things in English and interpreting locations of two places. These two knowledge has been learned before by teachers and is incorporated into the pattern by trees (sentences).

One more example to illustrate how the 3-d environment can be used to find patterns is determining the distance between two places (FIGS. 79A-79B). If the question: “how far is it from the supermarket to the library?”, the answer to this question would require the 3-d environment from memory.

The distances in the 3-d environment have already been assigned to language. So a certain distance in the 3-d environment activates certain words that represent the distance. In FIG. 79A the distance from the supermarket to the library is interpreted as 1 mile. This 1 mile is part of the answer the robot needs to answer the question. If the robot compares this example to other similar examples then a pattern is found. The universal pathway is presented in FIG. 79B.

D. Rewinding and Fast Forwarding in Long-Term Memory to Find Information

The next internal function is having the ability to rewind or fast forward experiences the robot has encountered. All the movie frames are stored in a timeline when it accord and the AI program breaks up the movie frames into sections and store these sections in memory. The long-term memory is this timeline and the timeline has reference points to all the data stored in various parts in the network.

There are questions that require the AI program to extract information from long-term memory. The example below illustrates this point.

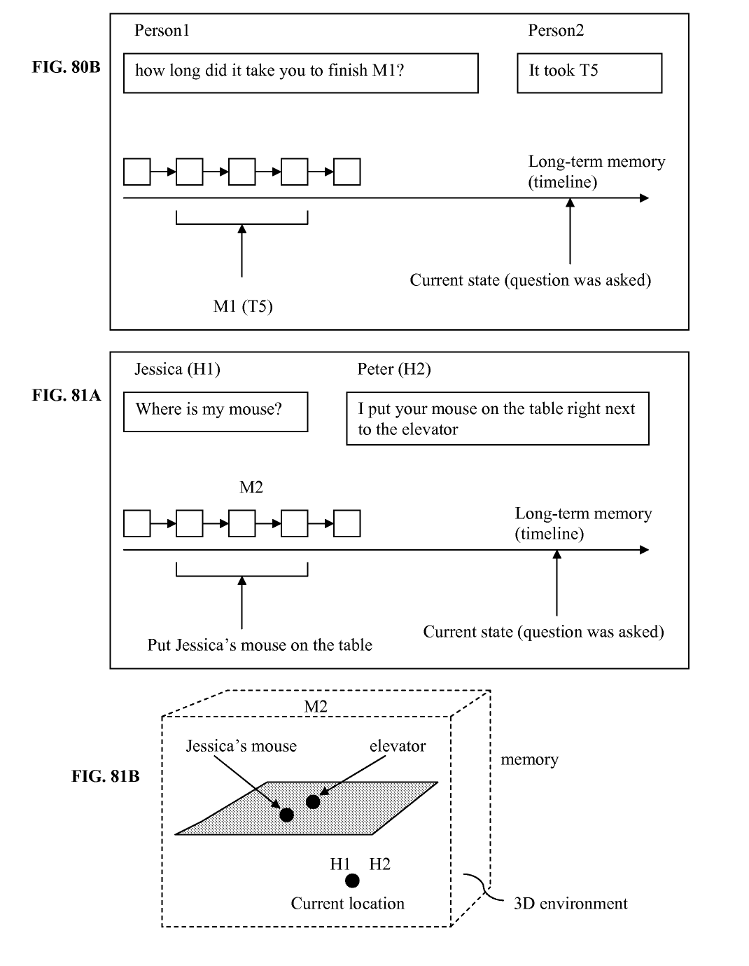

The example in FIG. 80A illustrates how long it took the robot to complete a task. The robot first searches for the movie frames regarding the building of a ship. Then it extracted the time it took from start to finish and use that information to answer the question. As always, this example will be compared to similar examples already stored in memory and the AI will determine wither or not there are patterns involved. FIG. 80B is the universal pathway used to answer these type of questions.

Everything in the pattern can be in a fuzzy range. For example, the question “how long did it take you to finish M1” can be represented as “how long did it take you to accomplish M1” or “you worked on M1 for how long?”. So, everything in the sentences can be in a fuzzy range and doesn't have to be exactly as the pattern. Everything from the sentences, to the image layers, to sound, and even the position of the image layers can be in terms of fuzzy logic.

Let's combine both internal function C and internal function D and give an example of both functions working together to answer a question. As mentioned above, all internal functions can be combined together to look for information. The pattern can be simple with one internal function or it can be complex with multiple internal functions working together to find information.

FIGS. 81A-81B are diagrams showing two internal functions: finding data from the 3-d environment and rewinding and fast-forwarding in long term memory to get information. The example in FIGS. 81A-81B uses both the long-term memory and the 3-d environment to look for information. First the AI program looks for the movie frames concerning Jessica's mouse. Then it extracts the movie frames from the long-term memory. Next, it extracts the information that it needs from the movie sequences (in this case it wants to know where Jessica's mouse was put last). Finally, it takes this knowledge and answers the question.

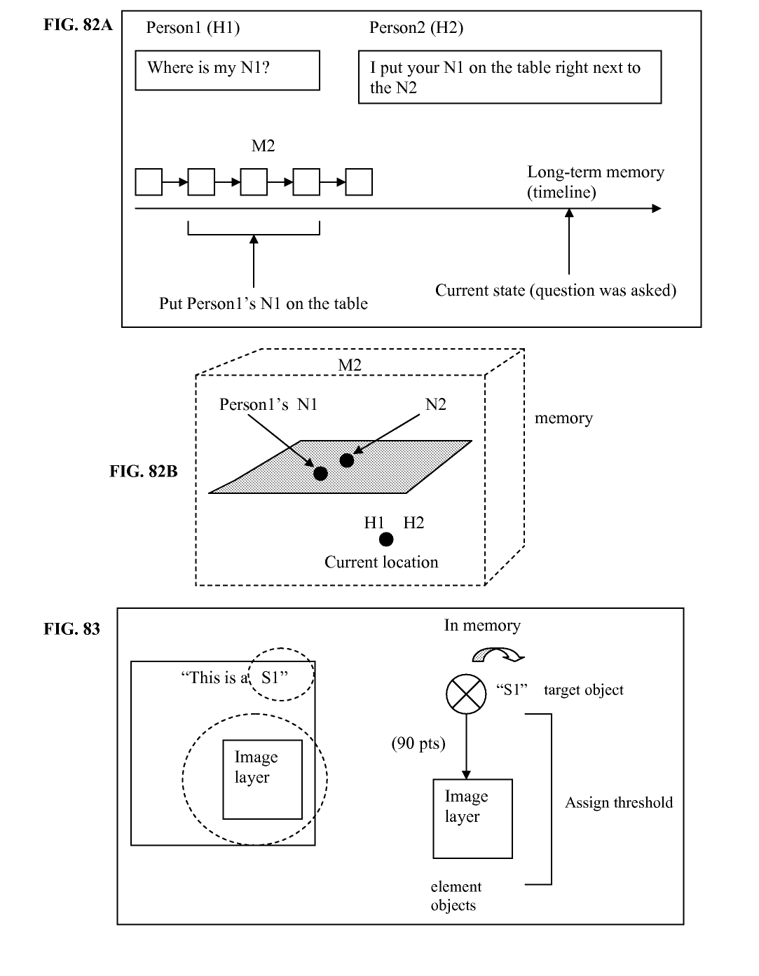

When many similar examples are trained the AI program will understand the question in a fuzzy logic way. The universal pathway will be created in terms of this question and answer situation (FIG. 82A-82B).

All internal functions are assigned to its appropriate places in this universal pathway (FIGS. 82A-82B). Before answering the question the AI will use internal function D (searching for information in long-term memory). Then it takes particular movie sequences and extract information from these frames using internal function C (search for information in the 3-d environment). The assigning of these internal functions to a particular moment in a pathway is done by averaging similar pathways and finding the patterns. It's kind of like reverse engineering what an event is and assuming what internal functions were used to get a particular information. The patterns are found and the event is assigned certain internal functions to instruct the AI to find information in memory. This is how the robot will be able to predict the future or find meaning to language. And these things are all done through fuzzy logic.

E. Determining the Strength and the Weakness of Data in Memory

In this example I will combine the assignment statement and the strength and weakness of data in memory. In FIG. 75, the “this is a mouse” example will be revisited. In order to assign one object to another object the AI program has to encounter these two objects many times before they can be assigned to each other. For instance, if I wanted the robot to assign the sound “cat” to the visual image of a cat, I would have to train the robot with both objects repeatedly. Maybe after 20 sets of training the AI program will understand that the sound “cat” is equal to the visual image of cat. If you think about all the words in the English language and how long it would take the AI program to learn these words, it would be very overwhelming.

There is an alternative to this brute-force way of learning words. The English language can be used to encapsulate patterns and these patterns can be used to accomplish certain tasks that would otherwise take a long time to finish. In FIG. 75, the “this is a mouse” example is designed to assign a word to a particular image. Along with determining that two objects are equal it can copy the connection strength of the two objects involved. This will allow the AI program to encounter two objects once or twice and the AI program “gets it”. The robot understand that this particular word identifies this particular image in the current pathway. Instead of using the old method of training the word with the image we have used sentences to represent assigning equality among two objects. In other words instead of training the robot 20 times with the two objects we can use the sentence 2 to 3 times before the robot understand a meaning to a word. The strength of the two objects (word and image) are given the average strength of all similar examples.

In FIG. 83 the sentence “this is a S1” is assigning the word S1 (a variable) with the image layer in the frame. The sentence will also assign the average strength of the connection between the target object and the element object. In this case the average weight of the connection is 90 pts. When the AI encounters the sentence “this is a bat” and in the frame is an image of a bat, the AI program (if it never saw a bat before) will create the word “bat” in memory and it will store the bat image close to the word “bat” with the connection weight set at 90 points.

Conscious Thoughts and its Development

Up to this point the AI program can understand the meaning to words/sentences and it can also create patterns in pathways that can predict the future. The understanding of meaning to language is also accompanied by fuzzy logic so that the meaning is more important than the words/sentences that represent that meaning.

The material covered up to this point is important to the understanding of conscious thoughts and how it is developed. The conscious serves many purposes for the robot. It provides the robot with valuable information about the environment, it gives meaning to language, it tells facts about an object, it guides the robot to solve arbitrary problems, it answers questions, and even provides a conversation when the robot is bored. (some conscious thoughts has very little to do with the 5 senses from the environment. This will be explained further in later sections)

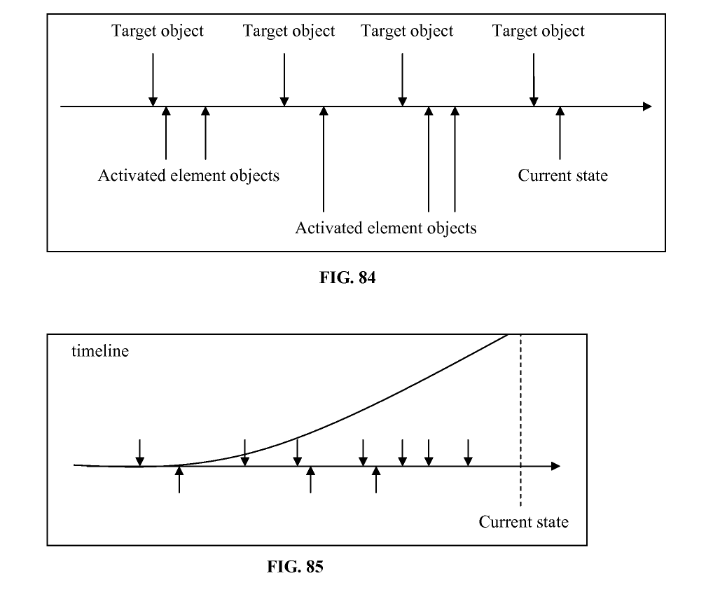

The idea behind the conscious is quite simple. The AI program recognizes target objects from the current pathway and all the elements from all target objects compete with one another to be activated in memory. These activated element objects are the conscious thoughts of the robot (FIG. 84).

FIGS. 84-85 are diagrams depicting target objects and activated element objects. The arrows at the top of the timeline are target objects and the arrows located on the bottom of the timeline are activated element objects (FIG. 85). All the target objects and all the activated element objects will have their element objects extracted from memory and the rules program will decide which of these associated element objects will be activated. Although activated element objects don't have the same strength as target objects, the rules program will consider the activated element objects too (activated element objects have ¼ the strength of target objects). In FIG. 85 all target objects and activated element objects closest to the current state will be considered first, while objects farther away will be considered last. This also means that the objects closest to the current state have higher consideration than objects farther away from the current state. When I say objects I'm referring to both target objects and activated element objects.

Fuzzy Logic is Very Important to the Rules Program

All data in memory is represented in terms of fuzzy logic. Visual images or 360 degree sequential images of a visual object has a fuzzy range of itself. A 360 degree floater of a cat will identify all the cats in the world despite their physical appearances such as size, color, weight, and age. The meaning to certain words/sentences also has a fuzzy range of itself. People can say totally different sentences but the sentences mean the same things (or roughly the same things). You can even use sentences from two different languages but the meaning of these sentences mean the same things.

The fuzzy logic is what brings order to chaos in the world we live in. It is also a very powerful tool used by the rules program to create conscious thoughts. The life we live in has infinite possibilities and chances of encountering the same sequence of events twice is impossible. However, we can encounter events in life in a similar manner.

Because all the data is stored in terms of fuzzy logic and each data has a hierarchical order of itself, the strength of pathways depend on which pathways in the hierarchical order is strongest and not the exact data itself. (Remember I said that the AI program may not pick a 90 percent match compared to a 20 percent match). The reason is because the strength of the pathway also matters in the decision making process.

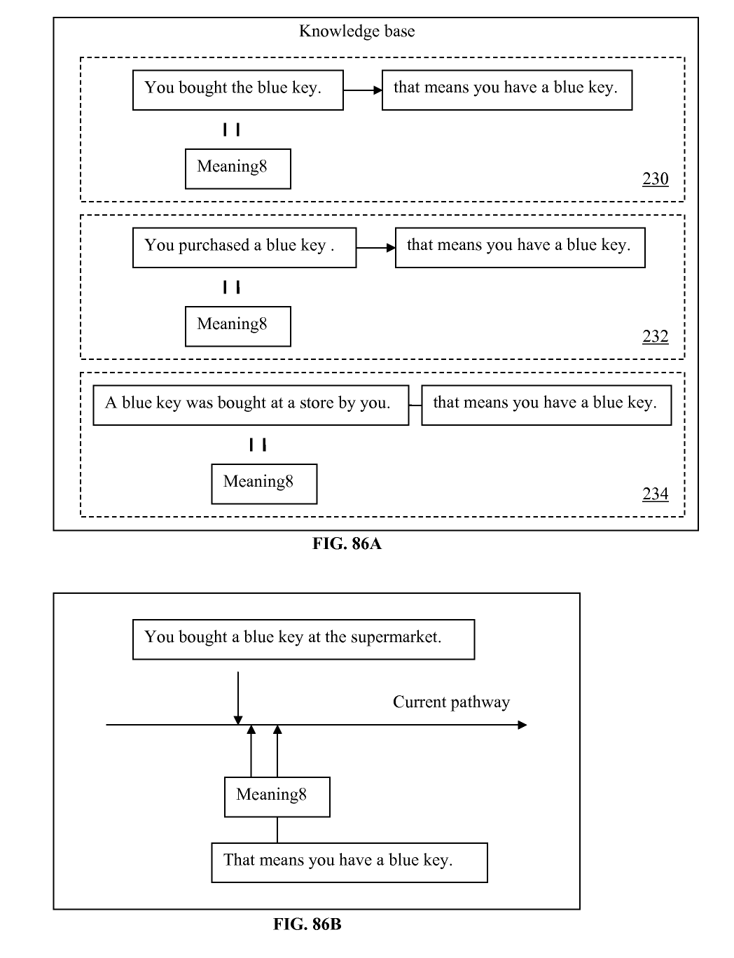

FIG. 86A is a block diagram showing sequential sentence association. Data 230, data 232, and data 234 are the training examples.

If we train the 3 examples in FIG. 86A over and over again, the AI program will have a strong connection between the first sentence and the second sentence. Although the first sentence isn't the same every time the meaning behind it is the same. The sequence is trained in terms of fuzzy logic and the meaning (a hidden object) is more important than what is actually sensed (the target object or the sentence).

If we apply this example to the rules program the reader will get an idea how the conscious works (FIG. 86B).

The sentence that was encountered by the AI program, “you bought a blue key at the supermarket” (FIG. 86B) isn't a sentence that was trained in memory. The three examples that were trained were different sentences but they share the same meaning (meaning8).

Because there was a strong association between the two sequential sentences in memory, when the AI encountered the target object “you bought a blue key at the supermarket”, the second sentence was the second element object to activate. The meaning of the first sentence was the first element object to activate. The reason for this is because the meaning had stronger association to the target object.

The second sentence can also be trained in a fuzzy logic manner. Instead of an exact sentence, a meaning can be activated.

The TV Problem

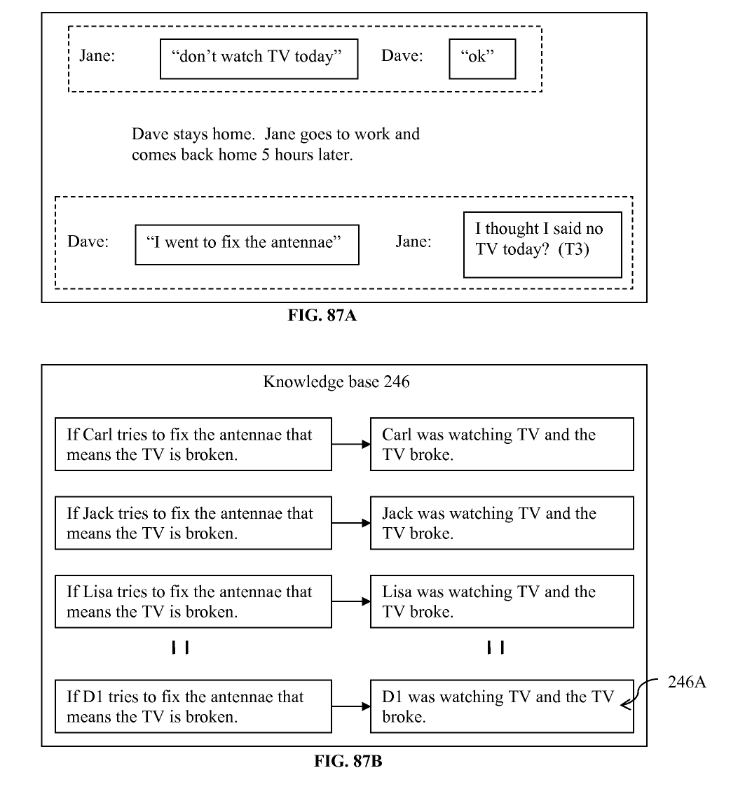

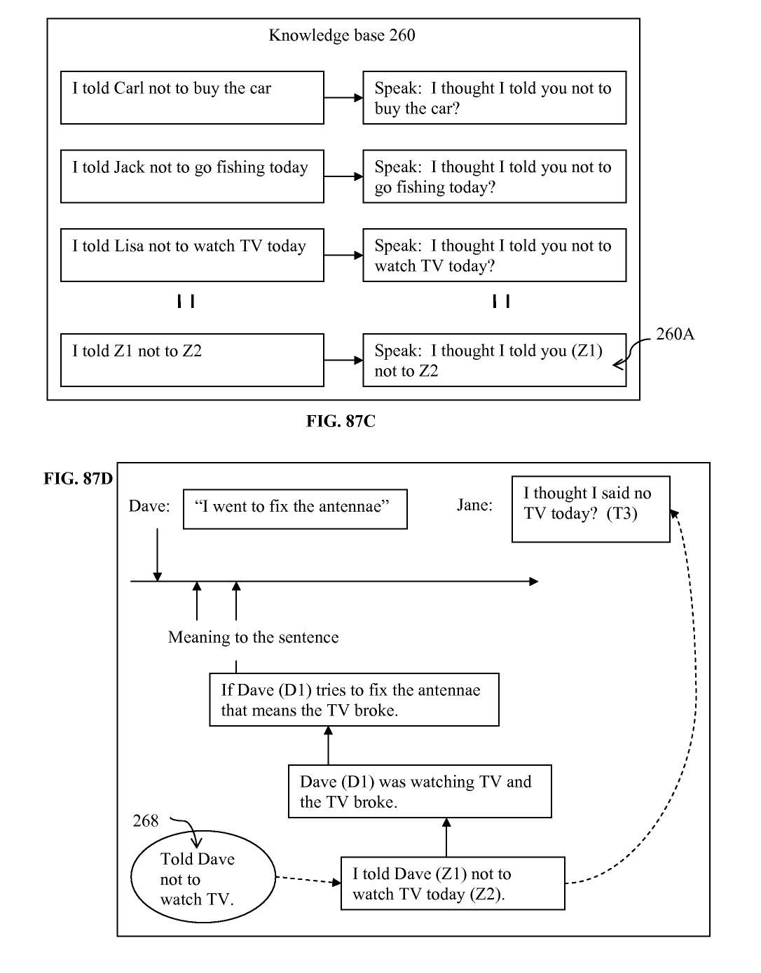

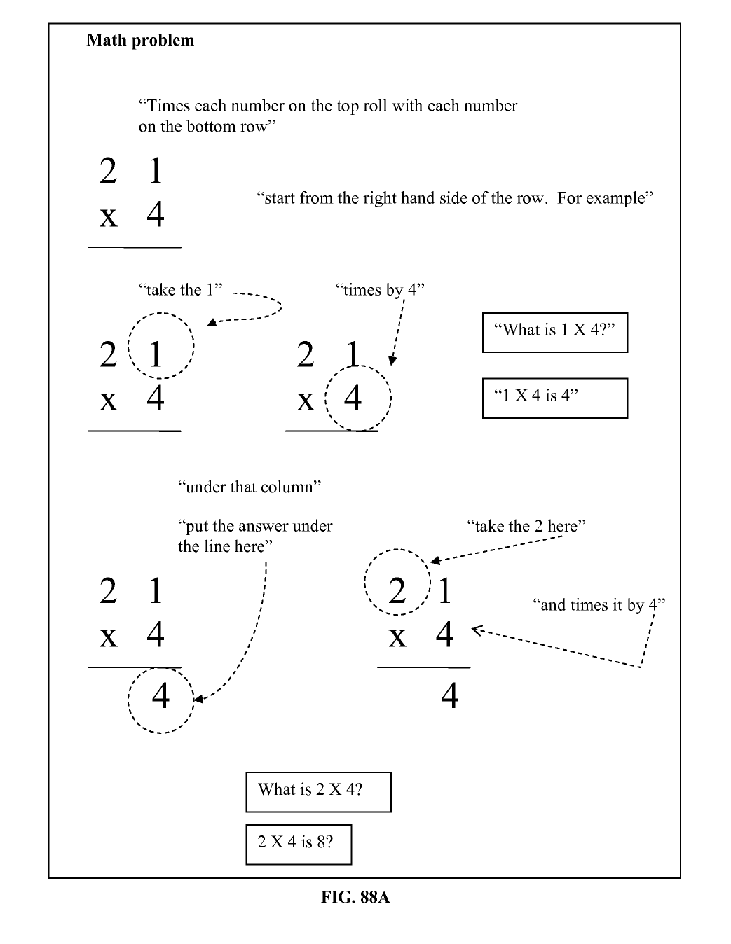

The next example illustrates how human conscious is used to create logic and reasoning. This example was taken out of a movie that I was watching. An idea popped up in my head when I was watching a scene where reasoning was needed to understand the situation. I did some reverse-engineering on how the logic was created and found out how reasoning happens in human beings. The diagram in FIGS. 87A-87D demonstrate this form of logic.

In FIG. 87A the reasoning behind this situation is that Jane told Dave not to watch TV on that day. When Jane came home from work Dave said that he went to fix the antennae. The logic behind T3 is that Jane knows that the antennae is attached to the TV and that the TV must have been broken. The only way that the TV broke is if Dave was watching TV and something happened to it. The way that the AI program outputs the logic in T3 is by the lesson I thought earlier about sentence association. The more times the robot learns knowledge about a situation the more likely that knowledge will be activated by the rules program. Knowledge could be any data in memory, most notable sentences or movie sequences that include sentences and words that have references to the movie sequence.

The knowledge from logic T3 is presented in FIG. 87B-87C. These strong sentences were activated by the rules program and it gave Jane the knowledge to come up with T3's logic.

The knowledge base 246 and 260 are lessons learned by teachers or by observation (FIG. 87B-87C). They are just a bunch of sentences and movie sequences that teach a person knowledge about a situation. The objects within these knowledge base are strong so when one object (first sentence) is recognized by the AI program the other object (second sentence) in the situation will activate. In the example in FIG. 87D, the situation is set up when Jane told Dave not to watch TV on that day. Then 5 hours later Jane got off work and went home. When she got home Dave told her that he went to fix the antennae. The response she gave Dave comes from the logic above. That logic is: The meaning of the sentence: I went to fix the antennae activated. This meaning had strong association to knowledge base 246A which activated the first sentence. Next, Jane activated the strongest association to the first sentence which is the second sentence: Dave (D1) was watching TV and the TV broke. Then Jane activated knowledge base 260A where a previous event 268 triggers knowledge base 260A. The decision to activate knowledge base 260A comes from a pattern to extract knowledge from the past, in this case extract the event where Jane told dave not to watch TV. The result is the conscious thought: I told Dave (Z1) not to watch TV today (Z2). The association that is attached to that is to say to Dave: “I thought I said no TV today”.

This example demonstrates reasoning in robots and how the conscious is used to create this reasoning. Although this is a relatively simple example, if you think about all the steps that are described above and combine that with fuzzy logic then you will understand how affective this form of reasoning is. The knowledge base can be represented through fuzzy logic, the steps of recognizing the objects from our environment can be done in fuzzy logic, and activating element objects can be done in fuzzy logic.

The knowledge base of the program can be as long as you want it too be. You can read an entire science book and all of that knowledge will group itself based on their strongest association. When that knowledge is recognized by the AI program the strongest knowledge attached to it will activate.

How the AI Program Builds this Knowledge Base

The AI program learns knowledge by reading books. However, before it can read a book it needs to understand all the words/sentences and the grammar structure of a language. That is why it is so important that the AI program have the ability to understand most of the words/sentences from a language. Just like humans these robots have to learn knowledge from a young age and slowly build all the neural pathways in memory.

Things like creativity are actually just lessons learned in life. If the robot is drawing a picture all the strongest lessons learned to draw a picture activates in the robot's mind and these lessons instruct the robot to draw the picture. Although there are some lessons that are created by the robot the majority of the lessons are guided by teachers. A question or a statement is thought to the robot and that question or statement is asking the robot what its' preferences are. Questions or statements such as: “what is your favorite color?”, or “if the picture doesn't look good use the eraser and try again”. These aren't instructions that the teacher gave to the robot to draw the picture, these are statements or questions that ask the robot what it wants to do. The answering of the questions or statements are the instructions that is used to draw the picture.

Ideas and imagination is also part of the conscious. Just like before, conscious thoughts that create ideas come from lessons learned in the past by teachers. Ever since we were in grade school the lessons learned by teachers guided us in terms of creativity. Wither its coming up with a good essay or making a business plan or drawing a picture, that creative side of a human being comes from the average lessons thought by teachers. Statements like “we need to come up with a new idea that we never thought of before”, is a very powerful statement because in order to answer this statement you have to understand certain information. One of those information is what kind of ideas have you explored in the past and what kinds of ideas have you come up with in the past but didn't use. These information are needed in order to come up with a response to the statement. Creativity is a very complex form of intelligence and in order to form a creative mind many years of learning must be had. Creativity is also something that is encapsulated with many forms of intelligent thoughts. The complexity is managed by sentences and meaning of sentences.

I want to reemphasize one more thing because I think it is very important to the understanding of how fuzzy logic works. It isn't just words/sentences that are represented in a “fuzzy logic” way, but entire situations where visual movie sequences are accompanied by sentences to accomplish a goal. The knowledge base doesn't just come from reading a book with text but reading text along with pictures and diagrams and examples. Math books have a lot of these examples and diagrams to solve a problem or a science book have instructions in terms of pictures and text to point out how experiments are carried out. The knowledge base will include not only text but also visual movies that contain text to describe things.

Expert in Writing Essays and Giving Speeches

The more you read and the more you understand how the grammar works the easier it is to recognize and store the words/sentences. The easier it is to recognize and store the words/sentences the better the logic and reasoning for that intelligent being.

For something like writing an essay, it requires many tasks working together in order to accomplish. First the understanding of most words/sentences has to be understood. Then understanding grammar and how words/sentences are structured in terms of language rules. Next, you have to know how to write an essay—what are the steps and rules in writing an essay such as identifying the topic, how long does the essay have to be, what font size to use, what are the paragraph indentations, the margins of the page, structure of the paragraphs, and proofreading the text. Finally, there is the imagination part of the essay. The writer has to come up with ideas to write the essay. These ideas come from personal knowledge. Just like how the robot can learn how to draw a picture it can learn how to write an essay.

Giving speeches is also another task that is very complicated. The speaker has to prepare the speech. The speaker also has to know what is contained in the speech and how to give the speech. What it boils down to is many many years of learning the English language and learning how to give a speech before such a task can be accomplished. As the robot learns more the knowledge in memory builds on itself and the complexity of any problem is managed by encapsulation.

Conscious Thoughts Part 2

In the previous sections we discuss how text (sound or visual text) can be used to create reasoning. In this section instead of using only words/sentences I have decided to demonstrate intelligence using words/sentences and visual movie sequences. A math problem is something that can't be solved through text alone. It can only be solved through visual movies and words/sentences.

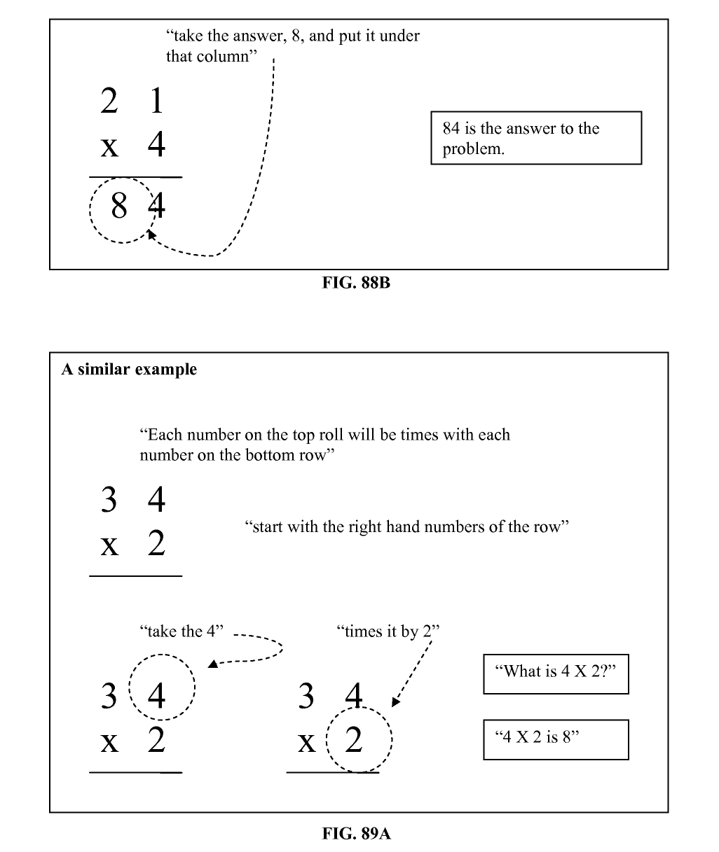

FIGS. 88A-88B are diagrams showing an example of an addition problem. Most of the sentences are learned previously such as sentences like “take the answer, 8, and put it under the column”. The sentence instructs the robot to identify the number 8 and then copy that 8 under the column. This sentence was learned previously and the understanding of the sentence means the robot can carry out the instructions. Another previously learned sentence is “take the 1”. This sentence is trying to focus the robot's eyes on the number “1” on the visual environment. That number “1” that was said in the sentence represents the visual number “1” on the math problem. Other variations of the sentence like “look at the number next to 1”, means identification of numbers in relation to the visual environment. These sentences instruct the robot to focus and assign words in the sentence to images in our environment. The meaning to these sentences uses hidden objects and patterns (previously discussed).

Next, the AI program has to have many similar training examples in memory so that the AI can find patterns and similarities between all the training examples. The common traits within the hierarchical pathways (called a floater) will be developed where all the data are centered at the strongest hierarchical pathway creating a fuzzy range of itself. Anything that falls within this fuzzy range will be considered the same object.

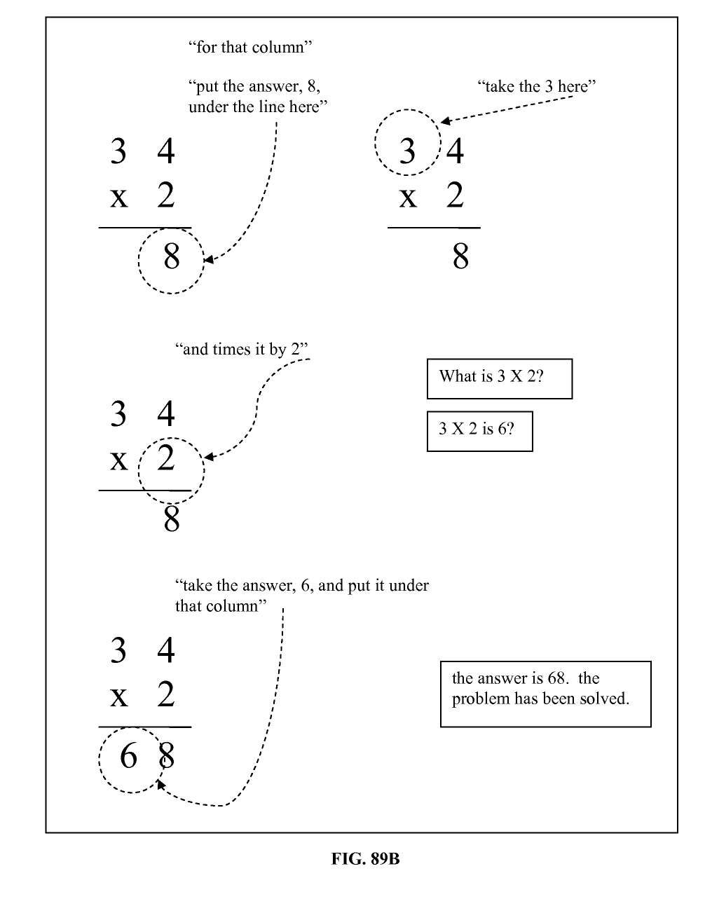

FIGS. 89A-89B is a similar example to the math equation above. The numbers are different and the sentences used to solve the problem are different. These are different sentences but mean the same things. The overall way of solving a similar math problem is the same. It's just that certain variables are different and the AI has to identify what is similar or same among all the training examples.

This similar pathway to solve a multiplication problem is a variance of the first example (FIGS. 88A-88B). The sentences used are different (same meaning), the numbers used are different, the timing of the sequences are different, and the way the numbers are represented are different. All of these things will be averaged out by the AI program and a universal pathway will be created in order to solve this problem.

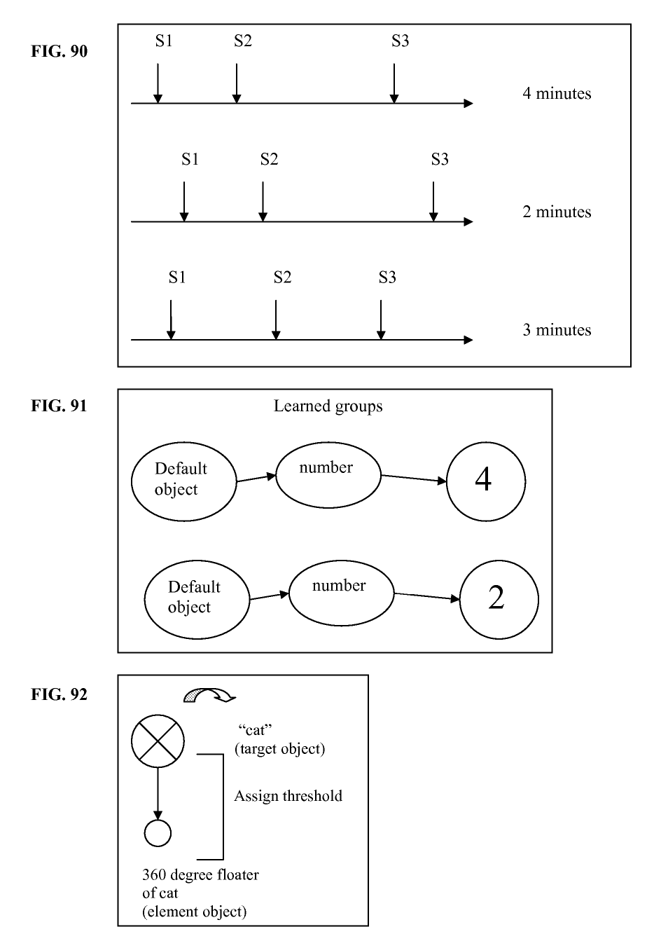

The timing of the problem is one factor to consider. The AI will average out the time it took to solve this problem (FIG. 90).

When the average is created the AI will void any discrepancies in terms of time. However, the time it takes for a math problem should fall within the average time in the floater to be considered a pathway in this floater.

Another lesson that I want to note is that the hierarchical order of image layers must be considered (FIG. 91). If a number 2 was identified and a number 4 is identified that means that the most common learned group is the word: “number”. Both numbers is considered the same at the learned group “number”. This is important because when the AI averages out the pathways the image layers contained in the pathway are purely numbers. They aren't alphabets, or toothpicks, or pencils. The elements in a multiplication problem are purely numbers.

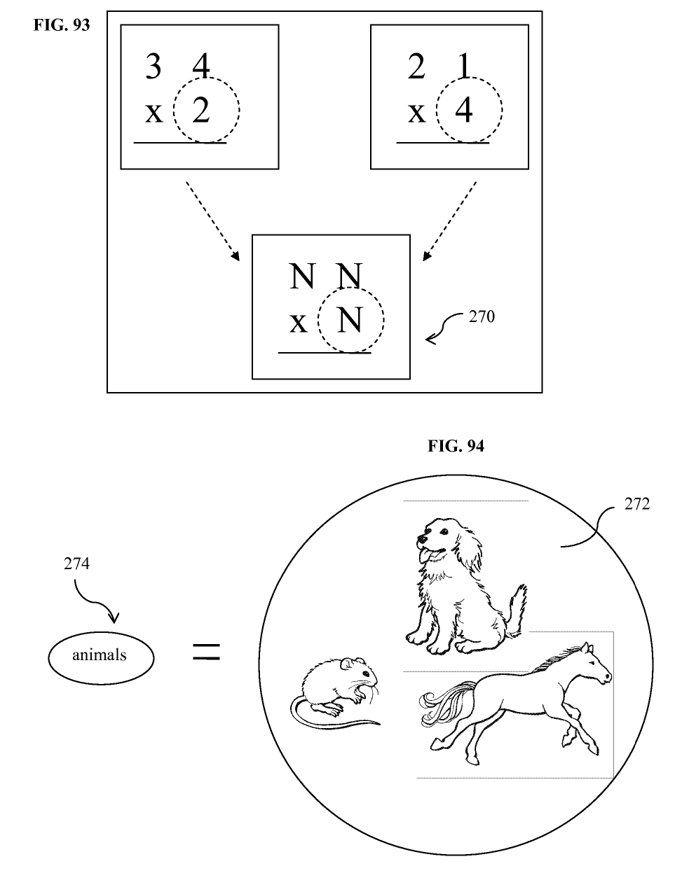

The self-organization part of the program will average out the image layers in similar pathways and creating a universal pathway. FIG. 93 is one example. N in this case stands for number (block 270). Sentences will also be averaged out where the hierarchical meaning of the sentence is established and not the sentences that represent that meaning.

Using Visual Movies and Words/Sentences to Learn Other Knowledge

There is another way of learning learned groups besides the material I have covered. Learned groups are language that classify things around us. We associate a 5 sense object with a certain word. The word can be anything in our environment. That 5 sense object doesn't even have to be similar in physical appearance. The word animal encases many visual objects in our environment. These objects aren't even remotely similar to each other in physical appearance. A dog and a rat doesn't look similar or a cow and a giraffe doesn't look similar. Despite physical appearances all these visual objects are classified as animals (a learned group).

The previous way of assigning a visual object with a learned group is by having the AI find association between two objects (FIG. 92). If the two objects fall within the same assign threshold then both objects are considered identical. Usually, words are used as learned groups to classify visual objects.

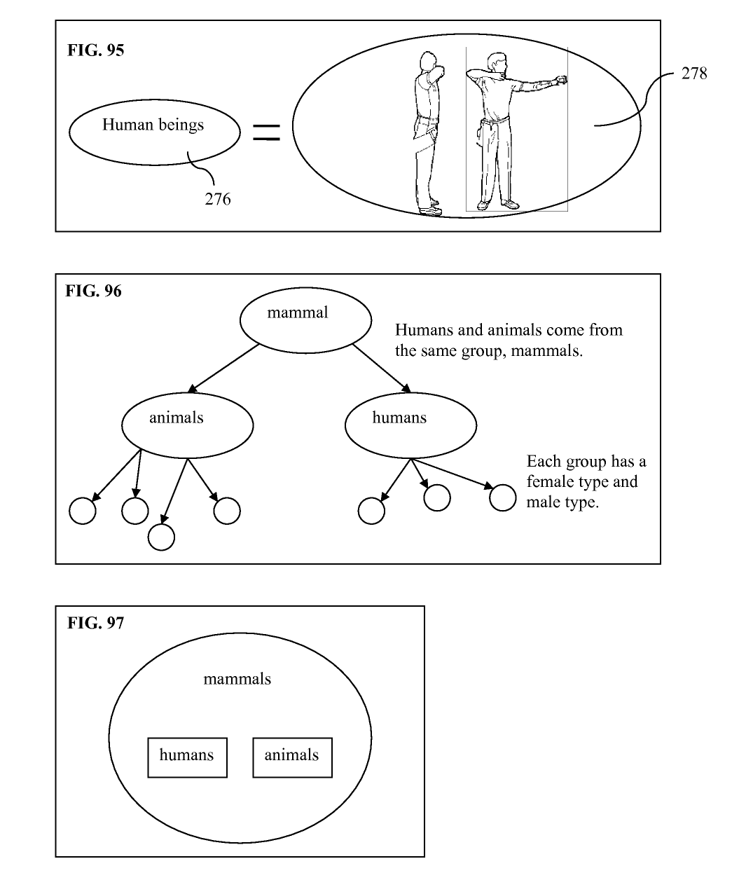

The second way of learning learned groups is by using visual images and sentences to explain what a word means (In fact, there are combinations of ways in which words can be assigned to a visual object). Maybe by using a diagram to create associations between word and visual objects learned groups can be created. FIGS. 94-95 are examples of several learned groups that can be represented by visual diagrams and text. Images 272 and 278 are assigned to their respective word/s 274 and 276

Not only can learned groups be represented from movie sequences but also a hierarchical tree. A hierarchical tree of mammals can be created and understood by the viewer (FIGS. 96-97). A hierarchical tree of a family can be understood by the viewer. Within the tree sentences can be used to explain what functions each element in the tree serves and how it relates to other elements in the hierarchical tree. Words/sentences alone can't explain what hierarchical trees are. But these diagrams can give the viewer the understanding of a hierarchical tree from a learned perspective.

Referring to FIG. 96, when questions are asked such as: “Are humans and animals mammals?”, the patterns involved to answer the question (future prediction) comes from this diagram. Facts about the diagram pops up and the robot uses these facts to answer the question. Patterns are found between similar examples and the instructions to answer the question will be in the patterns. Facts like “humans and animals come from the same group, mammals” can be used to answer the question. If the visual diagram above was on a textbook and one of the assignments given by the teacher is to answer this question: do animals and humans have a female type and a male type?, the answering of the question will require the robot to observe the diagram and read the text. Based on what it learned it can use the knowledge to answer the question “do animals and humans have a female type and a male type”. Such behavior to answer this question require many training examples. As usual the complexity is managed by the AI program.

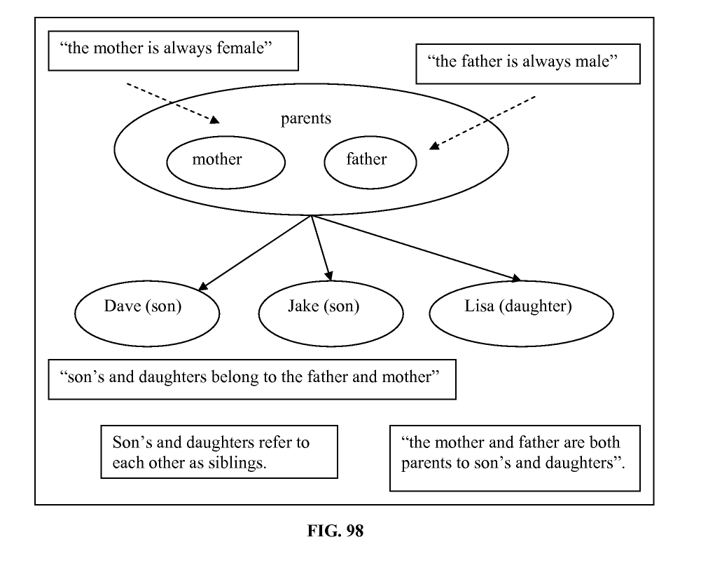

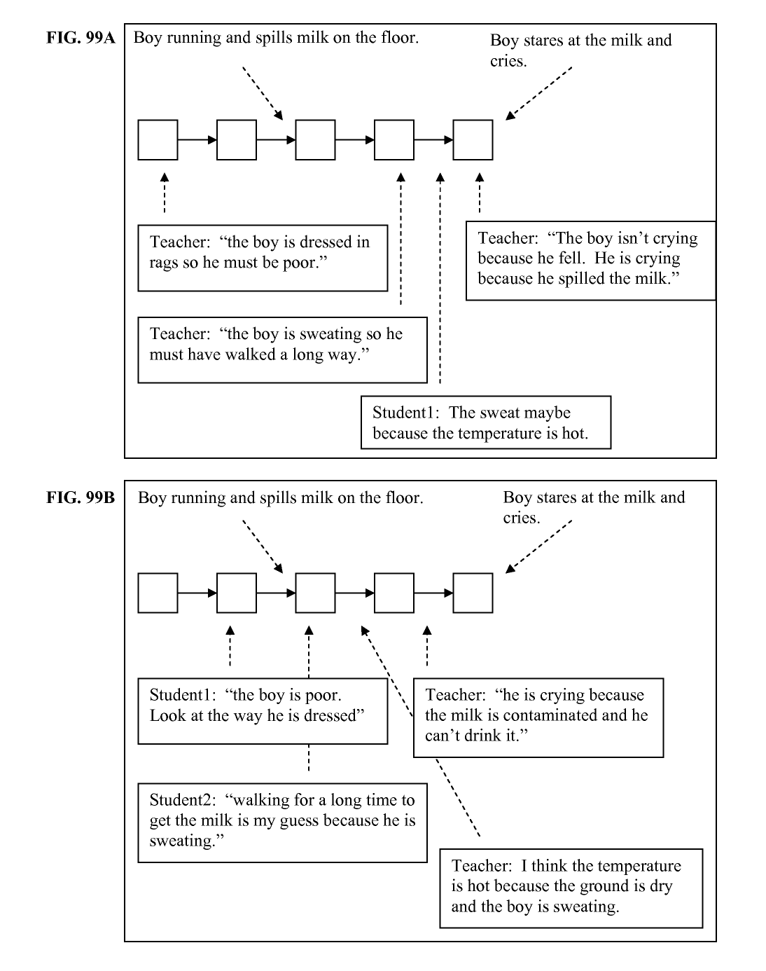

On the other hand, let's use a family tree as another example to demonstrate intelligence. Imagine that the diagram in FIG. 98 was presented to you by a teacher. And this teacher gave you facts about all the elements in the family tree such as: “the father is always male”, “the mother is always female”, “son's and daughters belong to the father and mother”, “the mother and father are both parents to son's and daughters”.

Based on all these facts about the diagram and repeatedly teaching people what the relationship between the elements in the diagram are, the robot is able to learn what a family tree is. Answering of questions related to this family tree can happen by using this diagram from memory and using the facts that are activated by this diagram.

Common Sense Knowledge or Observation Consciousness

Learning to observe the way people behave and act is very valuable to intelligence. Also, observing a situation and what the appropriate actions are is very valuable to intelligence. Common sense knowledge is what most AI scientists call this field of research. The ability for machines to understand knowledge that humans have is quite complicated. When someone drops food on the ground, a human knows that the food is contaminated and can't be eaten. When it rains a human will take shelter, when humans smell smoke he/she will run out of the house. These are common sense knowledge that humans have. This type of knowledge was learned from the day you were born to your current state. Common sense knowledge is actually the ability to learn to observe a situation and to have a teacher teach you what that situation is.

The best example of observation is from my English class. I was studying Shakespeare for that semester and I had to read Hamlet. In the book there was a line that I didn't understand and I wanted clarity by asking the professor. The sentence I was confused with was: “more matter and less art”. From a human point of view this sentence makes no sense. But after asking the professor what it means and using a form of complex logic I figured it out. The statement: “more matter and less art” means “get to the point”.

I use this example because in Shakespeare's plays, the language he uses is different from the language we use today. In order to learn the language I had to analyze the sentences, word for word, and have a teacher tell me what different words mean and how that word relates to other words in the sentence. I understood the complex sentence from observing an explanation of the meaning.

The next time I read the sentence: “more matter and less art” the meaning “get to the point” pops up in my mind.

Spilling Milk Example

Imagine there was a scene where a boy from Korea who is holding a bottle of milk. The boy comes from a very poor family. It took the boy two hours to get to the market place to buy the milk. The boy runs and trips spilling the milk all over the floor. The boy gets up and looks at the empty bottle of milk, and then the boy begins to cry. Based on this scene an intelligent person would understand that the boy did not cry because he tripped and fell to the ground. I'm sure it was a little painful but the boy didn't cry because of the fall. The boy cried because the milk was spilled all over the floor and the milk was gone. Since the boy is poor he and his family won't have any food for the rest of the day.

As students in school we learned how to observe a situation and either hear what people think about the situation or we can voice our own opinion about the situation. This is where the conscious of intelligent thought is produced. The collective voices of not only the teacher but the other students who critiqued about the situation is stored in memory in a fuzzy logic way (FIG. 99A). All the sentences said during the situation are averaged out and what remain are the strongest average sentences for that given situation.

Based on the conversation about the situation the robot will store all these sentences in memory and average the data. The diagram in FIG. 99B will show a similar example to the boy spilling the milk and the teacher's and students' responses to the same situation. All the responses are stored in terms of fuzzy logic

In the second example (FIG. 99B) the speakers are different and the way that the speaker says the sentences are different. The timing of the sentences are said at different times too. The important thing is that the meaning is the same. And because the meaning is the same the computer can average all similar examples and come up with a universal pathway. What will activate is the meaning of something instead of the exact sentence that was encountered. This is the essence of fuzzy logic.

Observing and listening to people's opinions about a situation is very important to common sense knowledge. The brain will have to know facts about a situation and know what to say and do next. The material learned in school is vital to the way conscious thoughts are activated. If someone walks into a classroom with a black eye, people will critique, assume, and guess using logical analyzes of the person. They can assume this person got into a fight yesterday and got punched on the eye. It could possibly be that it was an accident. Whatever the circumstance is by analyzing this person and his behavior human beings can assume what happened.

Another example is if someone is sick. We learned that if someone is sick we have to take measures to make sure that there is no contact between the sick person and us. The reason for this is because sickness can be spread among humans. We learned how diseases are spread and the flu is spread through contact with the sick person. Because we discussed the situation when a person is sick and how to respond to this situation we know what to do or we know how to think consciously when such an event occurs. In some sense this form of analyzing a situation can be used to predict the future. In previous lessons I taught about how the AI program follows the strongest future pathway in order to predict the future. This is the second way in which the AI program can predict the future—by using sentences and logical analyzes of the current situation.

We learned how to respond to danger when it occurs because the teachers thought us how to respond. For example, we know that alligators are dangerous. We didn't learn this lesson by having an alligator bite us, we learned it by lessons thought to us in school. Sometimes pain and pleasure decides things but this time it's using sentences and logical analyzes to tell us what to do in the future. “when we see an alligator or any dangerous reptile what should we do?” “we should run away and get help”. That conscious thought instructs the robot in what kind of action to take in the future.

Observation by Watching TV

Another form of intelligence is observing a situation by watching TV shows. Copying what to say and when to say it as the show is interpreted by the robot. Observing how others interpret a situation and either agreeing with them or disagreeing with them. Many logical thinking is done by watching TV because the scripts are well planned out. In fact, most of the learning we get comes from watching TV and copying the things that happened during the show.

By watching the movie and making personal opinions about a situation we are learning to analyze a situation. During the movie there might also be people critiquing on the situation so you can get their opinion on the situation.

Copying the way actors behave, say things, and act are another factor that can be considered when watching TV. We tend to emulate certain people that we look up to. Some might be people from real life, but others are actors and actresses on TV. We take the lines that we find dynamic and we copy them. If we like the way certain actors/actresses dress then we copy them. If we find their line of work interesting then we try to work in their field. So, lots of behavior and decision making are done by watching and emulating what we see on TV.

Markers and How Sentences Play a Role in Identifying Pathways

Sentences are just markers on the pathway and are not considered an entire pathway. Sentences don't actually encapsulate entire situations (movie sequences). It simply gives the AI program a marker in a particular unique area in memory and the unique area happens to be the only pathway that contains the sentence. I will be using the ABC block example again (FIG. 41A). At the beginning of the problem is a sentence that identifies that pathway: “I want you to stack the blocks up starting with C then B and finally A”.

This sentence serves as the marker to identify the entire pathway. In fact, this sentence is so unique that only this pathway contain the sentence and no other. In previous lessons I stated that a sentence has to be identified according to the situation. This doesn't mean that the sentence identifies the entire pathway as the meaning. It just means that at that moment a hidden object (meaning1) is activated and this meaning1 is just a pattern that tells the robot what to expect in the future as a result of the sentence.

If you look in FIG. 41A every sentence in the problem is a marker. Every sentence is unique only to a certain pathway. By identifying the sentence, the pathway is also identified. Each marker might belong to other pathways but it's the combined sequence of the markers that make the pathway unique.

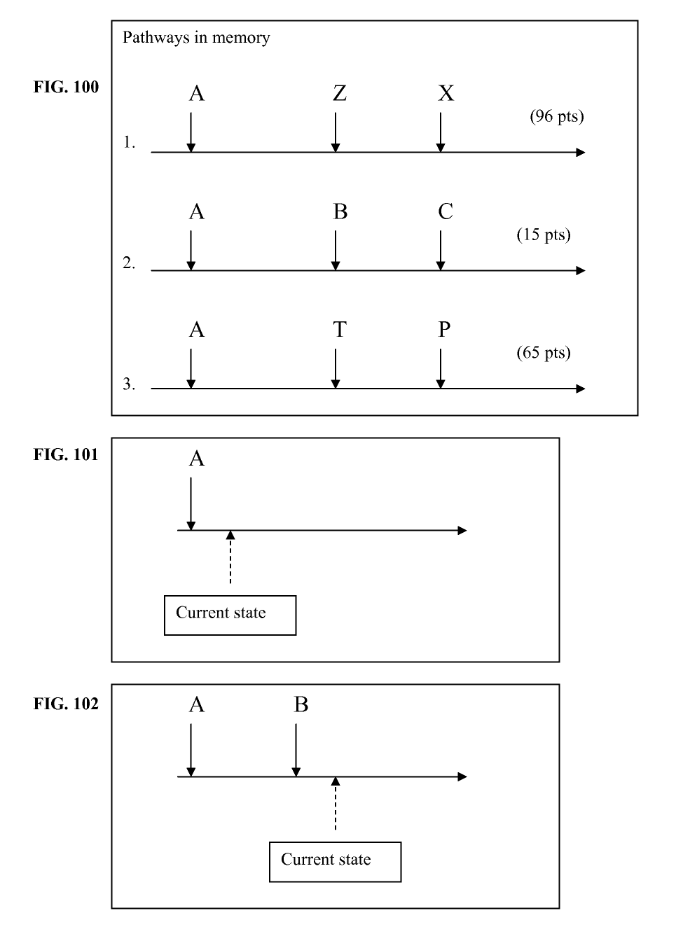

Each letter in FIG. 100 represents a sentence (marker). If you wanted to match the pathway in FIG. 101 to one of the pathways in memory (FIG. 100) then the AI has to find the best match. According to the match all three pathways have letter “A”, therefore the only way to choose a pathway is to look at their powerpts. Since pathway 1 has the highest points (96 pts) then that is the pathway the computer will choose (AZX).

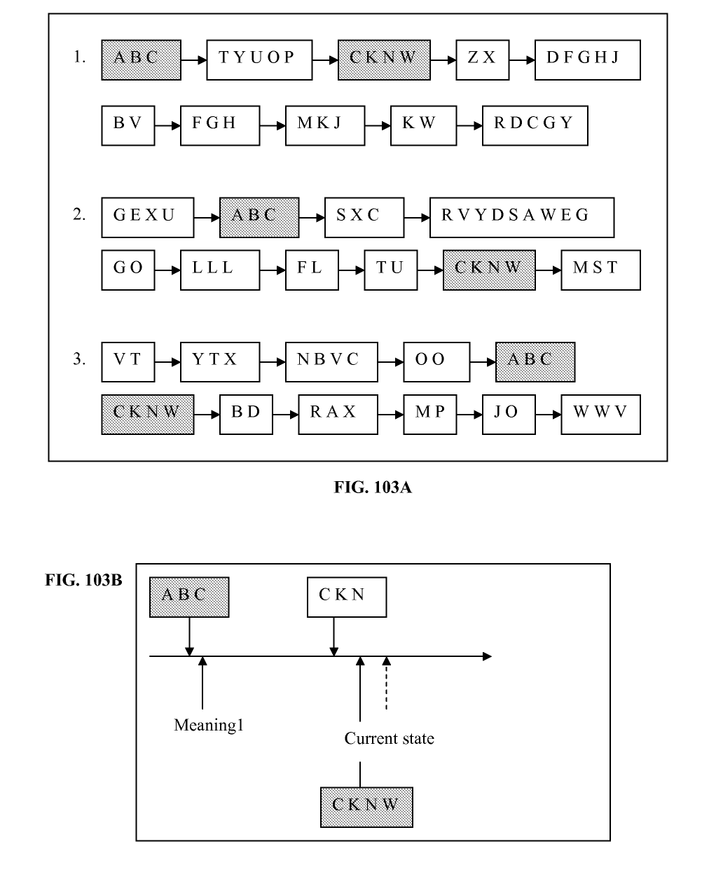

However, if the pathway is like the example in FIG. 102 then the AI program will pick the best sequential match that contains sentence “A” and sentence “B”. The more sequences the AI is allowed to search the more accurate the match will become. In this case the pathway is so unique to ABC that there is only one pathway it belongs to (the 2^{nd} pathway).

Back to Knowledge Base and How it Works

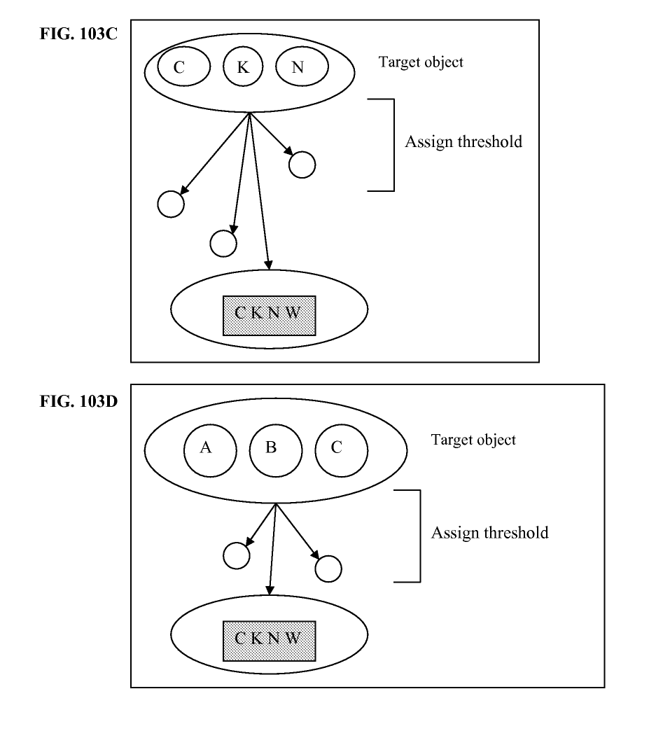

The diagrams in FIG. 103A are sequential events that happen. Imagine that each letter is a word in a sentence and that the robot is reading in text from a book. Notice that the grey blocks: ABC block and CKNW are outlined. I wanted the readers to be aware of these two blocks.

In the next diagram (FIG. 103B) the machine recognized ABC and the current state is at: CKN. Based on CKN the rules program activated CKNW. The stereotype CKNW is attached to object CKN and that is why it was activated.

Target object ABC and target object CKN are trying to compete with one another to activate their respective element objects (FIGS. 103C-103D). They both share CKNW as an element object. This makes the element object CKNW stronger. The rules program activated CKNW as the element object at that moment because that was the strongest element object based on the current data.

Notice that in the knowledge base that ABC and CKNW are not even trained sequentially. They are far away from each other. But all three sequential training example has object ABC first then object CKNW. Because both objects are trained together each object is associated with the other object.

Decision Making and Planning Tasks

There are many different levels on decision making and each level influences the way the robot makes decisions. Below is an outline of the level of factors that will influence the AI program in terms of decision making.

Levels of Decision Making:
1. innate reflexes based on pain—when a person is in great pain reflexes are most likely to trigger. These reflexes are wired into pain so that when the pain reaches a certain point it triggers the reflex. No conscious decision was needed to trigger this action. Some of these innate reflexes are: when a person is in great pain he/she yells out loud, when the knee cap is hit with a hammer the leg moves automatically, etc.
2. Learned decisions based on past knowledge—the conscious guides the robot to make decisions. These decisions are either based on future predictions or logical decision making.
3. Pain and pleasure built into the robot—attractiveness or ugliness, physical pain (degree of pain) and physical pleasure (degree of pleasure) are factors that the robot uses to make decisions. Is the robot going to eat lobster for dinner (the robot loves lobsters) or is the robot going to eat rice? (the robot eats rice only if he has to). These pain/pleasure factors that are built into the robot will make decisions.
4. Daily routine—Learned things that the robot was thought everyday by teachers are factors in decision making. Some of these daily routines are so natural that the robot doesn't need to make a decision to do them. Daily routines such as: waking up in the morning, brushing your teeth, eating 3 meals a day based on the time, going to sleep at night, using the bathroom when you need to go, and going to work or school on weekdays.

These are the levels of decision making. The higher levels overshadow the lower levels in terms of decision making. For example, innate pain overshadows learned decisions because innate pain is a reflex and is triggered by pain while learned decisions uses conscious thoughts to make decision. In other words, innate pain is triggered without conscious thought and overshadows learned decisions.

Another example is learned decisions can overshadow pain and pleasure. This form of pain and pleasure doesn't trigger reflexes, it's just a lower degree of pain/pleasure from innate reflexes—a degree where the robot can manage the pain. If a person has an itch on his butt and this person is walking on the street, the person can make a decision to scratch his butt or not. He can wait until he gets to a private area before scratching his butt. This is one demonstration of learned decision having higher priority than pain/pleasure. Even something like using the bathroom require learned decisions. If you have to go the pain is unbearable. However, you can't take a dump on the street or in a classroom. You have to make a decision to go to the bathroom and take a dump. Even though the pain is so great the learned decisions guided the robot to take the appropriate actions.

Pain and pleasure is another factor that is used for hidden objects. The AI finds these patterns and wire pathways with pain and pleasure. The strongest pathways have their powerpts strengthened because it's wired to pleasure and the weak pathways have their powerpts lowered because it's wired to pain. The learned decision encapsulates pain/pleasure to plan out tasks and make decisions for the robot. The main function of decision making is always to pursue pathways that lead to pleasure and stay away from pathways that lead to pain.

Daily routines such as brushing your teeth, sleeping at 9 pm, and waking up at 7 am are just things that we learn everyday and this type of learning is so normal that we do them without thinking. Learned decision can overshadow these things because we can control when we sleep by conscious thought. Instead of 9 pm we can sleep at 2 am. Instead of eating cereal for breakfast we can eat a hamburger. This daily routine is also another factor that can be encapsulated into learned decisions to plan out tasks and make decisions for the robot. The AI program finds patterns concerning daily routines and use this pattern in a hidden object. This hidden object will then be assigned to words/sentences as meaning of words/sentences.

Planning Out Tasks and Interruptions of Tasks

In modern day AI techniques, planning out tasks uses a combination of language parsers, discrete mathematics, probability theories, and recursions. My method of planning out tasks uses the conscious. Everything from planning a task, decision making, task interruption and probability of task is all managed by one thing: conscious thoughts.

In this section I will demonstrate how tasks are planned out and how interruptions of tasks are solved. So far you have learned that the conscious does many functions for the robot. Functions such as provide meaning to words/sentences, give information about objects, guide the AI program to solve arbitrary problems, and provide information about a situation. Now, an addition to these functions, the conscious can plan out tasks and solve interruptions of tasks.

There are two ways of accomplishing planning of tasks. The two ways will be outlined and detailed demonstrations will be given.

1^{st} Way of Planning Out Tasks:

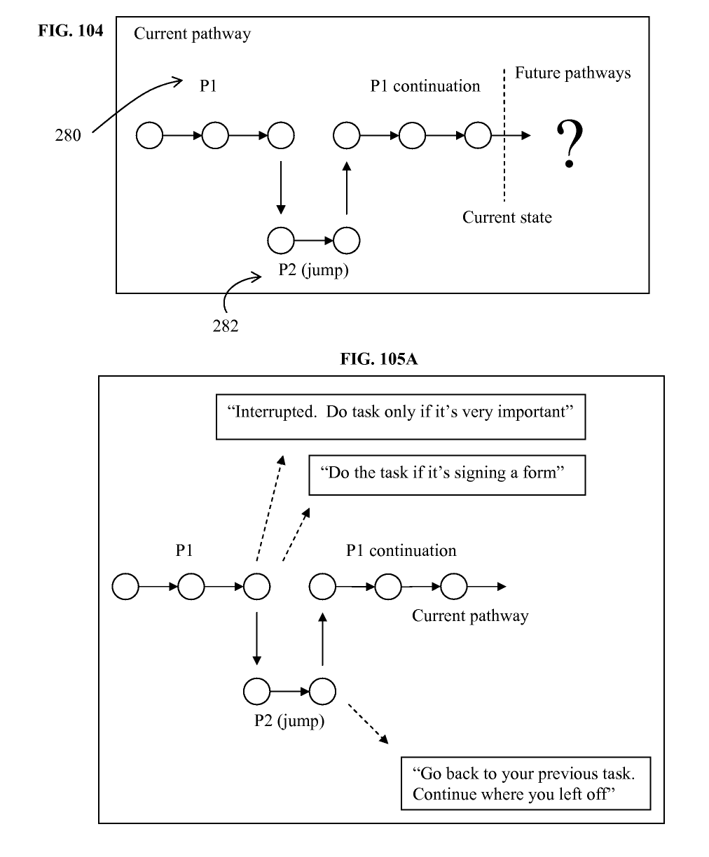

FIGS. 104-107 are diagrams showing the process of planning tasks and managing interrupted tasks via language. Referring to FIG. 104, pathways in memory are either continuous or non-continuous (pathway 280 and 282). The continuous pathway is a pathway that can be followed sequentially. The non-continuous pathway is a fabricated pathway that jumps around in memory. As the AI follows a pathway it will keep a note of wither a pathway is continuous or not. It will also indicate where the pathway jump to or from.

So the AI program was following pathway one (P1), then it jumped to pathway2 (P2), followed P2 for awhile then it jumped back to pathway one (P1). This is one pattern that will be used to self-organize similar pathways in memory. Imagine if P1 represent the ABC block problem and P2 represent an interruption by a student. While the robot is trying to solve the ABC block problem a student in the classroom interrupted him to sign his name on a piece of paper. After the robot finishes signing his name he goes back to the ABC block problem and continues where he left off.

Conscious thoughts guide the student to go back to the task it was previously doing. After the interrupted task is completed teachers will teach the robot using sentences to go back to what the robot was doing before—go back to the first task and continue where it was before the interruption.

Before the robot decides to accomplish the interrupted task teachers can teach it wither to do this interrupted task or not. The teachers can teach the robot not to do the interrupted task or to do the interrupted task. Maybe the teacher can set up some kind of criteria of priority wither to abandon its current task to accomplish another task.

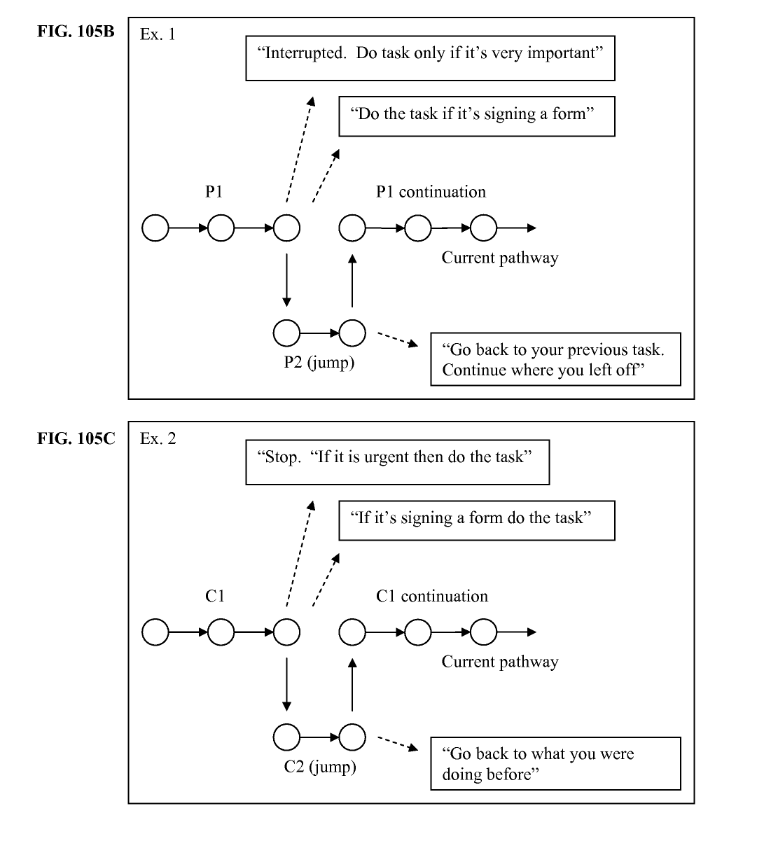

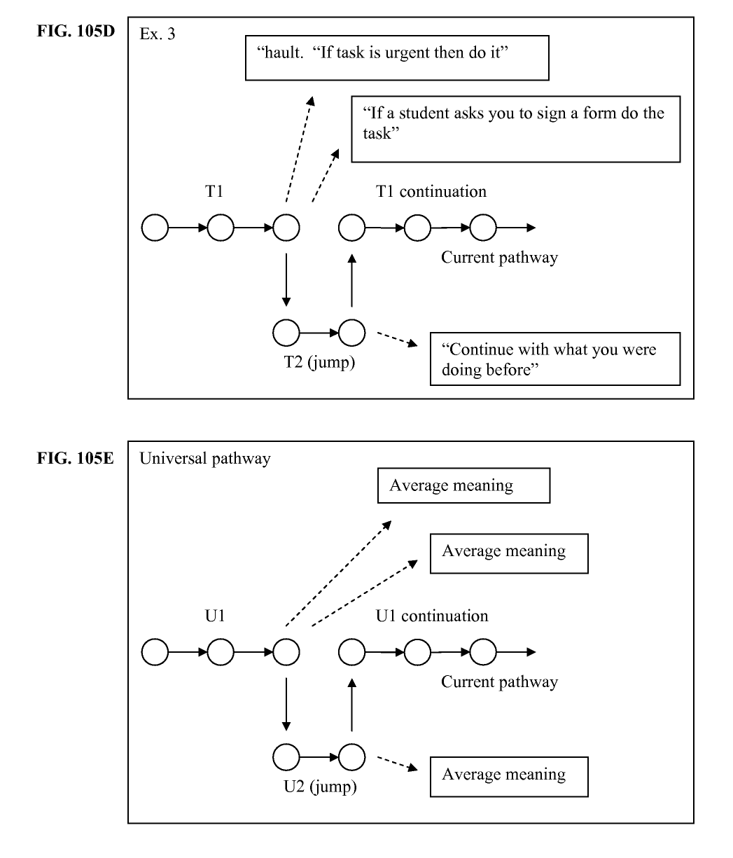

FIG. 105A depict how conscious thoughts are used to plan tasks and manage interrupted tasks. This sets up the rules for doing another task and it also sets up the rules of what happens after the interrupted task is completed.

The sentences, if understood by the robot, will carry out the instructions to manage tasks. It will provide the robot with rules to either do a second task or not. It will also provide the robot with rules after the second task is done to either go back to its previous task or continue on with another brand new task.

A universal pathway to manage tasks must be developed and the only way to do this is by averaging similar pathways. The pattern I stated at the beginning of this section is what will link similar pathways together. The pattern is: The AI program was following one pathway, then it jumped to another pathway, next, it jumped back to the previous pathway. In addition to that the fuzzy logic sentences that accompany a jump are included. FIG. 105B, FIG. 105C and FIG. 105D are three examples of similar pathways and these pathways are averaged out and a universal pathway is created.

In Ex. 1, Ex. 2, and Ex. 3 the situation is very similar (FIG. 105B-105D). Although the tasks to be done are different the way that the pathways jump around is the same. Also, the meaning to the sentences in all three pathways are either similar or the same. After self-organizing similar pathways in memory a universal pathway is created. This universal pathway states that the AI program was following pathway U1 and then it was instructed to jump to pathway U2. After U2 is completed it was instructed to jump back to U1 and continue where it left off (FIG. 105E).

U1 and U2 are pathway variables and the pathways can be anything. U1 can be a math problem, or riding a bike, or taking a test. U2 can be a conversion, or it can be using the bathroom, or eating a piece of candy.

2^{nd} Way of Planning Tasks:

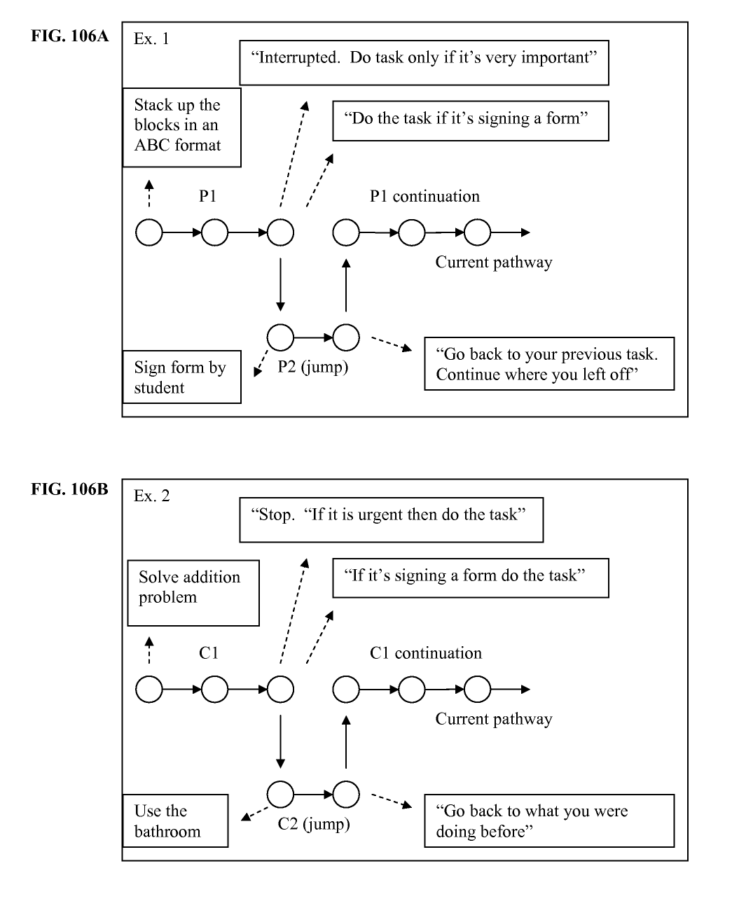

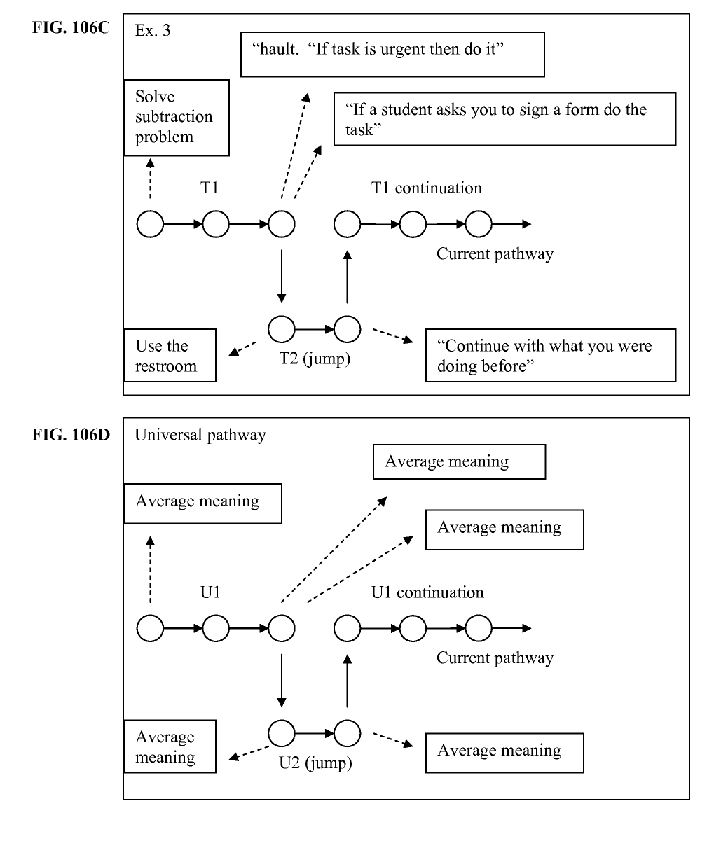

The second way of planning out tasks is virtually identical to the first way. I simple add in the learned groups to identify what the pathways are. Usually a sentence to identify the task is crucial; other times it's just a combination of sentences to describe the task that is crucial. The sentences don't represent the entire pathway it's just a marker to identify a unique pathway (discussed earlier). The AI program will use these unique markers (in the form of sentences or meaning of sentences) as the identification of the pathway. The sentences or its meaning will go through self-organization just like all the other sentences and a universal pathway will result. FIGS. 106A-106C are similar examples from the first way of planning a task. I simply included sentences to identify what the pathways are.

Referring to FIGS. 106A-106C, all the identification of pathways in the form of sentences and meaning of sentences serve as a marker on the pathway. The averaging of these markers will also include any hierarchical order. For example, ex. 2 and ex. 3 are grouped in solving math problems. Although ex. 1 isn't remotely close to ex. 2 and ex. 3, they are grouped together because the overall pathways have similar events. Ex. 1 will still be included in the universal pathway.

Within the universal pathway are hierarchical groups that organize similar pathways (FIG. 106D). The more the AI program learns the more organized these pathways are. The universal pathway is the center of the floater because this is the pathway that is shared among many examples. The specific pathways within the floater represent the fuzzy range of the floater.

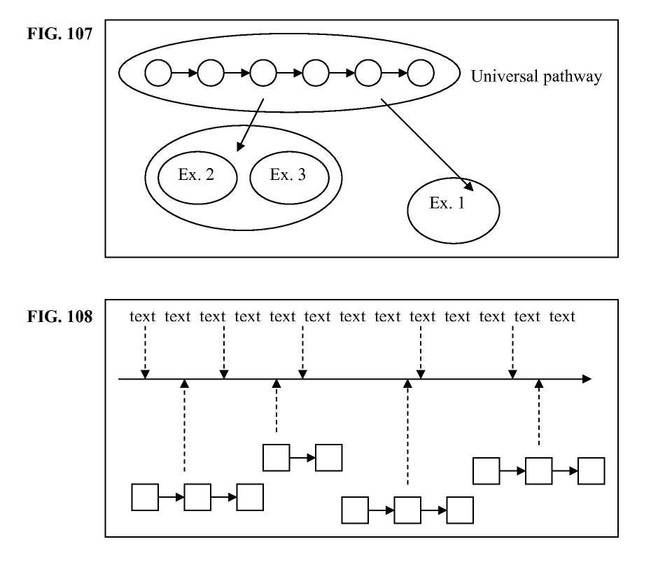

All the pathways are encapsulated in the universal pathway (FIG. 107). Since Ex. 2 and Ex. 3 are so similar they are grouped closer together. Ex. 1 is farther away. If the AI program encounters a problem that is similar to Ex. 2 then it will go into the universal pathway first, then it will go into the math problem group and finally go into Ex. 2.

On the other hand if the AI program encounters a pathway similar to Ex. 1 (the ABC block) then it will go into the universal pathway first, then it will go into the Ex. 1 group.

Other Topics

The next couple of paragraphs are just lessons that were taken out of other sections in this patent because they were too long. I have included them here because these are important lessons that should be noted.

Learning to Delineate Image Layers from Pictures and Movie Sequences

There is another way besides using an image processor to cut out image layers from pictures and movie sequences. Finding patterns between the image processor and how it dissects out image layers and assigning this pattern to language is another way. The machine can use language as a tool to cut out image layers from pictures and movie sequences. If we preprogram all the various ways in which an image processor can dissect out images from pictures it would be impossible to program. But if we teach the image processor what to cut out in the form of sentences and visual movies then it will know how to cut out images from pictures and movie sequences.

When I say cut out image layers from pictures and movies I don't mean just cutting out moving objects. What I mean is there should be rules that the image process must follow to cut out certain images. If I said, cut out the image in the picture with the dotted lines, then the robot should cut out the image by following the dotted line and cutting it out carefully. If I said cut out animals from the picture then the robot should cut out all the animals from the picture. If I said cut out the images next to the mail box then the robot should identify the mail box and then cut out the image that is next to it.

By using language and visual representation we can guide the robot to delineate any image from a picture or a movie sequence. All the rules are communicated through language and the understanding of language allows the robot to carry out the instructions. This is the ultimate type of image processor that anyone can ever build.

Also, intelligence has lots to do with what rules the image processor needs in order to carry out its instructions. The ability to understand that a cat image is a called a “cat” and a dog image is called a “dog”. Being able to identify situations like the dog jumped over the cat, is vital to the Image processor. What if there was an instruction given to the robot that said: “cut out the image that the dog jumped over”. Since the cat is the image that the dog jumped over then the cat is the image the robot has to cut out.

We can use a finger to point to a particular image in a picture. We can also use a laser to point to a particular image in a picture. We can outline the image in the picture using the laser. Or we can use an outliner like a digital outliner to delineate an image from a picture. Learning sentences and movie sequences and associating these things with a particular way of delineating images from pictures and movies is one form of intelligent image processing.

In fact, we can tell the robot what to do with the image when it identifies this image in a picture or movie sequence. For a real life picture we can have the robot cut out the image. If it's an image in a picture on a computer monitor we can tell the robot to erase the image using a mouse. If it's an image on a chalkboard we can tell it to physically erase that image. If the image is on a piece of paper we can tell the robot to white out the image. If the image is on a coloring book we can tell the robot to color the image. So the way that the robot treats the image in the picture or movie sequence is arbitrary. Using language and all the mechanics of the robot's body the different ways that the image can be handled will be up to the programmer's imagination.

Reading a Book

When the AI program is reading a book he is actually fabricating a movie sequence in his mind based on what he is reading (FIG. 108). Every word that the robot reads in will activate a sequence of movies that will tell the robot what is happening in the story. By the time the robot finishes reading the story he will have an understanding of the story not in terms of words/sentences but through a movie that was fabricated based on the text in the book.

This fabricated movie will consist of snapshots of pictures and movie sequences that are activated by the meaning of the words/sentences. Although the fabricated movie won't be like a streaming DVD quality movie the snapshots give an idea of what is happening in the story. These fabricated movie sequences will be used to recall information about the things the robot read. Questions that are asked about the story depend on this fabricated movie in order to answer.

The foregoing has outlined, in general, the physical aspects of the invention and is to serve as an aid to better understanding the intended use and application of the invention. In reference to such, there is to be a clear understanding that the present invention is not limited to the method or detail of construction, fabrication, material, or application of use described and illustrated herein. Any other variation of fabrication, use, or application should be considered apparent as an alternative embodiment of the present invention.

What is claimed is:

1. A method of creating human level artificial intelligence in machines and computer based software applications, the method comprising:
an artificial intelligent computer program repeats itself in a single for-loop to receive information, calculate an optimal pathway from memory, and taking action;
a storage area to store all data received by said artificial intelligent program; and
a long-term memory used by said artificial intelligent program.

2. A method of claim 1, wherein said for-loop contain instructions that said artificial intelligent program must accomplish within a predefined fixed time limit, for example, 1 millisecond, 10 millisecond, 86 millisecond, instructions in said for-loop comprising the steps of:
entering said for-loop;
receiving input from the environment in a frame by frame format or movie sequence, each frame containing at least one data comprising of at least one of the following senses: sight, sound, taste, touch, smell or a combination of senses;
searching for said input in memory and finding the closest matches;
calculating the future pathway of the matches found in memory and determining the optimal pathway to follow;
storing said input in the optimal pathway and self-organizing said input with the data in a computer storage area called memory;
following the future pathway of the optimal pathway and exiting said for-loop; and
repeating said for-loop from the beginning.

3. The method of claim 2, wherein searching for information is based on searching for one pathway in memory, which is referred to as the optimal pathway, and said artificial intelligent program will take action by following the optimal pathway's future pathway

4. The method of claim 2, wherein searching for the input in memory, the input called the current pathway, the method comprising the steps of:
using an image processor to break up said current pathway into sections of data, called partial data;
searching for each of the partial data in memory using randomly spaced out search points;
each search point will collaborate and communicate their search results with other search points to converge on the pathways that best match said current pathway until the entire network is searched.

5. The method of claim 4, wherein each search point will communicate with other search points on search results with at least one of the following: successful searches, failed searches, best possible searches and unlikely possible searches.

6. The method of claim 4, wherein each search point has a priority number, and determining said priority number comprises of at least one of these criteria:
the more search points that merge into one search point the higher said priority number;
the more matches found by the search point the higher said priority number; and
the more search points surrounding that search point the higher said priority number.

7. The method of claim 6, wherein the higher said priority number the more computer processing time is devoted in that search point and the lower said priority number the less computer processing time is devoted in that search point.

8. The method of claim 3, wherein if the search function doesn't find an exact match in memory said artificial intelligent program will attempt to fabricate pathways and fabricate future pathways by using at least one of the four deviation functions: fabricating pathways using minus layer pathways, fabricating pathways using similar pathways, fabricating pathways using sections in memory, and fabricating pathways using the trial and error function.

9. The method of claim 2, wherein calculating the future pathways comprises:
designating a current state in a given pathway and determining all the future sequences in said pathway;
adding all the weights for each possible future sequences;
calculating the total worth of each possible future pathway and ranking them starting with the strongest long-term future pathway.

10. The method of claim 1, in which the storage of data is based on a network contained in a 3-dimensional grid, said data being represented by objects comprising of at least one of the following: visual images, sound, taste, touch, smell, math equations, or combination of objects.

11. The method of claim 10, wherein the 3-dimensional grid stores at least one data structured tree, each tree can grow or shrink in size based on the amount of training, and each tree can break apart into a plurality of sub-tree branches when data is forgotten.

12. The method of claim 10, in which the storage space uses a 3-dimensional grid to contain all the pathways from input; and each pathway is subject to space in the 3-dimensional grid where 2 data can not occupy the same space at the same time.

13. The method of claim 10, wherein during self-organization in the 3-dimensional grid said artificial intelligent program will designate a given radius, centered on the input data, to bring common groups closer together; data outside of said radius will not be affected while data in said radius will be subject to changes.

14. The method of claim 10, wherein each data comprises two types of connections with other data in memory and are independent of each other:
sequential connections, which is best represented as a frame by frame movie; and
encapsulated connections which are objects that are contained in another object, for example, pixels are encapsulated in images, images are encapsulated in movie sequences, and movie sequences are encapsulated in other movie sequences.

15. The method of claim 14, in which the sequential connections are used for predicting the future while the encapsulated connections are used for storing and retrieving data from memory.

16. The method of claim 2, wherein self-organizing of data, also known as the rules program, finds association between objects in memory, the method comprising the steps of:
designating an object from input as a target object;
searching and identifying said target object in memory;
designating the objects surrounding said target object in memory and the objects surrounding said target object in the input space as the element objects; and
bringing the element objects closer to said target object based on association.

17. The method of claim 16, wherein the association between target object and the element object further comprising:
the more times the target object and the element object are trained together the stronger the association; and
the closer the timing of the target object and the element object are the stronger the association.

18. The method of claim 16, in which said artificial intelligent program will use the rules program to create the human conscious, the method comprising the steps of:
searching and identifying target objects from input;
gather all the closest element objects from all the target objects found in memory;
determining which element objects will be activated; and
activating each of the qualified element objects in linear order.

19. The method of claim 18, wherein activating element objects will result in conscious thoughts equivalent to human beings, said conscious thoughts being represented by instructions, in the form of language or visual images, that will guide said artificial intelligent program to execute at least one of the following: solve arbitrary problems, provide meaning to language, give information about an object, and provide general knowledge about a situation.

20. The method of claim 16, wherein meaning of objects, most notably meaning to language, occurs when two or more objects fall within the same assign threshold, for example, a sound of cat, the visual text cat, and the visual floater of cat are stationed in the same assign threshold, therefore all three objects have the same meaning.

21. The method of claim 16, wherein self-organization of data comprises two types of groups: learned groups; and commonality groups.

22. The method of claim 21, wherein said commonality group is represented by any 5 sense traits or hidden data that two or more objects have in common such as common traits represented by sight, sound, taste, touch, smell or hidden data set up by the programmer within these 5 senses.

23. The method of claim 21, wherein said learned group is represented by two or more objects that have strong association to one another; particularly two or more objects that are stationed in the same assign threshold.

24. The method in claim 10, wherein the 3-dimensional storage grid uses the 2-dimensional movie frames and store them in such a way that said 2-dimensional movie frames produces a 3-dimensional environment.

25. A method to mimic long-term memory similar to human beings in claim 2, the method comprising:
a timeline, with increments of 1 millisecond, that contain reference points to the time movie sequences occurred;
said timeline has reference pointers to movie sequences stored in memory; and
said artificial intelligent program uses said timeline to find patterns to intelligence and conscious thought.

26. A method to create an N-dimensional object from 2-dimensional sequential movie frames, said N-dimensional being represented as any-dimensional, the method comprising the steps of:
using an image processor to delineate moving or non-moving image layers from one frame to the next in said 2-dimensional movie;
using the self-organization technique in said artificial intelligent program to find repeated patterns based on colored pixels from frame to frame;
determining what image layers belong sequentially from frame to frame and designating the strongest sequential image layers as the center of said N-dimensional object; and
determining a predefined range of how fuzzy said N-dimensional object can be and anything that falls within this fuzzy range will be considered said N-dimensional object.

27. A method of claim 4, wherein said current pathway comprises at least one of the following data types:
5 sense data or commonality groups;
activated element objects or learned groups;
hidden data and;
patterns;

28. A method of claim 27, wherein each data type have their own encapsulated format.

29. A method of claim 27, in which said hidden data are created during runtime based on the 5 sense data, said hidden data for a visual object comprises: a normalization point of said visual object; an overall pixel count of said visual object; a scaling analysis of said visual object, a rotation analysis of said visual object, a movement path of said visual object, a movement distance of said visual object, a number of changes of a movement direction of said visual object, and a number of contacts between said visual object and other visual objects.

30. A method of claim 27, wherein said patterns uses internal functions to assign instructions in pathways to extract data from memory and predict the future.

31. A method of claim 30, wherein said internal functions include: the assignment statement, searching for data in memory, determining the distance between data in the 3-d environment, rewinding and fast-forwarding in long term memory to get data, and determining the strength of data in memory.

32. A method of claim 30, wherein said artificial intelligence program compares data from similar pathways in memory to find said patterns

33. A method of claim 10, wherein if there are multiple copies of an object in memory each copy of said object will have a reference pointer to a masternode, said masternode being represented as the copy of said object with the highest powerpoints

34. A method of claim 33, wherein training of an object occur in a global fashion where all copies of said object's powerpoints will be modified, the method comprising the steps of:
said object sends a signal to the masternode to identify itself and;
said masternode will modify most copies of said object in which the stronger the pointer connection the stronger the modification.

35. A method of claim 10, wherein the priority of objects in a given pathway state is determined by at least one of the following factors:
said artificial intelligence program uses pain and pleasure in which said artificial intelligence program identifies objects that causes the pain or pleasure and;
said artificial intelligence program compares data in similar pathways to determine wither or not an object causes the pathway to change its future course.

36. A method of claim 18, in which the steps to extract element objects from a target object comprises:
said target object sends a signal to the masternode to identify itself and;
said masternode will extract element objects from all copies of said target object based on the connection pointers, wherein the stronger the connection pointer the higher the priority of the element object.

37. A means by an artificial intelligence program to use language in a fuzzy logic manner to accomplish at least one of the following functions:
storing and organizing 5 sense data in a computer readable memory or network;
predicting the future without the aid of heuristic search algorithms, discrete mathematics, language parsers, planning programs, genetic programming, and probability theories;
predicting the future with the aid of heuristic search algorithms, discrete mathematics, language parsers, planning programs, genetic programming, and probability theories;
planning tasks and solving interruption of tasks;
defining the rules of an image processor to extract information from pictures or movie sequences and;
creating logic and reasoning from 5 sense data;
